(19) United States
(12) Patent Application Publication
(10) Pub. No.: US 2010/0040806 A1
(43) Pub. Date: Feb. 18, 2010

(54) CELLULOSE ESTER OPTICAL FILM, POLARIZING PLATE AND LIQUID CRYSTAL DISPLAY USING THE CELLULOSE ESTER OPTICAL FILM, AND METHOD FOR PRODUCING CELLULOSE ESTER OPTICAL FILM

(75) Inventors: Takayuki Suzuki, Tokyo (JP); Takatugu Suzuki, Tokyo (JP); Issei Nakahara, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/531,289

(22) PCT Filed: Mar. 24, 2008
(86) PCT No.: PCT/JP2008/055395

§ 371 Date: Sep. 14, 2009

(30) Foreign Application Priority Data
Apr. 3, 2007 (JP) 2007-097135

(51) Int. Cl. C08L 1/10; B29D 11/00

(52) U.S. Cl. 428/1.31; 524/37; 264/1.1; 264/1.6

(57) ABSTRACT

Disclosed is a cellulose ester optical film characterized by containing a cellulose ester, a polymer (a) defined below and a compound (b) defined below. (a) a polymer obtained by copolymerizing an ethylenically unsaturated monomer having a partial structure represented by the general formula (1) below in a molecule and at least one ethylenically unsaturated monomer (b) at least one compound selected from the group consisting of carbon radical scavengers, phenol compounds and phosphorus compounds. (In the formula, R¹, R² and R³ independently represent an optionally substituted aliphatic group, an optionally substituted aromatic group or an optionally substituted heterocyclic group; or alternatively any two of R¹, R² and R³ may combine and form a ring structure together with a nitrogen atom or with a nitrogen atom and a carbon atom to which they are bonded to.)

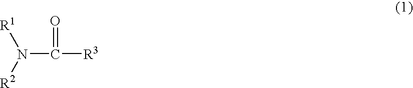

### TECHNICAL FIELD

The invention relates to a cellulose ester optical film, a polarization plate and a liquid crystal display using the cellulose ester optical film and a method for producing the cellulose ester optical film.

### TECHNICAL BACKGROUND

Liquid crystal displays (LCD) are widely applied to the displays of word processors, personal computers, televisions, monitors and portable information displaying terminals because the liquid crystal display can be driven with low electric power consumption and directly connected with an IC circuit and the display can be made thinner by the use of the LCD. The basic structure of the CLD is, for example, one composed of a liquid crystal cell and polarization plates provided on both sides of the liquid crystal cell.

The polarization plate is transparent only to light having a certain direction of the plane of polarization. Consequently, the LCD carries important role to visualize the variation of the orientation of the liquid crystals by the electric field. Therefore, the properties of the LCD are strongly depended on the properties of the polarization plate.

The polarizer of the polarization plate is prepared by adsorbing iodine to a polymer film and extending the film. In concrete, a solution containing a dichromatic substance (iodine) called as H-ink is adsorbed onto a poly(vinyl alcohol) film in a wet condition and the film is mono-axially extending to orient the dichromatic substance in one direction. Cellulose ester, particularly cellulose triacetate, is widely used as the protective film of the polarizing plate.

The cellulose ester film is commonly and widely used since which is optically and physically suitable as the protective layer of the polarization plate. However, the cost necessary for recovering the solvent is very heavy burden since the usual method for producing the film is a solution-casting film forming method using a halogen-containing solvent. Moreover, the halogen-containing solvent poses a problem that the solvent causes high environmental load. Recently, it is tried to produce the cellulose ester film for the protective layer of the polarization plate by a melt film forming method as disclosed in Patent Publication 1, for example. It is known, however, that large problems are posed that the physical properties such as the flatness and dimensional stability and the important optical properties such as the uniformity of double refractivity, particularly in the cross direction of the film, are lower than those of the film produced by the solution-casting method because the melted cellulose ester is difficultly leveled and solidified in short period after extrusion when the cellulose ester is extruded through a die onto a cooling drum or a cooling belt since the cellulose ester is a polymer having very high viscosity in the melted state and has high glass transition temperature. Improvement in such the drawbacks is demanded because which cause contrast lowering and ununiformity of displayed image when the polarization plate is built in a large size display of 15 inches or more. Moreover, serious problems such as lowering in the stability in the processing by thermal decomposition, occurrence of brightening foreign matter observable by polarized light and coloring are posed since the melt-casting method is a process performed at a high temperature not less than 150° C. Particularly, improvements in the occurrence of the brightening foreign matter and the coloring at the both edges of the cross direction of the film are difficult in the present circumstance. When producing the wide width cellulose ester film is produced, the portion of both edges of the film subjected to knurling treatment and that the film cut-off on the occasion of slitting the raw film into the designated width are effectively applied as recovered materials. However, the edge portion cannot be used as the recovered material and should be discarded when the coloring at the edge portion is considerable. Therefore, the coloring at the edge portion is particularly demanded to be improved.

It is known to use plasticizers for improving the processing stability of the cellulose ester. Among them, polymers and copolymers of a vinyl monomer having an amide bond are disclosed as the plasticizer excellent in the elasticity, non-volatility and non-transferability; cf. Patent Publication 2, for example. It is found, however, that the important problem of considerable coloring of the optical film cannot be improved even when the method disclosed in Patent publication 2 is applied to the melt-casting method.

On the other hand, methods for inhibiting the thermal deterioration of the cellulose ester on the occasion of the melt-casting by adding a phenol type anti-degradation agent, a thioether type compound and a phosphor type compound are disclosed (for example, Patent Publications 3 and 4).

However, the improvements in the processing stability, the uniformity in the double refraction, the occurrence of the brightening foreign matter and the coloring are insufficient. Particularly, the improvements in the ununiformity of the refraction in the cross direction of the film, occurrence of the foreign matter and the coloring at the both edge portions of the cross direction of the film is insufficient in the present circumstance.
Patent Publication 1: Unexamined Japanese Patent Application Publication (hereinafter also referred to as JP-A) No. 2000-352620
Patent Document 2: JP-A No. 2000-212224
Patent Document 3: JP-A No. 2006-241428
Patent Document 4: JP-A No. 2006-251746

### DISCLOSURE OF THE INVENTION

An object of the invention is to provide a cellulose ester optical film which has excellent optical properties such as reduced variation of the retardation in the cross direction of the film, inhibited occurrence of the brightening foreign matter and reduced coloring at the edge portions of the cross direction of the film, a polarization plate and a liquid crystal display using the cellulose ester optical film, and a production method of the cellulose ester optical film in which the loads on the production, equipment and environment accompanied with the drying and recovering the solvent are reduced.

On of the embodiments of the invention for attaining the above object is an optical film containing cellulose ester, a polymer of the following (a) and a compound of the following (b), in which (a) is a polymer obtained by copolymerizing an ethylenic unsaturated monomer having a partial structure represented by the following Formula (1) in the molecular thereof and an ethylenic unsaturated monomer and (b) is a compound selected from the group consisting of a carbon radical trapping agent, a phenol type compound and a phosphor type compound.

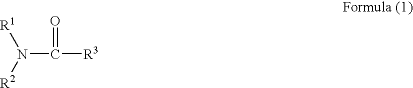

In the formula, R¹, R² and R³ are each independently an aliphatic group, an aromatic group or a heterocyclic group; the aliphatic group, aromatic group and heterocyclic group each may have a substituent. Two of R¹, R² and R³ may form a cyclic structure by combining together with the nitrogen atom or the carbon and nitrogen atoms bonded with these groups.

### BRIEF DESCRIPTION OF THE DRAWINGS

FIG. 1 shows a schematic flow sheet of an embodiment of equipment for performing the production method of the cellulose ester optical film of the invention.

FIG. 2 shows an enlarged flow sheet of principal part of the production equipment shown in FIG. 1.

FIG. 3a shows a schematic drawing of an example of principal portion of casting die, and FIG. 3b shows a cross section of principal portion of casting die.

FIG. 4 shows a cross section of the first embodiment of pressing rotation member.

FIG. 5 shows a cross section of the second embodiment of pressing rotation member on the plane vertical to the rotating axis.

FIG. 6 shows a cross section of the second embodiment of pressing rotation member on the plane including the rotating axis.

FIG. 7 shows an exploded perspective view of schematic constitution of liquid crystal display.

### DESCRIPTION OF THE PREFERRED EMBODIMENTS

The above object has been attained by the following constitutions:

1. A cellulose ester optical film comprising a cellulose ester, a polymer (a) and a compound (b), wherein

the polymer (a) is obtained by copolymerizing an ethylenically unsaturated monomer having a partial structure represented by Formula (1) in a molecule and at least one ethylenically unsaturated monomer,

the compound (b) is at least one compound selected from the group consisting of carbon radical trapping agents, phenol compounds and phosphorous compounds;

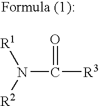

wherein R¹, R² and R³ represents each independently an aliphatic group, an aromatic group or a heterocyclic group, each of which may have a substituent; and any two of R¹, R² and R³ may form a cyclic structure by combining together with the nitrogen atom or the carbon and nitrogen atoms bonded with these groups.

2. The cellulose ester optical film of item 1, wherein a weight average molecular weight of the polymer (a) is 1,000 or more and 70,000 or less.
3. The cellulose ester optical film of item 1 or 2, wherein the ethylenically unsaturated monomer having a partial structure represented by Formula (1) is N-vinylpyrrolidone, N-acryloylmorpholine, N-vinylpiperidone, N-vinylcaprolactam or a mixture of thereof.
4. The cellulose ester optical film of any one of items 1 to 3, wherein the cellulose ester satisfies a degree of substitution in expressions (1) to (3);

2.4≦A+B≦3.0 Expression (1)

0≦A≦2.4 Expression (2)

0.1≦B<3.0, Expression (3)

wherein A represents a degree of substitution of an acetyl group, and B represents sum of a degree of substitution of an acyl group having 3 to 5 carbon atoms.

5. The cellulose ester optical film of any one of items 1 to 4, wherein the carbon radical trapping agent is a compound represented by Formula (2);

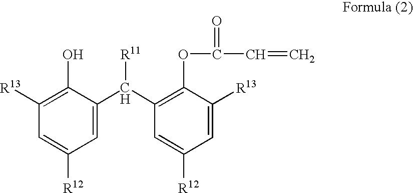

wherein R¹¹ represents a hydrogen atom or an alkyl group having 1 to 10 carbon atoms, and R¹² and R¹³ each independently represents an alkyl group having 1 to 8 carbon atoms,

6. The cellulose ester optical film of any one of items 1 to 4, wherein the carbon radical trapping agent is a compound represented by Formula (3);

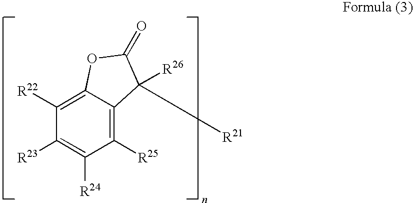

wherein R²² to R²⁶ represents each independently a hydrogen atom, an aliphatic group, an aromatic group or a heterocyclic group, each of which may have a substituent; n represents 1 or 2; when n is 1, R²¹ represents an aliphatic group, an aromatic group or a heterocyclic group, each of which may have a substituent; and when n is 2, R²¹ represents an divalent linking group.

7. The cellulose ester optical film of any one of items 1 to 6, wherein the phosphorous compound is a phosphonite compound represented by Formula (4) or (5);

R³¹P(OR³²)₂, Formula (4)

wherein R³¹ represents a phenyl group or a thienyl group, each of which may have a substituent; R³² represents an alkyl group, a phenyl group or a thienyl group, each of which may have a substituent; and a plurality of R³² may combine and form a ring structure together;

(R³⁴O)₂PR³³—R³³P(OR³⁴)₂, Formula (5)

wherein R³³ represents a phenylene group or a thienylene group, each of which may have a substituent; R³⁴ represents an alkyl group, a phenyl group or a thienyl group, each of which may have a substituent; and a plurality of R³⁴ may combine and form a ring structure together.

8. The cellulose ester optical film of item 7, wherein R³⁴ in Formula (5) is a substituted phenyl group comprising a substitute having a total number of carbon atoms of 9 to 14 per one phenyl group, provided that a substituted phenyl group way comprise a plurality of substitute per one phenyl group within a range of total number of carbon atoms being 9 to 14.
9. The cellulose ester optical film of item 8, wherein the phosphonite compound represented by Formula (5) is tetrakis(2,4-di-t-butyl-5-methylphenyl) 4,4′-biphenylene diphosphonite.
10. The cellulose ester optical film of any one of items 1 to 9, wherein an amount of the carbon radical trapping agent is 0.1 to 1.0 parts by weight, an amount of the phenol compound is 0.2 to 2.0 parts by weight and an amount of the phosphorous compound is 0.1 to 1.0 parts by weight, each to 100 parts by weight of the cellulose ester
11. The cellulose ester optical film of any one of items 1 to 10 comprising at least one ester type plasticizer obtained from a polyhydric alcohol and a monovalent carboxylic acid.
12. The cellulose ester optical film of any one of items 1 to 11 comprising at least one of an ultraviolet absorbent.
13. The cellulose ester optical film of any one of items 1 to 12 comprising at least one of fine particles.
14. A polarizing plate comprising the cellulose ester optical film of any one of items 1 to 13.
15. A liquid crystal display apparatus comprising the cellulose ester optical film of any one of items 1 to 13 or the polarizing plate of item 14.
16. A method for producing a cellulose ester optical film comprising a step of a melt casting, wherein the cellulose ester optical film comprising a cellulose ester, a polymer (a) and a compound (b), wherein

the polymer (a) is obtained by copolymerizing an ethylenically unsaturated monomer having a partial structure represented by Formula (1) in a molecule and at least one ethylenically unsaturated monomer,

the compound (b) is at least one compound selected from the group consisting of carbon radical trapping agents, phenol compounds and phosphorous compounds;

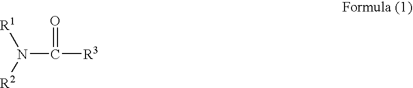

wherein R¹, R² and R³ represents each independently an aliphatic group, an aromatic group or a heterocyclic group, each of which may have a substituent; or any two of R¹, R² and R³ may form a cyclic structure by combining together with the nitrogen atom or the carbon and nitrogen atoms bonded with these groups.

17. The method for producing the cellulose ester optical film of item 16, wherein a yellow index Yc of a center portion and a yellow index Ye of an edge portion of a film after melt extrusion satisfies expression (4),

1.0≦Ye/Yc≦5.0. Expression (4)

18. The method for producing the cellulose ester optical film of item 16 or 17 comprising a step of a stretching, wherein the cellulose ester film after melt extrusion is stretched at a magnification of 1.0 through 4.0 times in one direction and is stretched at a magnification of 1.01 through 4.0 times in the direction perpendicular to each other.

The best embodiment for embodying the invention is described in detail below but the invention is not limited to the described embodiment.

The production method of the cellulose ester optical film is roughly classified into two kinds. One of them is the solution casting method in which a solution of cellulose ester prepared by dissolving cellulose ester in a solvent is cast and the solvent is evaporated and dried to form a film. In such the method, the solvent remaining in the film should be removed. Therefore, investment in plant and equipment such as the drying line, drying energy and recovering and recycling of the evaporated solvent is made massive. It is important subject to reduce such the cost. In contrast, in the film formation by the melt-casting method, any solvent for preparing the cellulose ester solution is not used, and the load of the drying and equipment is not caused. Therefore, the melt-casting method is particularly preferred in the invention than the solution-casting method.

As a result of investigation by the inventors, it is found that the uniformity of retardation is surprisingly improved by melt-casting the cellulose ester film containing the polymer having the specified amide structure and a compound selected from the group consisting of a carbon radical trapping agent, a phenol type compound and a phosphor type compound. Moreover, it is also found that the coloring at the edge portion of the film in the width direction can be improved and the occurrence of the brightening matter can be reduced. Thus it is understood that the cellulose ester optical film having the properties equivalent or higher compared with those of the film produced by the solution-casting method can be obtained by the melt-casting method.

The compounds to be used in the invention are described in detail below.

(The Forgoing Polymer (a))

The cellulose ester film of the invention contains at least one kind of polymer obtained by copolymerizing an ethylenic unsaturated monomer having a partial structure represented by the following Formula (1) in the molecule thereof and an ethylenic unsaturated monomer.

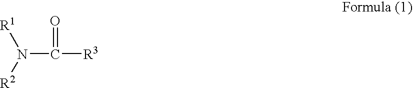

In the formula, R¹, R² and R³ are each independently an aliphatic group, an aromatic group or a heterocyclic group, each of which may have a substituent. Any two of R¹, R² and R³ may form a cyclic structure by combining together with the nitrogen atom or the carbon and nitrogen atoms bonded with these groups. The aliphatic group, aromatic group and heterocyclic group, each may have a substituent is not specifically limited and examples of them include an alkyl group such as a methyl group, an ethyl group, a propyl group, an isopropyl group, a t-butyl group, a pentyl group, a hexyl group, an octyl group, a dodecyl group and a trifluoromethyl group; a cycloalkyl group such as a cyclopentyl group and a cyclohexyl group; an aryl group such as a phenyl group and a naphthyl group; an acylamino group such as an acetylamino group and a benzoylamino group; an alkylthio group such as a methylthio group and an ethylthio group; an arylthio group such as a phenylthio group, and a naphthylthio group; an alkenyl group such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group; a halogen atom such as a fluorine atom, a chlorine atom, a bromine atom and an iodine atom; an alkynyl group such as a propargyl group; a heterocyclic group such as a pyridyl group, a thiazolyl group, an oxazolyl group and an imidazolyl group; an alkylsulfonyl group such as a methylsulfonyl group and an ethylsulfonyl group; an arylsulfonyl group such as a phenylsulfonyl group and a naphthylsulfonyl group; an alkylsulfinyl group such as a methylsulfinyl group; an arylsulfinyl group such as a phenylsulfinyl group; a phosphono group; an acyl group such as an acetyl group, a pivaloyl group and a benzoyl group; a carbamoyl group such as an aminocarbonyl group, a methylaminocarbonyl group, a dimethylaminocarbonyl group, a butylaminocarbonyl group, a cyclohexylaminocarbonyl group, a phenylaminocarbonyl group and a 2-pyridylamino-carbonyl group; a sulfamoyl group such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group; a sulfonamide group such as a methanesulfonamido group and benzenesulfonamido group; a cyano group; an alkoxy group such as a methoxy group, an ethoxy group and a propoxy group; an aryloxy group such as a phenoxy group and a naphthyloxy group; a heterocycloxy group; a siloxy group; an acyloxy group such as an acetyloxy group and a benzoyloxy group; a sulfonic acid group and its salt; an aminocarbonyloxy group; an amino group such as an amino group, an ethylamino group, a dimethylamino group, a butylamino group, a cyclopentylamino group, a 2-ethylhexylamino group and a dodecylamino group; an anilino group such as a phenylamino group, a chlorophenylamino group, a toluidino group, an anisidino group, a naphthylamino group and a 2-pyridylamino group; an imido group; a ureido group such as a methylureido group, an ethylureido group, a pentylureido group, a cyclohexylureido group, an octylureido group, a dodecylureido group, a phenylureido group, a naphthylureido group and a 2-pyridylaminoureido group; an alkoxycarbonylamino group such as a methoxycarbonylamino group and a phenoxycarbonylamino group; an alkoxycarbonyl group such as a methoxycarbonyl group, an ethoxycarbonylamino group and a phenoxycarbonyl group; an arylcarbonyl group such as a phenoxycarbonyl group; a heterocyclothio group, a thioureido group, a carboxyl group and its salt, a hydroxyl group, a mercapto group and a nitro group. These substituents each may be further substituted by the above substituents.

In the invention, any two of R¹, R² and R³ may be combined to form a five- to seven-member cyclic structure together with the nitrogen atom or the nitrogen atom and the carbon atom bonded with the groups. The thus formed ring may further contain a nitrogen atom, a sulfur atom or an oxygen atom, and the ring includes a saturated or unsaturated single-, multi- or condensed-ring. Concrete examples include a heterocyclic ring such as a pyrrolidine ring, a piperidine ring, a piperazine ring, a pyrrole ring, a morpholine ring, a thiamorpholine ring, an imidazole ring, a pyrazole ring, a pyrrolydone ring and a piperidine ring. These rings each may be further substituted by the substituent which is described as the substituents of the group represented by R¹, R² or R³.

In the invention, the ethylenic unsaturated monomer having the partial structure represented by Formula (1) has an ethylenic unsaturated bond in the molecular thereof, and such the fact means that at least one of the groups represented by R¹, R² or R³ is an alkenyl group as the group having the ethylenic unsaturated bond or at least one of the groups represented by R¹, R² and R³ has an ethylenic unsaturated bond as a partial structure. Concrete examples of the ethylenic unsaturated bond include a vinyl group, an allyl group, an acryloyl group, a methacryloyl group, a styryl group, an acrylamido group, a methacrylamido group, a vinyl cyanide group, a 2-cyanoacryloxi group, a 1,2-epoxy group, a vinylbenzyl group and a vinyl ether group. The group is preferably a vinyl group, an acryloyl group, a methacryloyl group, an acrylamido group and a methacrylamido group.

Preferable examples of the ethylenic unsaturated monomer having the partial structure represented by Formula (1) to be used in the invention are listed below but the monomer is not limited to them.

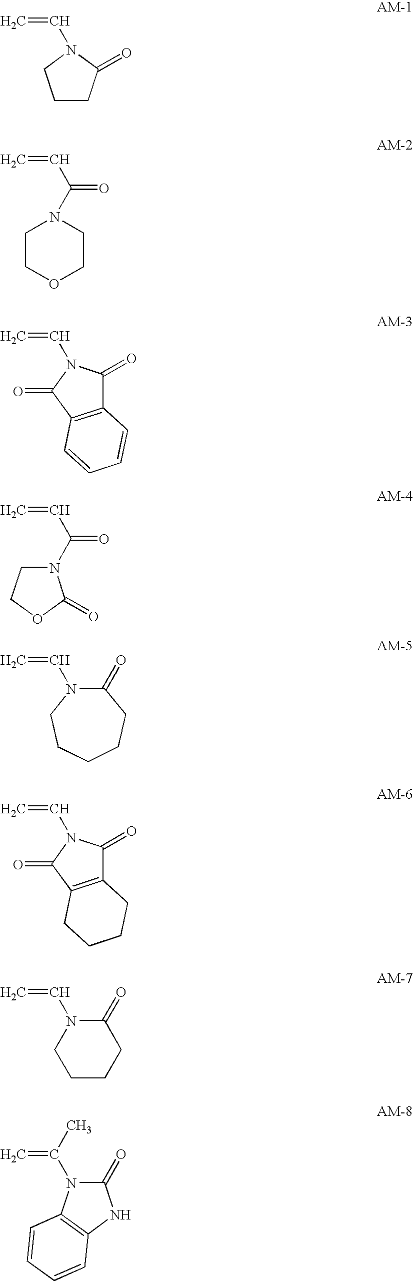

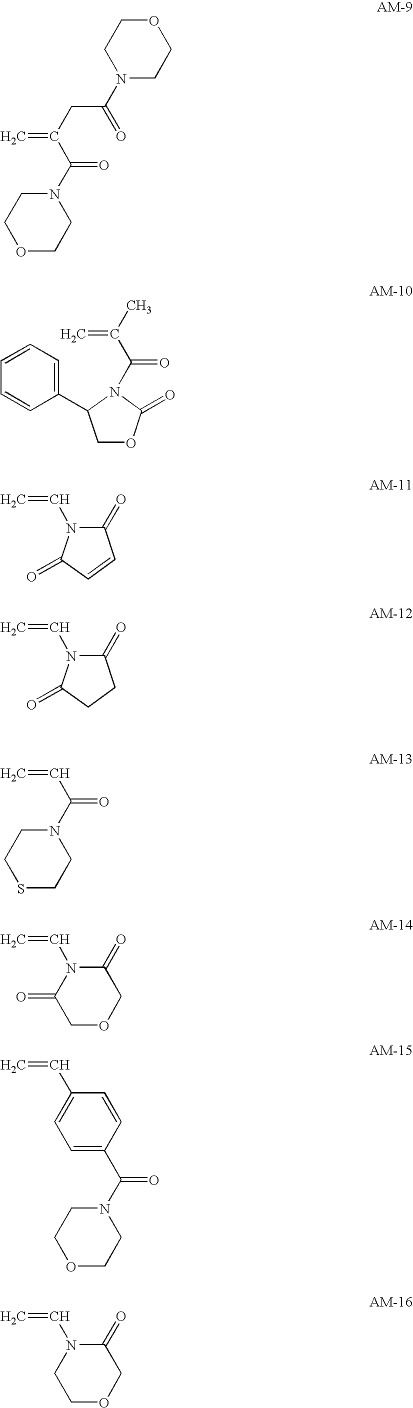

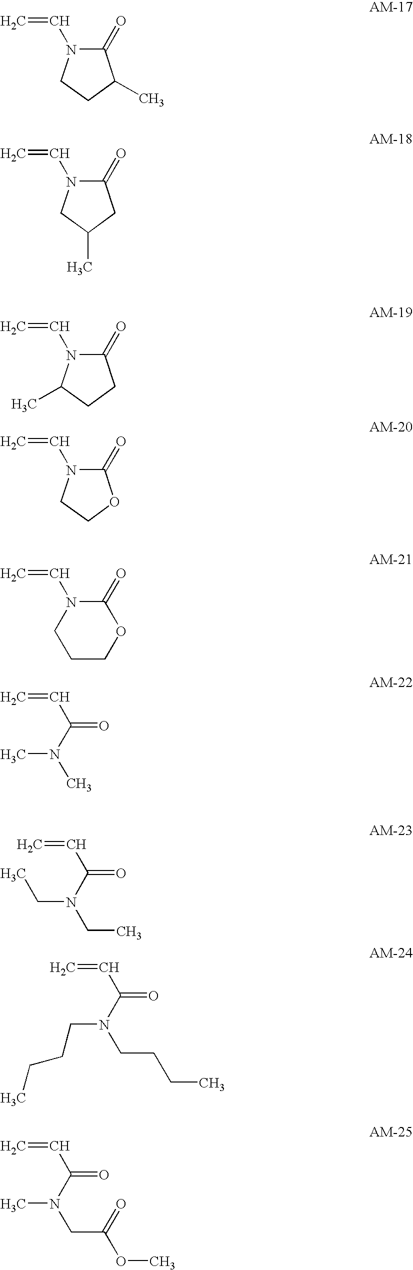

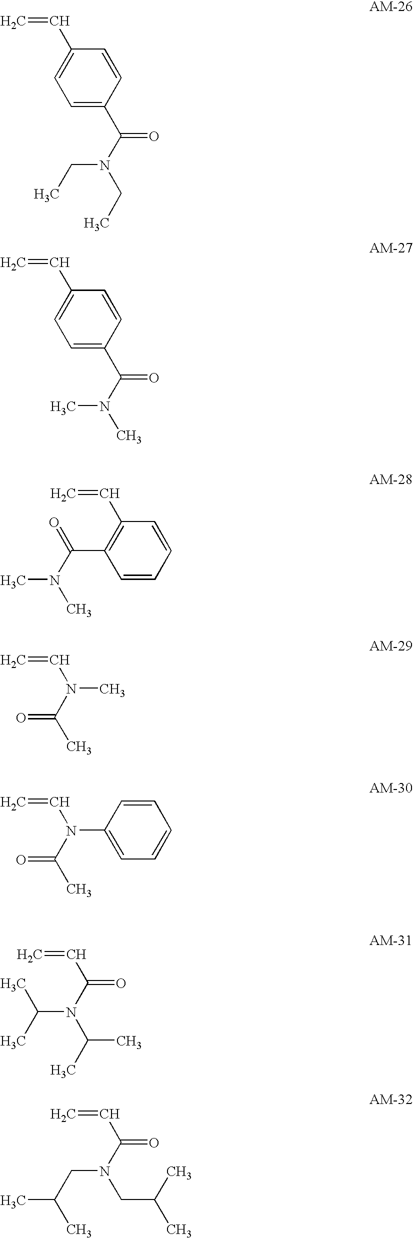

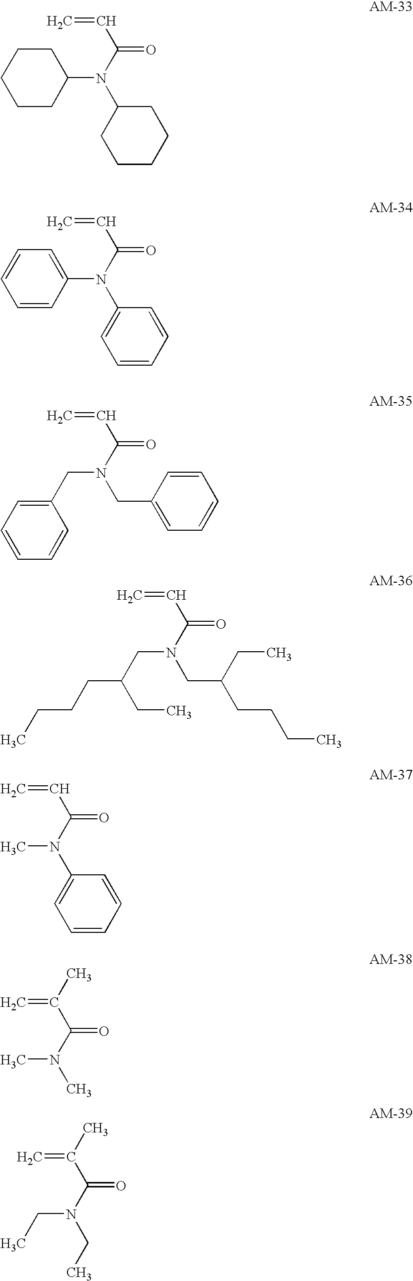

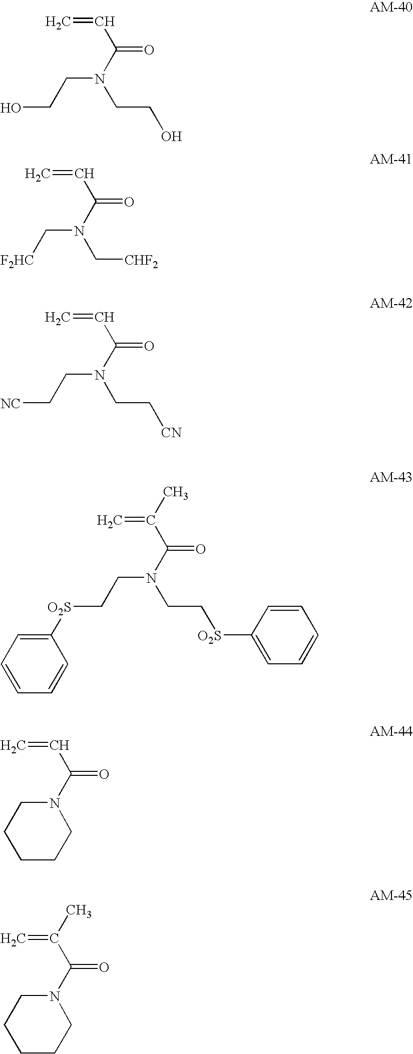

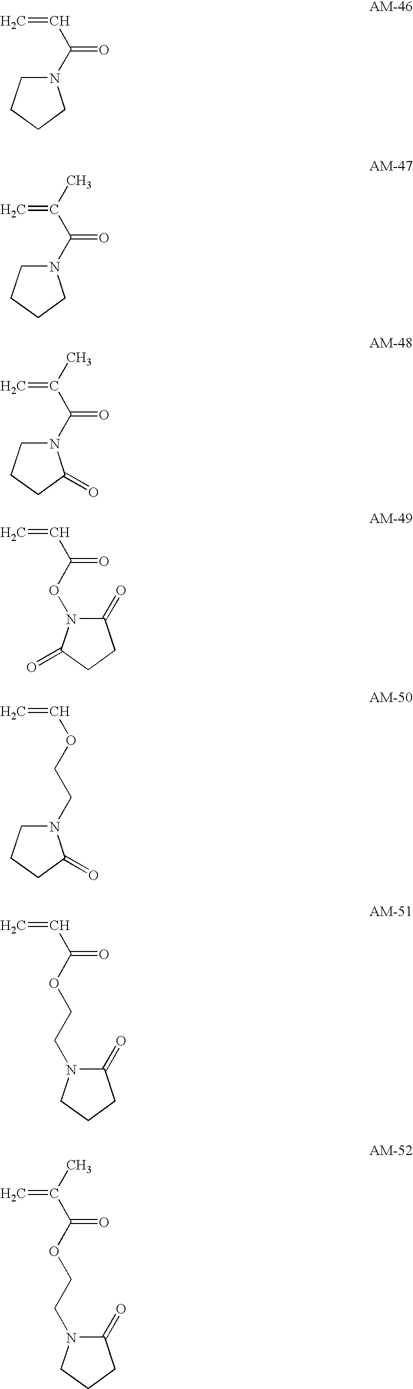

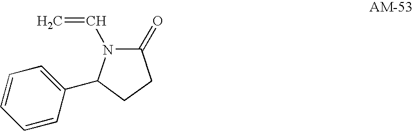

The ethylenic unsaturated monomer having the partial structure represented by Formula (1) may be used singly or in the combination of two or more kinds thereof N-vinylpyrrolidone, N-acryloylmorpholine, N-vinylpiperidone, N-vinylcaprolactum and a mixture thereof are particularly preferred.

The ethylenic unsaturated monomer having the partial structure represented by Formula (1) in the molecular thereof to be used in the invention is available on the market or by synthesizing referring known publications.

The ethylenic unsaturated monomer capable of being copolymerized with the ethylenic unsaturated monomer having the partial structure represented by Formula (1) may be the ethylenic unsaturated monomer having the partial structure represented by Formula (1). However, that is preferably ones other than the ethylenic unsaturated monomer having the partial structure represented by Formula (1). For example, the following unsaturated compounds can be cited; methacrylic acid and an ester derivative thereof such as methyl methacrylate, ethyl methacrylate, propyl methacrylate, butyl methacrylate, i-butyl methacrylate, t-butyl methacrylate, octyl methacrylate, cyclohexyl methacrylate, 2-hydroxyethyl methacrylate, 2-hydroxypropyl methacrylate, tetrahydrofurfuryl methacrylate, benzyl methacrylate, dimethylaminoethyl methacrylate and diethylaminoethyl methacrylate; and acrylic acid and an ester derivative thereof such as methyl acrylate, ethyl acrylate, propyl acrylate, butyl acrylate, i-butyl acrylate, t-butyl acrylate, octyl acrylate, cyclohexyl acrylate, 2-hydroxyethyl acrylate, 2-hydroxypropyl acrylate, tetrahydrofurfuryl acrylate, 2-ethoxyethyl acrylate, diethyleneglycolethoxylate acrylate, 3-methoxybutyl acrylate, benzyl acrylate, dimethylaminoethyl acrylate and diethylaminoethyl acrylate; an alkyl vinyl ether such as methyl vinyl ether, ethyl vinyl ether and butyl vinyl ether; a vinyl alkylate such as vinyl formate, vinyl acetate, vinyl butylate, vinyl caproate and vinyl stearate; a styrene derivative such as styrene, α-methylstyrene, o-methylstyrene, m-methylstyrene, p-methylstyrene and vinylnaphthalene; crotonic acid, maleic acid, fumaric acid, itaconic acid, acrylonitrile and methacrylonitrile. These compounds can be copolymerized singly or in combination of two or more kinds thereof together with the ethylenic unsaturated monomer having the partial structure represented by Formula (1).

Among these ethylenic unsaturated monomer, acrylates and methacrylates such as methyl methacrylate, ethyl methacrylate, propyl methacrylate, butyl methacrylate, methyl acrylate, ethyl acrylate, propyl acrylate and butyl acrylate; vinyl alkylates such as vinyl formate, vinyl acetate, vinyl butylate, vinyl caproate and vinyl stearate; and styrene derivatives such as styrene, α-methylstyrene, o-methylstyrene, m-methylstyrene, p-methylstyrene and vinylnaphthalene are preferable.

The weight average molecular weight of the copolymer of (a) to be used in the invention is preferably within the range of from 1,000 to 70,000, and particularly preferably from 2,000 to 50,000. When the weight average molecular weight is less than 1,000, oozing out to the film surface tends to be caused. When the weight average molecular weight is more than 70,000, the compatibility with the resin tends to be lowered. The ratio Mw/Mn of the weight average molecular weight Mw to the number average molecular weight Mn is preferably within the range of from 1.5 to 4.0, and particularly preferably from 1.5 to 3.0.

The ratio of the ethylenic unsaturated monomer having the partial structure represented by Formula (1) in the molecular thereof in the copolymer (a) to be used in the invention is decided referring the influence on the compatibility of the obtained copolymer with the transparent resin, and the transparency and mechanical strength of the optical film. It is preferable that the ethylenic unsaturated monomer having the partial structure represented by Formula (1) in the molecular thereof is added so that the content of it is made to 10 to 80% by weight, and more preferably from 20 to 70% by weight.

The method for synthesizing the copolymer of (a) in the invention is not specifically limited and known methods such as a radical polymerization, anion polymerization and cation polymerization method can be widely applied. As the initiator of the radical polymerization, an azo compound and a peroxide compound such as azobisisobutylonitrile (AIBN), a diester derivative of azobisbutylic acid and benzoyl peroxide are cited. The polymerization catalyst is not specifically limited, and an aromatic hydrocarbon type solvent such as toluene and chlorobenzene, a halogenized hydrocarbon type solvent such as dichloroethane and chloroform, an ether type solvent such as tetrahydrofuran and dioxane, an amide type solvent such as dimethylformamide, an alcohol type solvent such as methanol, an ester type solvent such as methyl acetate and ethyl acetate, a ketone type solvent such as acetone, cyclohexanone and methyl ethyl ketone and an aqueous solvent are cited for example. By the selection of the solvent, solution polymerization carried out in a uniform system, precipitation polymerization in which the formed polymer is precipitated or emulsion polymerization carried out in a micelle state can be performed.

The weight average molecular weight of the above copolymer can be controlled by known molecular weight controlling methods. As examples of such the molecular weight controlling methods, a method by adding a chain-transfer agent such as carbon tetrachloride, laurylmercaptane and octyl thioglycolate can be cited, The polymerization is usually performed at a temperature from room temperature to 130° C., and preferably from 50 to 110° C.

The copolymer (a) is preferably mixed with the cellulose ester forming the optical film in a ratio of from 0.1 to 50% by weight, and more preferably from 5 to 30% by weight. The mixing ratio is not specifically limited when the haze of the formed optical film is not more than 1.0%, the haze is preferably not more than 0.5%, and more preferably not more than 0.3%.

(Carbon Radical Trapping Agent)

“Carbon radical trapping agent” to be used in the invention is a compound which has a group (an unsaturated group such as that having a double or triple bond) capable of causing addition reaction with a carbon radical and gives a stable product not causing continuous reaction such as polymerization after the addition reaction with carbon radical. As the carbon radical trapping agent, a compound which has a group (an unsaturated group such as a methacryloyl group and an aryl group) capable of rapidly reacting with the carbon radical in the molecular thereof and radical polymerization preventing ability such as a phenol type compound and a lactone type compound is useful, and compounds represented by the following Formula (2) or (3) are particularly preferable.

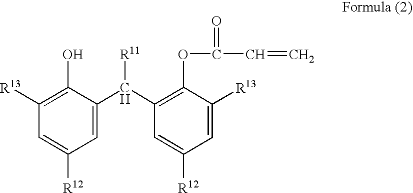

In Formula (2), R¹¹ is a hydrogen atom or an alkyl group having 1 to 10 carbon atoms, preferably a hydrogen atom or an alkyl group having 1 to 4 carbon atoms, and particularly preferably a hydrogen atom or a methyl group. R¹² and R¹³ are each independently an alkyl group having 1 to 8 carbon atoms which may have a straight chain, a branched chain or a cyclic structure. R¹² and R¹³ are preferably has a structure containing quaternary carbon atom represented by *—C(CH₃)₂—R′, in which * represents a bonding site with the aromatic ring and R′ is an alkyl group having 1 to 5 carbon atoms. R¹² is more preferably a tert-butyl group, tert-amyl group or a tert-octyl group. R¹³ is more preferably a tert-butyl group or a tert-amyl group, As the compound represented by Formula (1) available on the market, Sumilizer GM and Sumilizer GS, each trade name of product of Sumitomo Chemical Co., Ltd., are cited. Concrete examples of the compound represented by Formula (2) (1-1 to 1-18) are listed below but the invention is not limited to them.

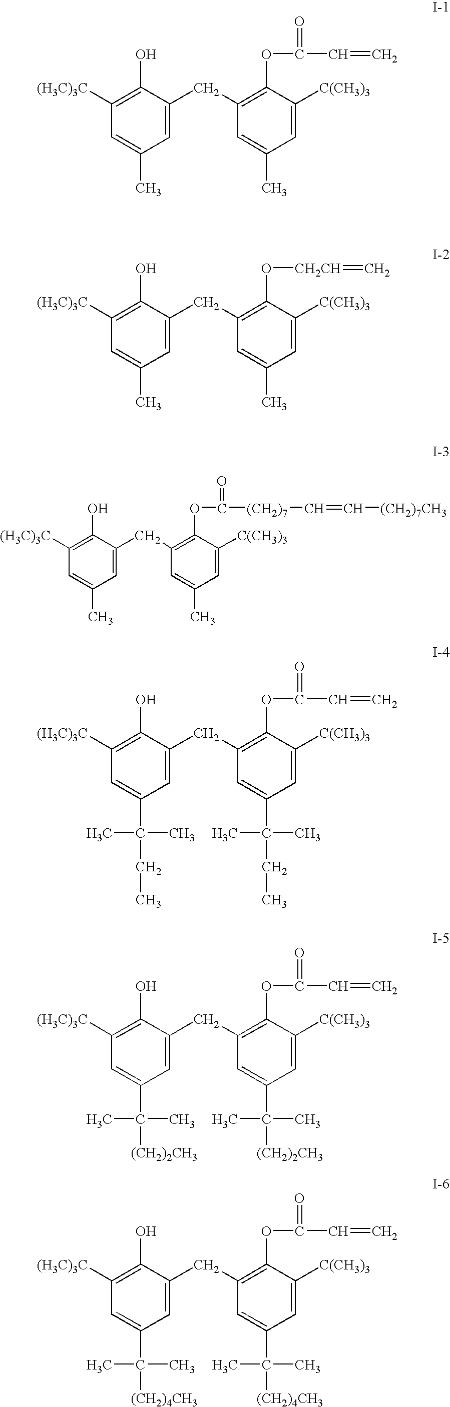

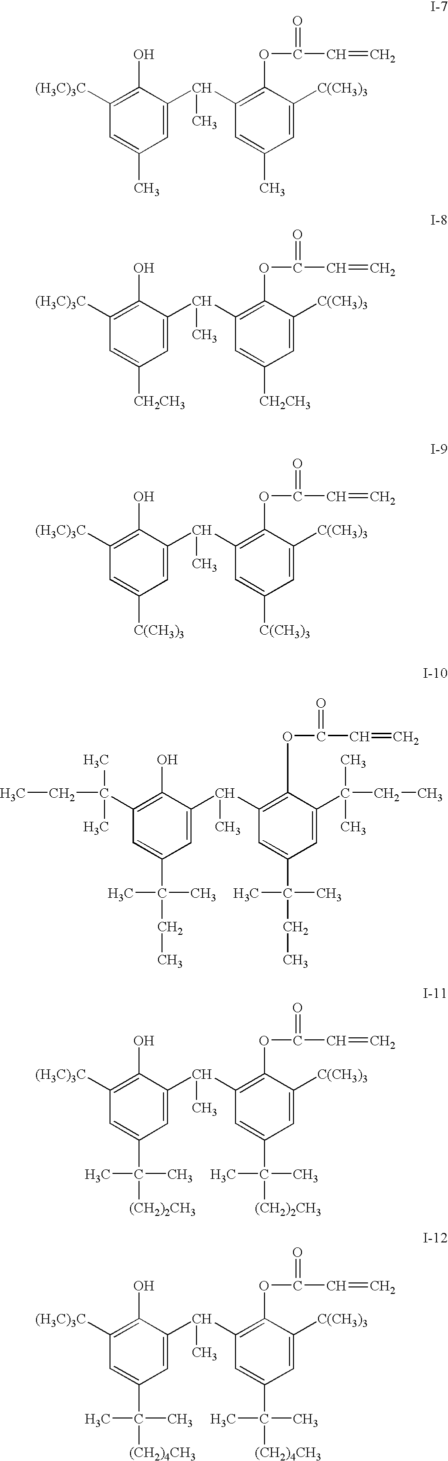

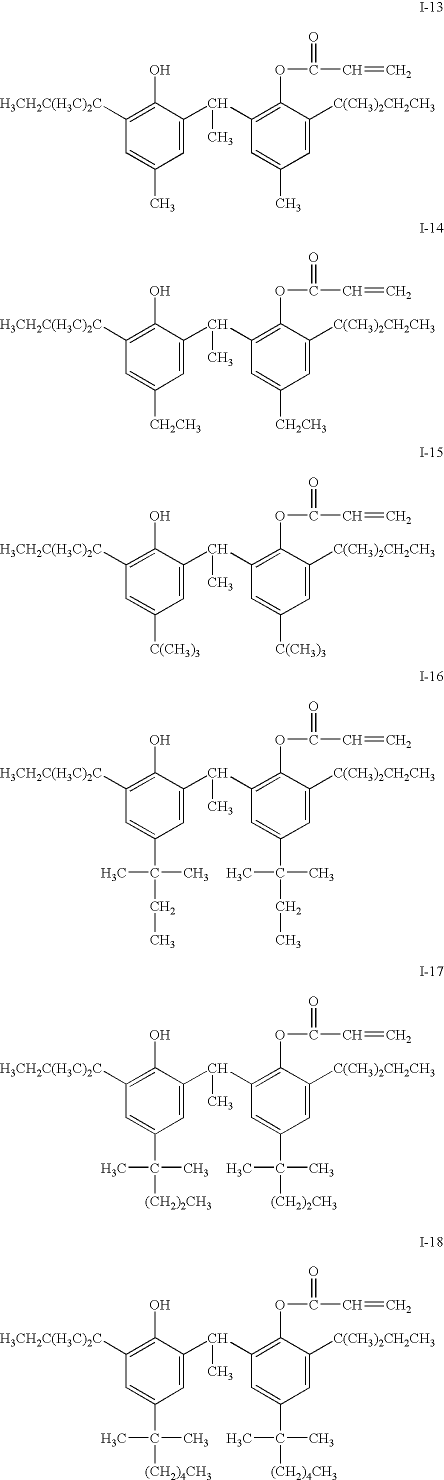

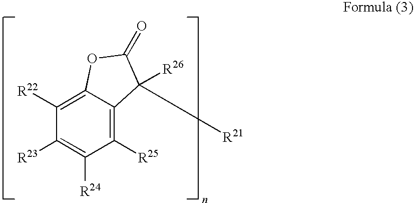

In Formula (3), R²² to R²⁶ are each independently a hydrogen atom or a substituent. The substituents represented by R²² to R²⁶ are not specifically limited. Examples of the substituent include an alkyl group such as a methyl group, an ethyl group, a propyl group, an i-propyl group, a t-butyl group, a pentyl group, a hexyl group, an octyl group, a dodecyl group and a trifluoromethyl group; a cycloalkyl group such as a cyclopentyl group and a cyclohexyl group; an aryl group such as a phenyl group and a naphthyl group; an acylamino group such as an acetylamino group and a benzoylamino group; an alkylthio group such as a methylthio group and an ethylthio group; an arylthio group such as a phenylthio group and a naphthylthio group; an alkenyl group such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group; a halogen atom such as a fluorine atom; a chlorine atom, a bromine atom and an iodine atom; an alkynyl group such as a propargyl group; a heterocyclic group such as a pyridyl group, a thiazolyl group, an oxazolyl group and an imidazolyl group; an alkylsulfonyl group such as a methylsulfonyl group and an ethylsulfonyl group; an arylsulfonyl group such as a phenylsulfonyl group and a naphthylsulfonyl group; an alkylsulfinyl group such as a methylsulfinyl group; an arylsulfinyl group such as a phenylsulfinyl group, a phosphono group; an acyl group such as an acetyl group, a pivaloyl group and a benzoyl group; a carbamoyl group such as an aminocarbonyl group, a methylaminocarbonyl group, dimethylaminocarbonyl group, a butylaminocarbonyl group, cyclohexylaminocarbonyl group, a phenylaminocarbonyl group and 2-pyridylaminocarbonyl group; a sulfamoyl group such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group; a sulfonamide group such as a methanesulfonamido group and a benzenesulfonamido group; a cyano group; an alkoxy group such as a methoxy group, an ethoxy group and a propoxy group; an aryloxy group such as a phenoxy group and a naphthyloxy group, a heterocycloxy group, a siloxy group; an acyloxy group such as an acetyloxy group and a benzoyloxy group, a sulfonic acid group and its salt, an aminocarbonyloxy group; an amino group such as an amino group, an ethylamino group, a dimethylamino group, a butylamino group, a cyclopentylamino group, a 2-ethylhexylamino group and a dodecylamino group; an anilino group such as a phenylamino group, a chloroamino group, a toluidino group, an anisidino group, a naphthylamino group and a 2-pyridylamino group, an imido group; a ureido group such as a methylureido group, an ethylureido group, a pentylureido group, a cyclohexylureido group, an octylureido group, a dodecylureido group, a phenylureido group, a napthylureido group and a 2-pyridylureido group; an alkoxycarbonylamino group such as a methoxycarbonylamino group and a phenoxycarbonylamino group, an alkoxycarbonyl group such as a methoxycarbonyl group, an ethoxycarbonyl group and a phenoxycarbonyl group; an aryloxycarbonyl group such as a phenoxycarbonyl group, a heterocycloxy group, a thioureido group, a carboxyl group and its salt, a hydroxyl group, a mercapto group and a mercapto group. These substituents each may be further substituted by the above substituents.

In Formula (3), n represents 1 or 2.

In Formula (3), R²¹ is a substituent when n is 1, and is a divalent bonding group when n is 2. When R²¹ is a substituent, groups the same as the substituents represented by R²² to R²⁶ are cited as the substituents.

When R²¹ is a divalent bonding group, an alkylene group which may have a substituent, an arylene group which may have a substituent, an oxygen atom, a nitrogen atom, a sulfur atom and a combination of them can be cited s the divalent bonding group.

In Formula (3), n is preferably 1.

Concrete examples of the compound represented by Formula (3) of the invention are listed below but the invention is not limited to the exemplified compounds.

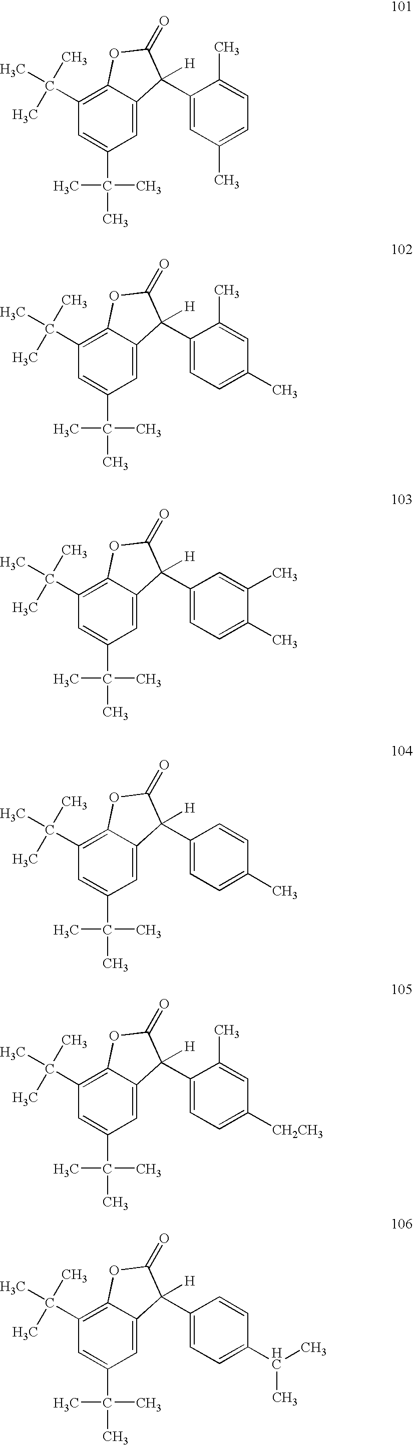

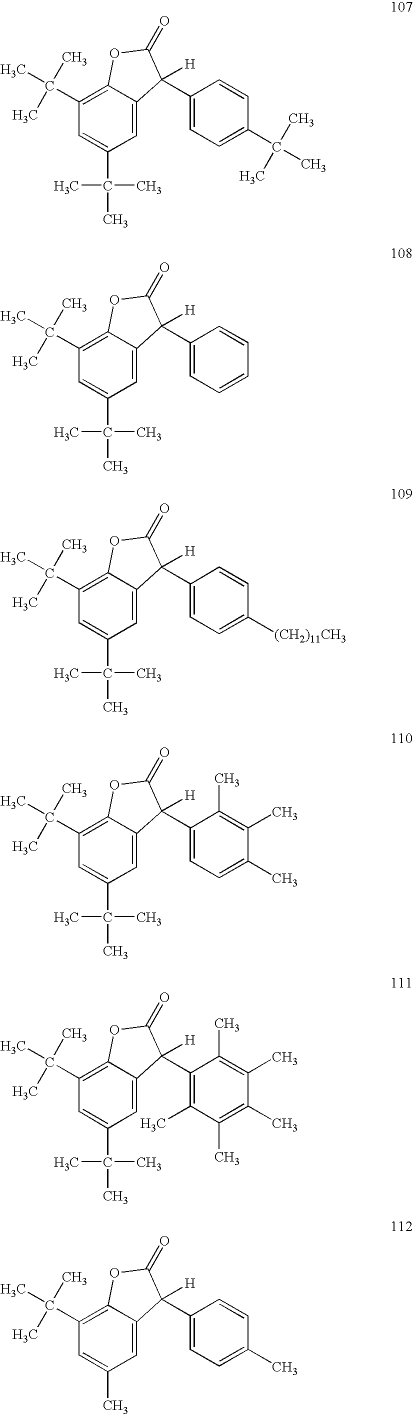

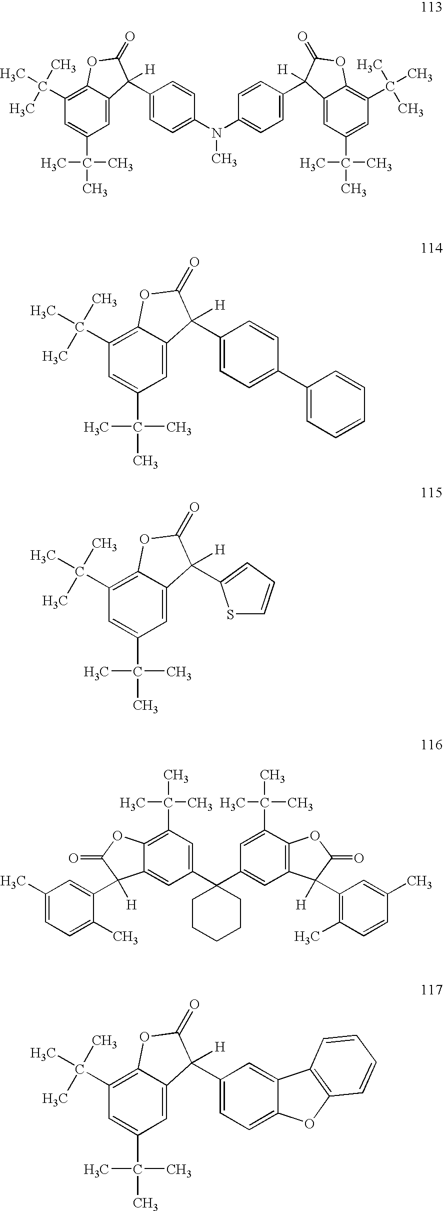

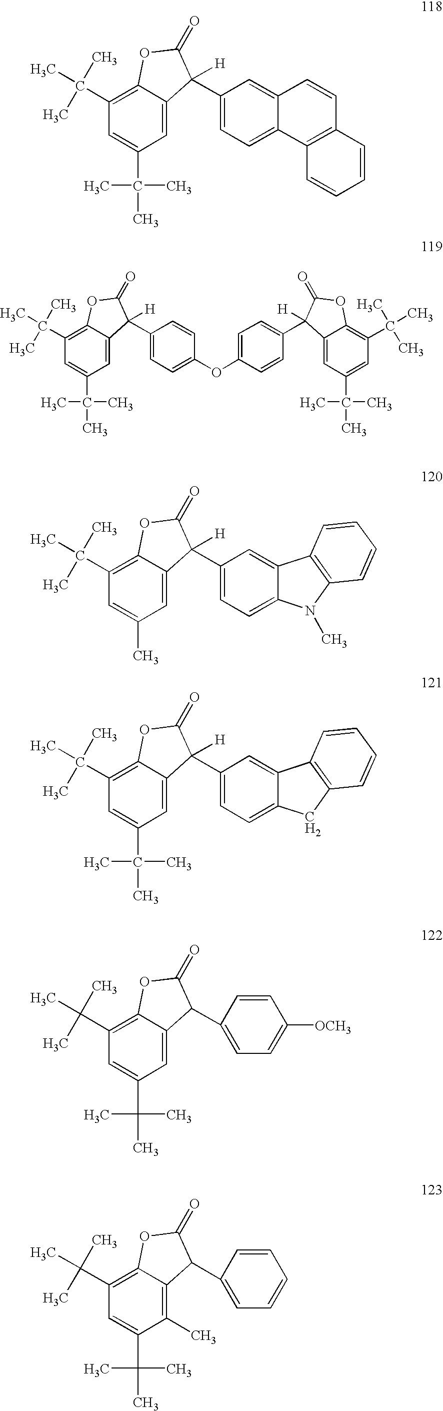

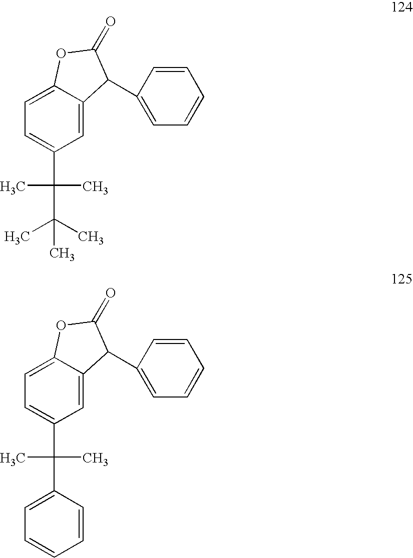

The above carbon radical trapping agents can be used singly or in combination of two or more kinds of them. The adding amount of the agent is suitably selected within the range in which the object of the invention is not impeded, and the amount is usually from 0.001 to 10.0 parts by weight, preferably from 0.01 to 5.0 parts by weight, and further preferably from 0-1 to 1.0 parts by weight, to 160 parts by weight of the cellulose ester.

(Phenol Type Compound)

As the phenol type compounds to be used in the invention, a 2,6-dialkylphenol derivative such as those described in U.S. Pat. No. 4,839,405, columns 12 to 14, is preferable and compounds represented by the following Formula (6) are particularly preferable.

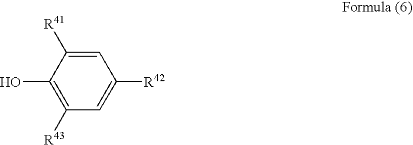

In the above formula, R⁴¹ R⁴² and R³⁴ are each a substituted or unsubstituted alkyl group. Concrete examples of the phenol type compound include n-octadecyl 3-(3,5-di-t-butyl-4-hydroxyphenyl)-propionate, n-octadecyl 3-(3,5-di-t-butyl-4-hydroxyphenyl)-acetate, n-octadecyl 3,5-di-t-butyl-4-hydroxybenzoate, n-hexyl 3,5-di-t-butyl-4-hydroxyphenyl-benzoate, n-dodecyl 3,5-di-t-butyl-4-hydroxyphenyl-benzoate, neododecyl 3-(3,5-di-t-butyl-4-hydroxyphenyl)-propionate, dodecyl β(3,5-di-t-butyl-4-hydroxyphenyl)-propionate, ethyl α-(4-hydroxy-3,5-di-t-butylphenyl)-isobutylate, octadecyl α-(4-hydroxy-3,5-di-t-butylphenyl)-isobutylate, octadecyl α-(4-hydroxy-3,5-di-t-butyl-4-hydroxyphenyl)propionate, 2-(n-octylthio)ethyl 3,5-di-t-butyl-4-hydroxy-benzoate, 2-(n-octylthio)ethyl 3,5-di-t-butyl-4-hydroxyphenylacetate, 2-(n-octadecylthio) ethyl 3,5-di-t-butyl-4-hydroxyphenylacetate, 2-(n-octadecyl-thio)ethyl 3,5-di-t-butyl-4-hydroxy-benzoate, 2-(2-hydroxyethylthio)ethyl 3,5-di-t-butyl-4-hydroxy-benzoate, diethylglycol bis-(3,5-di-t-butyl-4-hydroxy-phenyl)propionate, 2-(n-octadecylthio) ethyl 3-(3,5-di-t-butyl-4-hydroxyphenyl)propionate, stearylamido N,N-bis-[ethylene 3-(3,5-di-t-butyl-4-hydroxyphenyl)propionate], n-butylimino N,N-bis-[ethylene 3-(3,5-t-butyl-4-hydroxy-phenyl)-propionate, 2-(2-stearoyloxyethylthio)ethyl 3,5-di-t-butyl-4-hydroxybenzoate, 2-(2-stearoyloxyethylthio) ethyl 7-(3-methyl-5-t-butyl-4-hydroxyphenyl) heptanoate, 1,2-propyleneglycol bis-[3-(3,5-di-t-butyl-4-hydroxyphenyl)propionate], ethyleneglycol bis-[3-(3,5-di-t-butyl-4-hydroxyphenyl)propionate], neopentylglycol bis-[3-(3,5-di-t-butyl-4-hydroxyphenyl)propionate], ethyleneglycol bis-(3,5-di-t-butyl-4-hydroxyphenylacetate), glycelyl-1-n-octadecanoate-2,3-bis-(3,5-di-t-butyl-4-hydroxyphenylacetate), pentaerythritol-tetrakis-[3-(3′,5′-di-t-butyl-4′-hydroxy-Phenyl)propionate], 1,1,1-trimethylolethane-tris-[3-(3,5-di-t-butyl-4-hydroxyphenyl)propionate], sorbitol-hexa-[3-(3,5-di-t-butyl-4-hydroxyphenyl)propionate], 2-hydroxyethyl 7-(3-methyl-5-t-butyl-4-hydroxyphenyl)-propionate, 2-stearoyloxyethyl 7-(3-methyl-5-t-butyl-4-hydroxy-phenyl)hepanoate, 1,6-n-hexanediol-bis-[(3′,5′-di-t-butyl-4-hydroxypheyl)propionate] and pentaerythritol-tetrakis-(3,5-di-t-butyl-4-hydroxyphenylcinnamate). The above type phenol compounds are available on the market, for example, under the commercial name of Irganox 1076 and Irganox 1010, manufactured by Ciba Specialty Chemicals.

The phenol type compound can be used singly or in combination of two or more kinds thereof. The adding amount of the compound is suitably selected within the range in which the object of the invention is not impeded, and usually from 0.001 to 10.0 parts by weight, preferably from 0.05 to 5.0 parts by weight, and further preferably from 0.2 to 2.0 parts by weight, to 100 parts by weight of the cellulose ester.

(Phosphor Type Compound)

Known phosphor type compounds can be used as the phosphor type compound to be used in the invention. The compounds are preferably selected from the group consisting of phosphates, phosphonates, phosphinites and tertiary phosphanes. For example, those described in Japanese Laid-Open Patent Application Publication Nos. 2002-138188, 2005-344044 (paragraphs 0022 to 0027), 2004-182979 (paragraphs 0023 to 0039), Hei 10-306175, Hei 1-254744, Hei 2-270892, Hei 5-202078 and Hei 5-178870, Japanese Patent Application Publication Nos. 2004-504435 and 2004-530759, and Japanese Patent Application (translation of PCT application) No. 2005-353229 are preferable. As phosphor type compound, phosphonite compounds represented by Formulas (4) or (5) are more preferable.

In Formula (4), R³¹ is a phenyl group or a thienyl group each of which may have a substituent, R³² is an alkyl group, a phenyl group or a thienyl group each of which may have a substituent. R³² is preferably a substituted phenyl group. The total number of the carbon atoms of the substituent of the substituted phenyl group is preferably from 9 to 14, and more preferably from 9 to 11, though plural R³² may be bonded with together to form a ring.

The substituent is not specifically limited, and examples of it include an alkyl group such as a methyl group, an ethyl group, a propyl group, an isopropyl group, a t-butyl group, a pentyl group, a hexyl group, an octyl group, a dodecyl group and trifluoromethyl group; a cycloalkyl group such as a cyclopentyl group and a cyclohexyl group; an aryl group such as a phenyl group and a naphthyl group; an acylamino group such as an acetylamino group and a benzoylamino group; an alkylthio group such as a methylthio group and an ethylthio group; an arylthio group such as a phenylthio group and a naphthylthio group; at alkenyl group such as a vinyl group, a 2-propenyl group, a 3-butenyl group, a 1-methyl-3-propenyl group, a 3-pentenyl group, a 1-methyl-3-butenyl group, a 4-hexenyl group and a cyclohexenyl group; a halogen atom such as a fluorine atom, a chlorine atom, a bromine atom and an iodine atom: an alkynyl group such as a propargyl group; a heterocyclic group such as a pyridyl group, a thiazolyl group, an oxazolyl group and an imidazolyl group; an alkylsulfonyl group such as a methylsulfonyl group and an ethylsulfonyl group; an arylsulfonyl group such as a phenylsulfonyl group and a naphthylsulfonyl group; an alkylsulfinyl group such as a methylsulfinyl group; an arylsulfinyl group such as a phenylsulfinyl group, a phosphono group; an acyl group such as an acetyl group, a pivaloyl group and a benzoyl group; a carbamoyl group such as an aminocarbonyl group, a methylaminocarbonyl group, a dimethylaminocarbonyl group, a butylaminocarbonyl group, a cyclohexylaminocarbonyl group, a phenylaminocarbonyl group and a 2-pyridylaminocarbonyl group; a sulfamoyl group such as an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group; a sulfonamide group such as a methanesulfonamido group and a benzenesulfonamido group, a cyano group; an alkoxy group such as a methoxy group, an ethoxy group and a propoxy group, an aryloxy group such as a phenoxy group and a naphthyloxy group, a heterocycloxy group, a siloxy group; an acyloxy group such as an acetyloxy group and a benzoyloxy group, a sulfonic acid group and its salt, an amocaronyloxy group; an amino group such as an amino group, an ethylamino group, a dimethlamino group, a butylamino group, a cyclopentylamino group, a 2-ethylhexylamino group and a dodecylamino group; an anilino group such as a phenylamino group, a chlorophenylamino group, a toluidino group, an anisidino group, a naphthylamino group and a 2-pyridylamino group, an imido group; a ureido group such as a methylureido, an ethylureido group, a pentylureido group, a cyclohexylureido group, an octylureido group, a dodecylureido group, a phenylureido group, a naphthylureido group and a 2-pyridylaminoureido group, an alkoxycarbonyllamino group such as a methylcarbonylamino group, a phenoxycarbonylamino group, an alkoxycarbonyl group such as a methoxcarbonyl group, an ethoxycarbonyl group and a phenoxycarbonyl group; an aryloxycarbonyl group such as a phenoxycarbonyl group, a heterocyclothio group, a thioureido group, a carboxylic acid group and its salt, a hydroxyl group, a mercapto group and a nitro group. These groups each may be further substituted by the same substituents.

In Formula (5), R³³ is a phenylene group or a thienylene group each of which may have a substituent, R³⁴ is an alkyl group, a phenyl group or a thienyl group each of which may have a substituent. R³⁴ is preferably a substituted phenyl group. The total number of the carbon atoms of the substituent of the substituted phenyl group is preferably from 9 to 14, and more preferably from 9 to 11, though plural R³⁴ may be bonded with together to form a ring. The substituents are the same as those described as to R³².

As concrete examples of phosphonite compound represented by Formula (4), a dialkyl-phenylphosphonite such as dimethyl-phenylphosphonite and di-t-butyl-phenylphosphonite; a diphenylderivative-phosphonite such as diphenyl-phenylphosphonite, di-(4-pentyl-phenyl)-phenylphosphonite, di-(2-t-butylphenyl)-phenylphosphonite, di-(2-methyl-3-pentyl-phenyl)-phenylphosphonite, di-(2-methyl-4-octyl-phenyl)-phenylphosphonite, di-(3-butyl-4-methyl-phenyl)-phenylphosphonite, di-(3-butyl-4-ethyl-phenyl)-phenylphosphonite, di-(2,4,6-trimethylphenyl)-phenyl-phosphonite, di-(2,3-dimethyl-4-ethyl-phenyl)-phenylphosphonite, di-(2,6-diethyl-3-butylphenyl)-phenylphosphonite, di-(2,3-dipropyl-5-butylphenyl)-phenylphosphonite and di-(2,4,6-tri-t-butylphenyl)-phenylphosphonite are cited.

As the phosphonite compounds represented by Formula (5), the followings are cited: terakis-(2,4-di-t-butyl-phenyl)-4, 4′-biphenylenediphosphonite, terakis-(2,5-di-t-butyl-phenyl)-4,4′-biphenylenediphosphonite, terakis-(3,5-di-t-butylphenyl)-4,4′-biphenylenediphosphonite, terakis-(2,3,4-trimethylphenyl)-4,4′-biphenylene-di-phosphonite, terakis-(2,3-dimethyl-5-ethyl-phenyl)-4,4′-biphenylene-diphosphonite, terakis-(2,3-dimethyl-4-propyl-phenyl)-4,4′-biphenylene-diphosphonite, terakis-(2,3-dimethyl-5-t-butylphenyl)-4,4′-biphenylene-diphosphonite, terakis-(2,5-dimethyl-4-t-butylphenyl)-4,4′-biphenylene-diphosphonite, terakis-(2,3-diethyl-5-methylphenyl)-4,4′-biphenylene-diphosphonite, terakis-(2,6-diethyl-4-methylphenyl)-4,4′-biphenylene-di-phosphonite, terakis-(2,4,5-triethylphenyl)-4,4′-biphenylene-diphosphonite, terakis-(2,6-diethyl-4-propyl-phenzyl)-4,4′-biphenylene-diphosphonite, terakis-(2,5-diethyl 6-butylphenyl)-4,4′-biphenylene-diphosphonite, terakis-(2,3-diethyl-5-t-butylphenyl)-4,4′-biphenylene-di-phosphonite, terakis-(2,5-diethyl-S-t-butylphenyl)-4,4′-biphenylene-diphosphonite, terakis-(2,3-dipropyl-5-methylphenyl)-4,4′-biphenylene-diphosphonite, terakis-(2,6-dipropyl-4 methylphenyl)-4,4′-biphenylene-diphosphonite, terakis-(2,6-dipropyl-5-ethylphenyl)-4,4′-biphenylene-diphosphonite, terakis-(2,3-dipropyl-6-butylphenyl)-4,4′-biphenylene-diphosphonite, terakis-(2,6-dipropyl-5-butylphenyl)-4,4′-biphenylene-diphosphonite, terakis-(2,3-dibutyl-4-methylphenyl)-4,4′-biphenylene-diphosphonite, terakis-(2,5-dibutyl-3-methylphenyl)-4,4′-biphenylene-diphosphonite, terakis-(2,6-dibutyl-4-methylphenyl)-4,4′-biphenylene-diphosphonite, terakis-(2,4-di-t-butyl-3-methylphenyl)-4,4″-biphenylene-diphosphonite, terakis-(2,4-di-t-butyl-5-methylphenyl)-4,4′-biphenylene-diphosphonite, terakis-(2,4-di-t-butyl-6-methylphenyl)-4,4′-biphenylene-diphosphonite, terakis-(2,5-di-t-butyl-3-methylphenyl)-4,4′-biphenylene-diphosphonite, terakis-(2,5-di-t-butyl-4-methylphenyl)-4,4′-biphenylene-diphosphonite, terakis-(2,5-di-t-butyl-6-methylphenyl)-4,4′-biphenylene-diphosphonite, terakis-(2,6-di-t-butyl-3-methylphenyl)-4,4′-biphenylene-diphosphonite, terakis-(2,6-di-t-butyl-5-methylphenyl)-4,4′-biphenylene-diphosphonite, terakis-(2,3-dibutyl-4-ethylphenyl)-4,4′-biphenylene-diphosphonite, terakis-(2,4-dibutyl-3-ethylphenyl)-4,4′-biphenylene-diphosphonite, terakis-(2,5-dibutyl-4-ethylphenyl)-4,4′-biphenylene-diphosphonite, terakis-(2,4-di-t-butyl-3-ethylphenyl)-4,4′-biphenylene-diphosphonite, terakis-(2,4-di-t-butyl-5-ethylphenyl)-4,4′-biphenylene-diphosphonite, terakis-(2,4-di-t-butyl-G-ethylphenyl)-4,4′-biphenylene-diphosphonite, terakis-(2,5-di-t-butyl-3-ethylphenyl)-4,4′-biphenylene-diphosphonite, terakis-(2,5-di-t-butyl-4-ethylphenyl)-4,4-r-biphenylene-diphosphonite, terakis-(2,5-di-t-butyl-6-ethylphenyl)-4,4′-biphenylene-diphosphonite, terakis-(2,6-di-t-butyl-3-ethylphenyl)-4,4′-biphenylene-diphosphonite, terakis-(2,6-di-t-butyl-4-ethylphenyl)-4,4′-biphenylene-diphosphonite, terakis-(2,6-di-t-butyl-5-ethylphenyl)-4,4′-biphenylene-diphosphonite, terakis-(2,3,4-tributylphenyl)-4,4′-biphenylene-diphosphonite and terakis-(2,4,5-tri-t-butylphenyl)-4,4′-biphenylene-diphosphonite.

In the invention, phosphonite compounds represented by Formula (5) are preferable. Among them, 4,4′-biphenylene-diphosphonite compounds such as tetrakis-(2,4-di-t-butyophenyl)-4,4′-biphenylene-diphosphonite are preferred and tetrakis-(2,4-di-t-butyl-5-methylphenyl)-4,4′-biphenylene-diphosphonite is particularly preferred.

Particularly preferable phosphonite compounds are listed below.

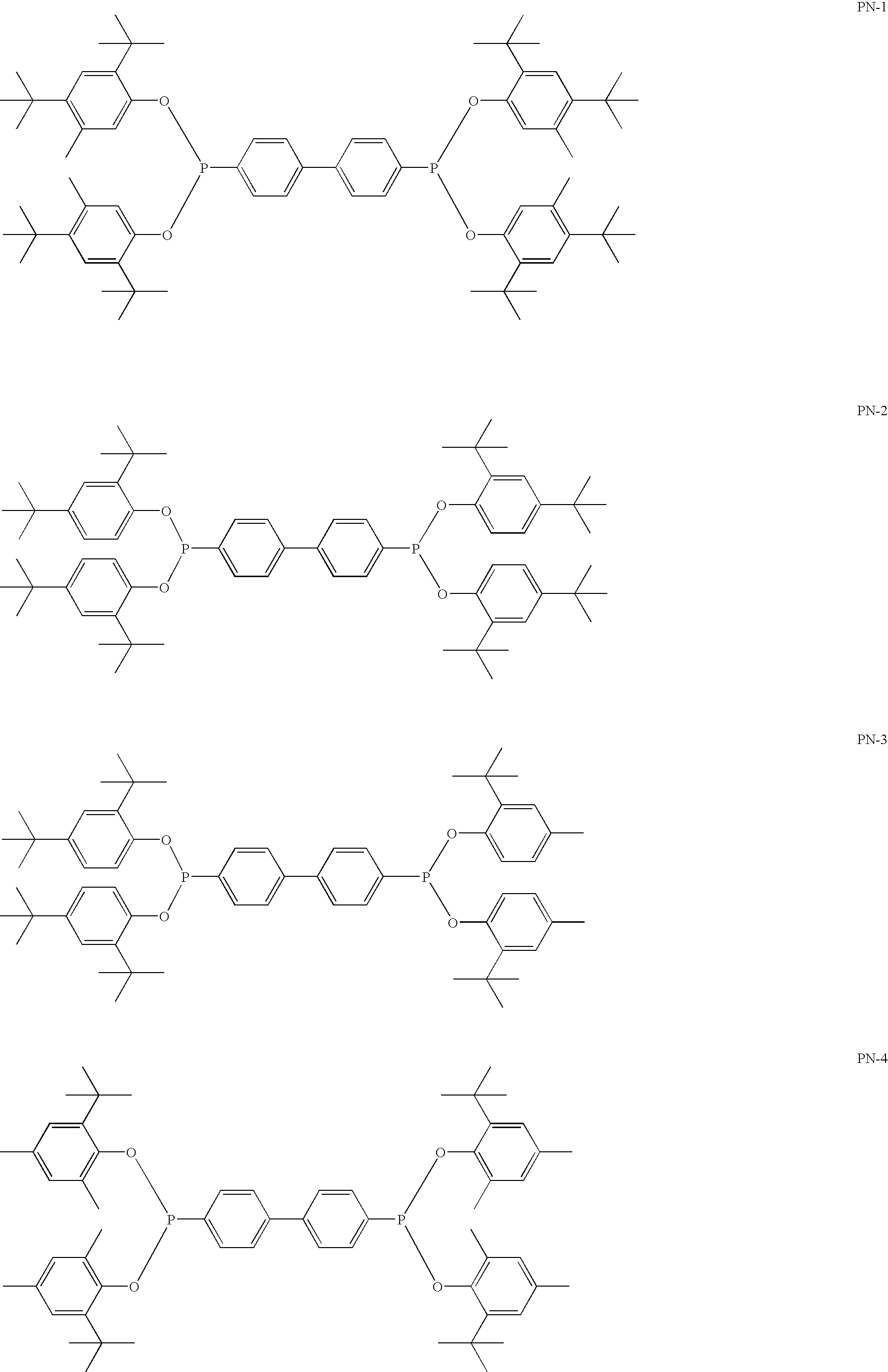

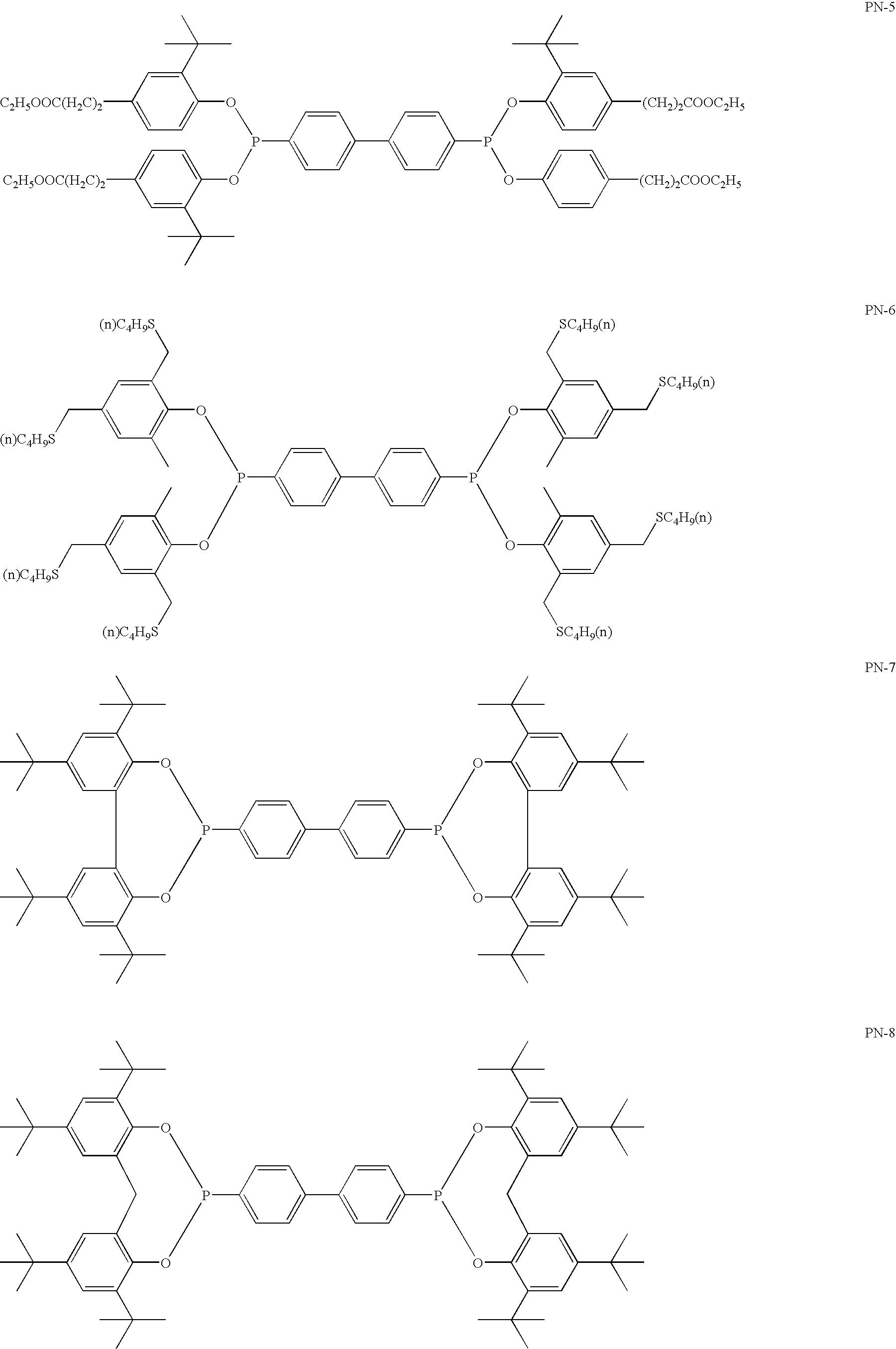

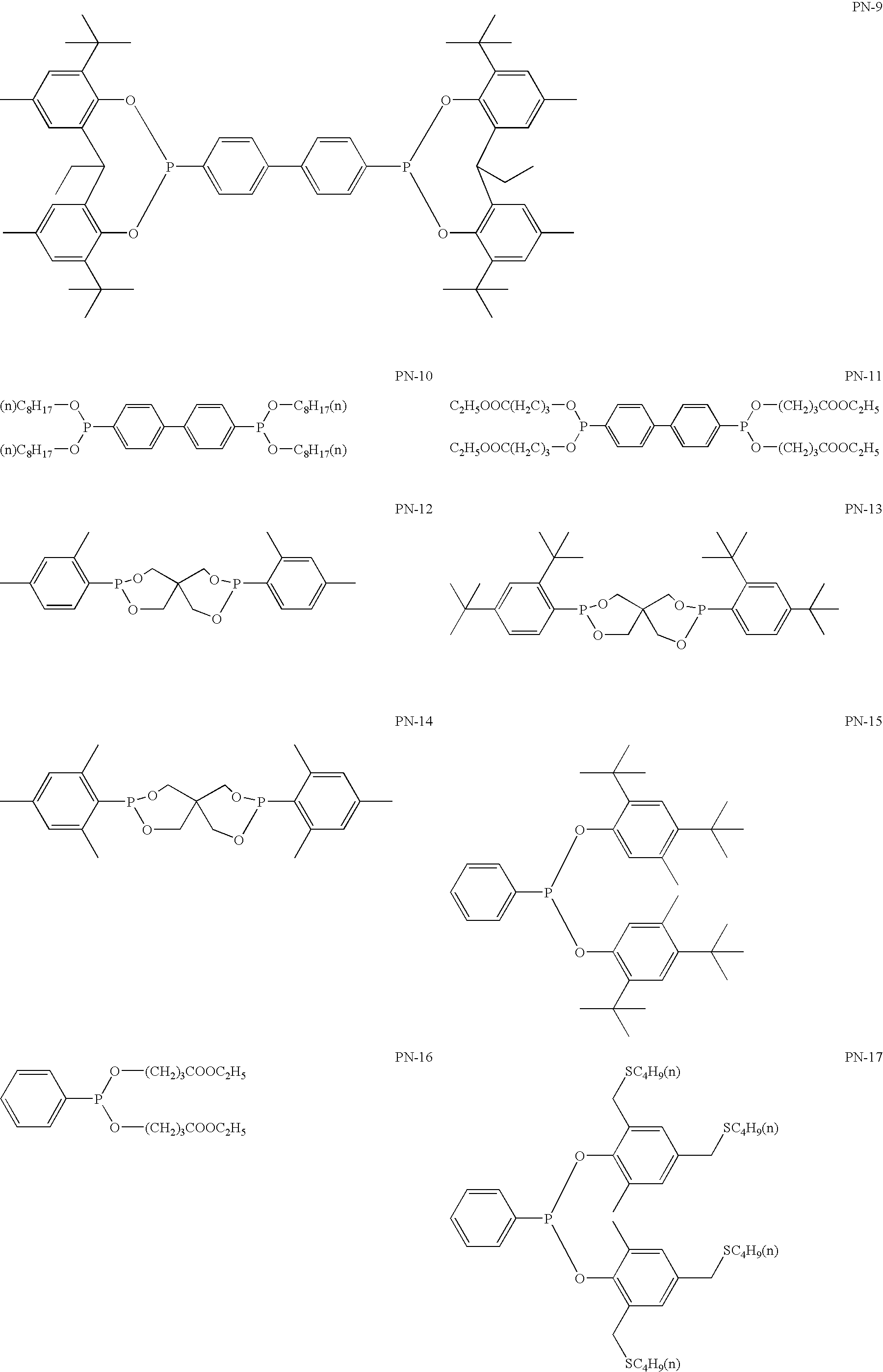

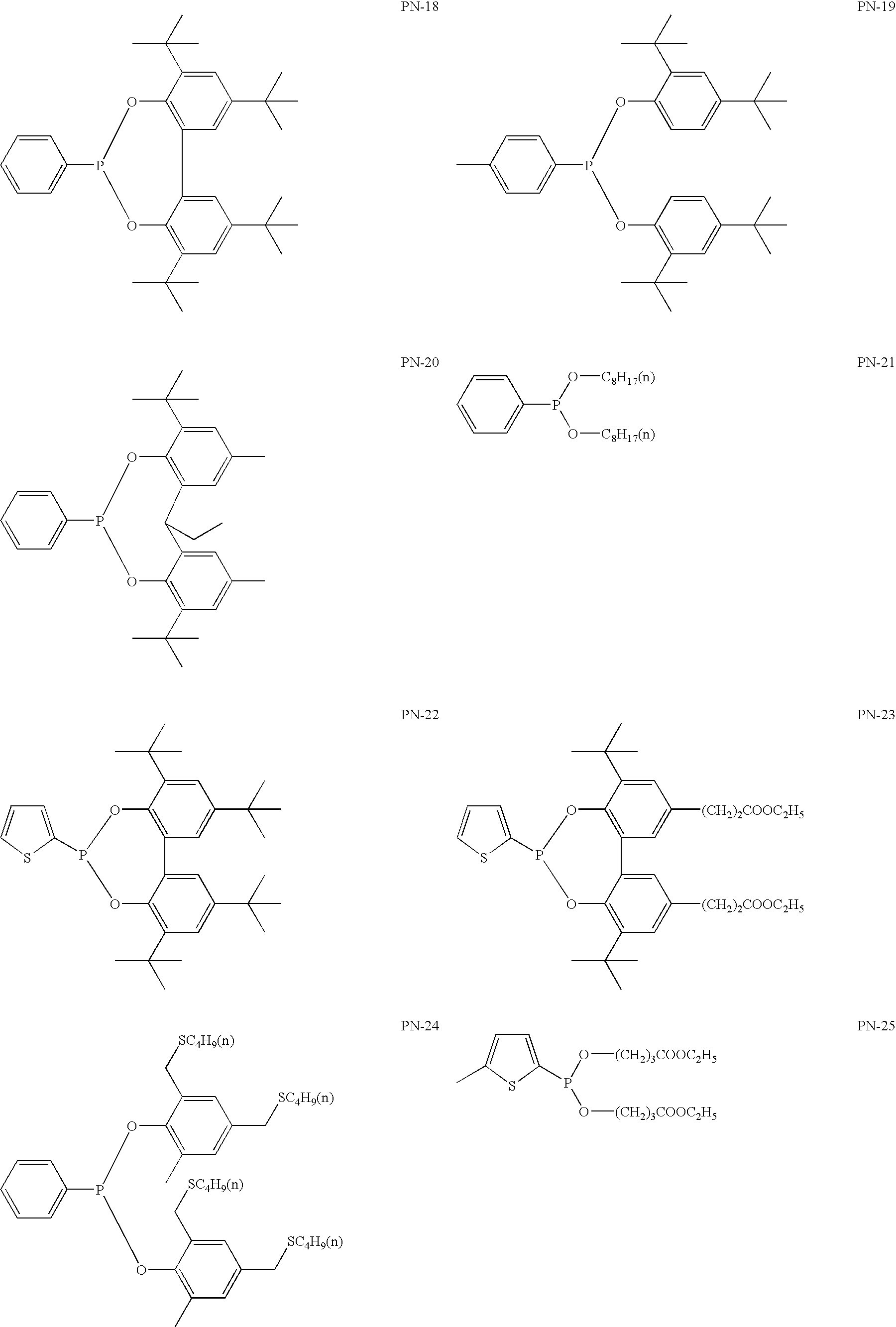

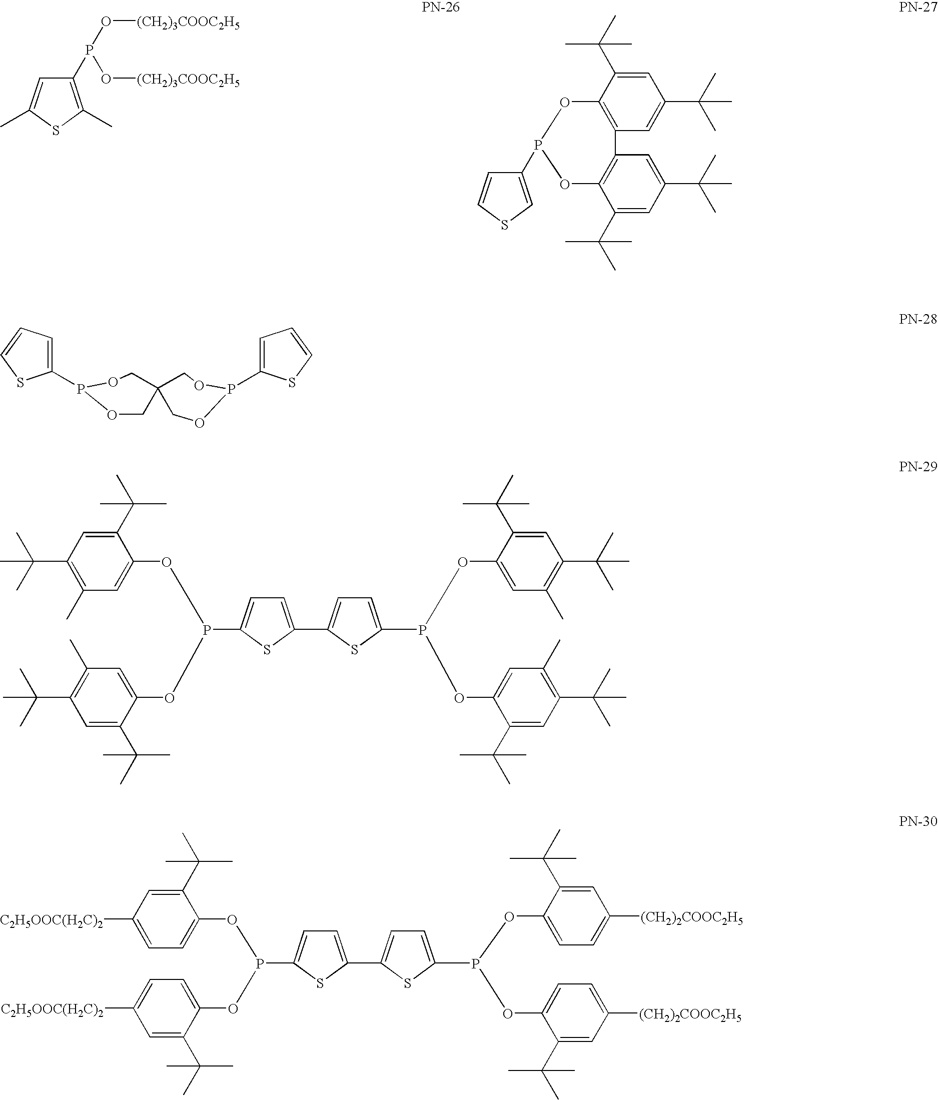

The content of the phosphor type compound is usually from 0.001 to 10.0 parts, preferably from 0.01 to 5.0 parts, and further preferably from 0.1 to 1.0 parts, by weight to 100 parts by weight of the cellulose ester.

The carbon radical trapping agent, phenol type compound and phosphor type compounds are preferably used in combination, and the more preferable adding amount of the carbon radical trapping agent is from 0.1 to 1.0 parts by weight, that of the phenol type compound is from 0.2 to 2.0 parts by weight and that of the phosphor type compound is from 0.1 to 1.0 parts by weight to 100 parts by weight of the cellulose ester. It is found that a synergistic effect can be obtained and the properties of the optical film are improved when the adding amounts of the three types of the compounds are each within the above range.

(Cellulose Ester)

The cellulose ester relating to the invention is a single-acid or multi-acid cellulose ester containing a structure selected from aliphatic acyl groups and substituted or unsubstituted aromatic acyl groups.

When the aromatic ring in the aromatic acyl group is a benzene ring, examples of the substituent of the benzene ring include a halogen atom, a cyano group, an alkyl group, an alkoxy group, an aryl group, an aryloxy group, an acyl group, a carbonamido group, a sulfonamido group, a ureido group, an aralkyl group, a nitro group, an alkyloxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an aryloxysulfonyl group, an alkyloxysulfonyl group, an aryloxysulfonyl group, —S—R, —NH—CO—OR, —PH—R, —P(—R)₂, —PH—O—R, —P(—R) (—O—R), —PH(—OR)₂, —PH(═O)—R—P(═O)(—R)₂, —PH(═O)—O—R, —P(═O)(—R)(—O—R), —P(═O)(═O)₂, —O—PH(═O)—R, —O—P(═O) (—R)₂—O—PH(═O)—O—R, —O—P(═O)(—R)(—O—R), —O—P(═O) (—O—R)₂, —NH—PH(═O)—R, —NH—P(═O) (—R) (—O—R), —NH—P(═O) (—O—R))₂, —SiH₂—R, —SiH(—R)₂, —Si(—R)₃, —O—SiH₂—R, —O—SiH(—R)₂ and —O—Si(—R)₂. In the above, R is an aliphatic group, an aromatic group or a heterocyclic group. The number of the substituent is preferably from 1 to 5, more preferably from 1 to 4, further preferably from 1 to 3, and most preferably 1 or 2. As the substituent, the halogen atom, cyano group, alkyl group, alkoxy group, aryl group, aryloxy group, acyl group, carbonamido group, sulfonamido group and ureido group are more preferable, and the halogen atom, cyano group, alkyl group, alkoxy group and aryloxy group are further preferable and the halogen atom, alkyl group and alkoxy group, are most preferable.

The halogen atom includes a fluorine atom, a chlorine atom, bromine atom and iodine atom.

The alkyl group may have a straight- or a branched-structure. The number of carbon atoms of the alkyl group is preferably 1 to 20, more preferably from 1 to 12, further preferably from 1 to 6 and most preferably from 1 to 4. Examples of the alkyl group include a methyl group, an ethyl group, a propyl group, a butyl group, a t-butyl group, a hexyl group, a cyclohexyl group, an octyl group and a 2-ethylhexyl group. The alkoxy group may have a cyclic or a branched structure. The number of carbon atoms of the alkoxyl group is preferably from 1 to 20, more preferably from 1 to 12, further preferably from 1 to 6 and most preferably from 1 to 4. The alkoxy group may be substituted with another alkoxy group. Examples of the alkoxy group include a methoxy group, an ethoxy group, a 2-methoxyethoxy group, a 2-methoxy-ethoxyethoxy group, a butyloxy group, a hexyloxy group and an octyloxy group.

The number of carbon atoms of the aryl group is preferably from 6 to 20, more preferably from 6 to 12. Examples of the aryl group include a phenyl group and a naphthyl group. The number of carbon atoms of the aryloxy group is preferably from 6 to 20, more preferably from 6 to 12. Examples of the aryloxy group include a phenoxy group and a naphthyloxy group. The number of carbon atoms of the acyl group is preferably from 1 to 20, more preferably from 1 to 12. Examples of the acyl group include a formyl group, an acetyl group and a benzoyl group. The number of carbon atoms of the carbonamido group is preferably from 1 to 20, more preferably from 1 to 12. Examples of the carbonamido group include an acetamido group and a benzamido group. The number of carbon atoms of the sulfonamido group is preferably from 1 to 20, more preferably from 1 to 12. Examples of the sulfamido group include a methanesulfonamido group, benzenesulfonamido and a p-toluenesulfonamido group. The number of carbon atoms of the ureido group is preferably from 1 to 20, more preferably from 1 to 12. Examples of the ureido group include a (unsubstituted) ureido group.

The number of carbon atoms of the aralkyl group is preferably from 7 to 20, more preferably from 7 to 12. Examples of the aralkyl group include a benzyl group, a phenetyl and a naphthylmethyl group. The number of carbon atoms of the alkoxycarbonyl group is preferably from 1 to 20, more preferably from 2 to 12. Examples of the alkoxycarbonyl group include a methoxycarbonyl. The number of carbon atoms of the aryloxycarbonyl group is preferably from 7 to 20, more preferably from 7 to 12. Examples of the aryloxycarbonyl group include a phenoxycarbonyl group The number of carbon atoms of the aralkyloxycarbonyl group is preferably from 8 to 20, more preferably from 8 to 12. Examples of the aralkyloxycarbonyl group include a benzyloxycarbonyl group. The number of carbon atoms of the carbamoyl group is preferably from 1 to 20, more preferably from 1 to 12. Examples of the carbamoyl group include a (unsubstituted) carbamoyl group and an N-methylcarbamoyl group. The number of carbon atoms of the sulfamoyl group is preferably not more than 20, more preferably not more than 12. Examples of the sulfamoyl group include a (unsubstituted) sulfamoyl group and an N-methylsulfamoyl group. The number of carbon atoms of the acyloxy group is preferably from 1 to 20, more preferably from 2 to 12. Examples of the acyloxy group include an acetoxy group and a benzoyloxy group.

The number of carbon atoms of the alkenyl group is preferably from 2 to 20, more preferably from 2 to 12. Examples of the alkenyl group include a vinyl group, an allyl group and an isopropenyl group. The number of carbon atoms of the alkynyl group is preferably from 2 to 20, more preferably from 2 to 12. Examples of the alkynyl group include a thienyl group. The number of carbon atoms of the alkylsulfonyl group is preferably from 1 to 20, more preferably from 1 to 12. The number of carbon atoms of the arylsulfonyl group is preferably from 6 to 20, more preferably from 6 to 12. The number of carbon atoms of the alkyloxysulfonyl group is preferably from 1 to 20, more preferably from 1 to 12. The number of carbon atoms of the aryloxysulfonyl group is preferably from 6 to 20, more preferably from 6 to 12. The number of carbon atoms of the alkylsulfonyloxy group is preferably from 1 to 20, more preferably from 1 to 12. The number of carbon atoms of the aryloxysulfonyl group is preferably from 6 to 20, more preferably from 6 to 12.

In the cellulose ester relating to the invention, when the hydrogen atom of the hydroxyl moiety of the cellulose is fatty acid ester formed with an aliphatic acyl group, the aliphatic acyl group is one having 2 to 20 carbon atoms such as an acetyl group, a propionyl group, a butylyl group, an isobutylyl group, a valeryl group, a pivaloyl group, a hexanoyl group, an octanoyl group, a lauroyl group and a stearoly group.

In the invention, the aliphatic acyl group includes ones having a substituent. As the substituent, those cited as the substituent of the benzene ring when the aromatic ring in the foregoing aromatic acyl group is a benzene ring.

When the esterified substituent of the cellulose ester is an aromatic ring, the number of the substituent X substituting to the aromatic ring is 0 or 1 to 5, preferably from 1 to 3 and particularly preferably 1 or 2. When the number of the substituent substituting to the aromatic ring is two or more, they may be the same as or different from each other and may be bonded with together to form a condensed polycyclic compound such as naphthalene, indene, indan, phenanthrene, quinoline, isoquinoline, chromene, chromane, phthalazine, acridine, indole and indoline.

In the cellulose ester relating to the invention, at least one structure selected from substituted and unsubstituted aliphatic acyl groups and substituted or unsubstituted aromatic groups is used. The cellulose ester may be a single or mixed acid ester or a mixture of two or more kinds of cellulose ester.

As the cellulose ester relating to the invention, at least one selected from cellulose acetate, cellulose propionate, cellulose butylate, cellulose pentanate, cellulose acetate propionate, cellulose acetate butylate, cellulose acetate pentanate, cellulose acetate phthalate and cellulose phthalate is preferable.

The glucose unit constituting cellulose by β-1,4-glycoside has free hydroxyl groups at 2-, 3- and 6-position thereof. The cellulose ester in the invention is a polymer in which a part or whole of these hydroxyl groups are esterified by the acyl groups. The substitution degree is the total of esterified ratios of each of the 2-, 3- and 6-position of the repeating unit. In concrete, the substitution degrees each becomes 1 when each of the hydroxyl groups at the 2-, 3- and 6-positions are esterified by 100%, respectively. Consequently, the substitution degree becomes the maximum value of 3 when the 2-, 3- and 6-positions are entirely esterified by 100%. The substitution degree of the acyl group can be determined by the method provided by ASTM-D817.

The preferable mixed fatty acid ester is one having the acyl groups having 2 to 5 carbon atoms and simultaneously satisfying the following expressions 1 to 3 when the substitution degree of the acetyl group is A, the total substitution degree of the acyl group is B.

2.4≦A+B≦3.0 Expression 1

0≦A≦2.4 Expression 2

0.1≦B<3.0 Expression 3

Among the above, cellulose acetate propionate is preferably used and one satisfying 1.00≦A≦2.20 and 0.50≦B≦2.00 is preferable, and one satisfying 1.20≦A≦2.00 and 0.70≦B≦1.70 is more preferable. The portion not substituted by the acyl group is usually occupied by a hydrogen atom. Such the cellulose ester can be synthesized by known method.

The cellulose ester having a ratio (Mw/Mn) of weight average molecular weight Mw to number average molecular weight Mn of from 1.5 to 5.5, particularly from 2.0 to 4.0, is preferably used in the invention.

The cellulose ester concerning the present invention has preferably a number average molecular weight (Mn) of 50,000 to 150,000, more preferably a number average molecular weight of 55,000 to 120,000, and still more preferably a number average molecular weight of 60,000 to 100,000.

Here, the number average molecular weight (Mn) and the ratio of Mw/Mn was calculated by a gel permeation chromatography with the following procedures.

The measuring conditions are as follows:

Solvent: tetrahydrofuran

Device: HKC-8220 (manufactured by Toso KK)

Column: TSK gel Super HM-M (manufactured by Toso KK)

Column temperature: 40° C.

Sample temperature: 0.1° by weight

Feed amount: 10 μl

Flow: 0.6 ml/min

Calibration curve: prepared by 9 samples of standard polystyrene: PS-1 (manufactured by Polymer Laboratories KK), Mw=2,560,000 to 580

Although a wood pulp or a cotton linter is suitable as a raw material of the cellulose ester used in the present invention, and the wood pulp may be a needle-leaf tree or a broadleaf tree, the needle-leaf tree is more desirable. From a point of the peel property in the case of film production, the cotton linter is usable preferably. The cellulose ester made from these may be mixes appropriately or may be used independently.

For example, a cotton linter-originated cellulose resin a wood-pulp (needle-leaf tree)-originated cellulose resin a wood pulp (broadleaf tree)-originate cellulose resin may be used with a ratio of 100:0:0, 90:10:0, 85:15:0, 50:50:0, 20:80:0, 10:90:0, 0:100:0, 0:0:100, 80:10:10, 85:0:15 and 40:30:30.

The cellulose ester can be obtained by substituting hydroxyl groups in a raw material of cellulose with an acetyl group, a propionyl group and/or a butyl group within the above range with an ordinary method by using an acetic anhydride, a propionic anhydride, and/or a butyric anhydride, for example. A synthetic method of these cellulose esters is not limited to a specific one. For example, these cellulose esters may be synthesized by referring a method disclosed by JP-A HEI 10-45804 or Japanese Translation of PCT International Application Publication No. 6-501040.

The cellulose ester used in the present invention preferably contains an alkaline earth metal in an amount of 1 to 50 ppm. If the content exceeds 50 ppm, a lip adhesion soil increases or a slitting part is apt to fracture during hot stretching or after hot stretching. If the content is less than 1 ppm, a breakage trouble may take place easily, however, the reasons for it is not known well. Further, in order to make it less than 1 ppm, since the burden of a washing process becomes too large, it is not desirable at this point. More preferably, the content is in a range of 1 to 30 ppm. Here, the alkaline earth metals means the total content of Ca and Mg, and it can be measured by the use of X ray photoelectron spectral-analysis equipment (XPS).

The amount of the residual sulfuric acid contained in the cellulose ester used in the present invention is 0.1 through 45 ppm in terms of the sulfur element. They are considered to be included as salts. When the amount of the residual sulfuric acid contained therein exceeds 45 ppm, the deposition on the die lip at the time of heat-melting will increase, and therefore, such an amount is not preferred. Further, at the time of thermal stretching or slitting subsequent to thermal stretching, the material will be easily damaged, and therefore, such an amount is not preferred. The amount of the residual sulfuric acid contained therein should be reduced as much as possible, but when it is to be reduced below 0.1, the load on the cellulose ester washing process will be excessive and the material tends to be damaged easily. This should be avoided. This may be because an increase in the frequency of washing affects the resin, but the details are not yet clarified. Further, the preferred amount is in the range of 1 through 30 ppm. The amount of the residual sulfuric acid can be measured according to the ASTM-D817-96 in the similar manner.

The free acid content in the cellulose ester used in the present invention is desirably in a range of 1 to 500 ppm. If the content exceeds 500 ppm, adhesion matters on a die-lips part may increase, and it may become easy to fracture. It may be difficult to make it less than 1 ppm by washing. The content is desirably in a range of 1 to 100 ppm, because it becomes difficult to fracture. Especially, the content is more desirably in a range of 1 to 70 ppm. The free acid content can be measured by a method specified in ASTM-D817.

The amount of the residual acid can be kept within the aforementioned range if the synthesized cellulose ester is washed more carefully than in the case of the solution casting method. Then, when a film is manufactured by the melt casting, the amount of depositions on the lip portion will be reduced so that a film characterized by a high degree of flatness is produced. Such a film will be further characterized by excellent resistance to dimensional changes, mechanical strength, transparency, resistance to moisture permeation, retardation values (to be described later). Further, the cellulose ester can be washed using water as well as a poor solvent such as methanol or ethanol. It is also possible to use a mixture between a poor solvent and a good solvent if it is a poor solvent as a result. This will remove the inorganic substance other than residual acid, and low-molecular organic impurities. The cellulose ester is washed preferably in the presence of an antioxidant such as a hindered amine and phosphorous acid ester. This will improve the heat resistance and film formation stability of the cellulose ester.

To improve the heat resistance, mechanical property and optical property of the cellulose ester, the cellulose ester is settled again in the poor solvent, subsequent to dissolution of the good solvent of the cellulose ester. This will remove the low molecular weight component and other impurities of the cellulose ester. In this case, similarly to the aforementioned case of washing the cellulose ester, washing is preferably carried out in the presence of an antioxidant.

Furthermore, another polymer or a low molecular compound may be added after a reprecipitation process of cellulose ester.

In the present invention, in addition to the cellulose ester resin, a cellulose ether resin, a vinyl resin (including a polyvinyl acetate resin and a polyvinyl alcohol resin), a cyclic olefine resin, a polyester resin (an aromatic polyester, an aliphatic polyester, and a copolymer containing them), and an acrylic resin (including a copolymer), may be contained. The content of a resin other than the cellulose ester is preferably 0.1 to 30% by weight.

The cellulose ester used in the present invention is preferred to be such that there are few brightening foreign matters when formed into a film. The bright defect can be defined as follows: Two polarizing plates are arranged perpendicular to each other (crossed-Nicols), and a cellulose ester film is inserted between them. Light of the light source is applied from one of the surfaces, and the cellulose ester film is observed from the other surface. In this case, a spot formed by the leakage of light from the light source. This spot is referred to as a bright detect. The polarizing plate employed for evaluation in this case is preferably made of the protective film free of a bright defect. A glass plate used to protect the polarizer is preferably used for this purpose the bright defect may be caused by non-acetified cellulose or cellulose with a low degree of acetification contained in the cellulose ester. It is necessary to use the cellulose ester containing few brightening foreign matters (use the cellulose ester with few distributions of substitution degree), or to filter the molten cellulose ester. Alternatively, the material in a state of solution is passed through a similar filtering step in either the later process of synthesizing the cellulose ester or in the process of obtaining the precipitate, whereby the bright defect can be removed. The molten resin has a high degree of viscosity, and therefore, the latter method can be used more efficiently.

However, minute foreign matter may not be completely removed by filtration. The present inventors have found that a melt film formation of a cellulose ester composition, in which cellulose ester is mixed with a polymer having a specific amide structure, a carbon radical trapping agent, a phenol compound and a phosphorous compound, greatly reduces the brightening foreign matters. The reason is not clear, but it is considered that cellulose ester with a low degree of acyl substitution is sufficiently melted

The smaller the film thickness, the fewer the number of brightening foreign matters per unit area and the fewer the number of the cellulose esters contained in the film. The number of the brightening foreign matters having a bright spot diameter of 0.01 mm or more is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all. The number of the brightening foreign matters having a bright spot diameter of 0.005 through 0.01 mm is preferably 200 pieces/cm² or less, more preferably 100 pieces/cm² or less, still more preferably 50 pieces/cm² or less, further more preferably 30 pieces/cm² or less, still further more preferably 10 pieces/cm² or less. The most desirable case is that there is no bright defect at all.

When the bright defect is to be removed by melt filtration, the bright defect is more effectively removed by filtering the cellulose ester composition mixed with a plasticizer, anti-deterioration agent and antioxidant, rather than filtering the cellulose ester melted independently. It goes without saying that, at the time of synthesizing the cellulose ester, the cellulose ester can be dissolved in a solvents and the bright defect can be reduced by filtering. Alternatively, the cellulose ester mixed with an appropriate amount of ultraviolet absorber and other additive can be filtered. At the time of filtering, the viscosity of the melt including the cellulose ester is preferably 10000 Pa·s or less, more preferably 5000 Pa·s or less, still more preferably 1000 Pa·s or less, further more preferably 500 Pa·s or less. A conventionally known medium including a fluoride resin such as a glass fiber, cellulose fiber, filter paper and tetrafluoroethylene resin is preferably used as a filter medium. Particularly, ceramics and metal can be used in preference. The absolute filtration accuracy is preferably 50 μm or less, more preferably 30 μm or less, still more 10 μm or less, further more preferably 5 μm or less. They can be appropriately combined for use. Either a surface type or depth type filter medium can be used. The depth type is more preferably used since it has a greater resistance to clogging.

In another embodiment, it is also possible that the cellulose ester as a material is dissolved in a solvent at least once, and is dried and used. In this case, the cellulose ester is dissolved in the solvent together with one or more of the plasticizer, ultraviolet absorber, anti-deterioration agent, antioxidant and matting agent, and is dried and used. Such a good solvent as methylene chloride, methyl acetate or dioxolane that is used in the solution casting method can be used as the solvent. At the same time, the poor solvent such as methanol, ethanol or butanol can also be used. Mix solvent of thereof can also be used. In the process of dissolution, it can be cooled down to −20° C. or less or heated up to 80° C. or more. Use of such a cellulose ester allows uniform additives to be formed in the molten state, and the uniform optical property is ensured in some cases.

(Plasticizer)

The cellulose ester optical film of the present invention preferably contains at least one ester type plasticizer obtained by condensing a polyvalent alcohol and a monovalent carboxyl acid, preferably contains 1-25 weight % of an ester compound, as a plasticizer, having a structure obtained by condensing the organic acid represented by Formula (7) and an alcohol having a valence of 3 or more. When its amount is less than 1 weight %, the effect of adding the plasticizer is not acknowledged, on the other hand, when its amount is more than 25 weight %, bleeding out tends to occur resulting in lowering the long term stability of the film, accordingly those amounts are not preferable. More preferable is a cellulose acylate film containing 3-20 weight % of the above plasticizers, and still more preferable is a cellulose acylate film containing 5-15 weight % of the plasticizers.

A plasticizer, as described herein, commonly refers to an additive which decreases brittleness and result in enhanced flexibility upon being incorporated in polymers. In the present invention, a plasticizer is added so that the melting temperature of a cellulose ester resin is lowered, and at the same temperature, the melt viscosity of the film forming materials including a plasticizer is lower than the melt viscosity of a cellulose ester resin containing no additive. Further, addition is performed to enhance hydrophilicity of cellulose ester so that the water vapor permeability of cellulose ester films is lowered. Therefore, the plasticizers of the present invention have a property of an anti-moisture-permeation agent.

The melting temperature of a film forming material, as described herein, refers to the temperature at which the above materials are heated to exhibit a state of fluidity. In order that cellulose ester results in melt fluidity, it is necessary to heat cellulose ester to a temperature which is at least higher than the glass transition temperature. At or above the glass transition temperature, the elastic modulus or viscosity decreases due to heat absorption, whereby fluidity is observed. However, at higher temperatures, cellulose ester melts and simultaneously undergoes thermal decomposition to result in a decrease in the molecular weight of the cellulose ester, whereby the dynamical characteristics of the resulting film may be adversely affected. Consequently, it is preferable to melt cellulose ester at a temperature as low as possible. Lowering the melting temperature of the film forming materials is achieved by the addition of a plasticizer having a melting point or a glass transition temperature which is equal to or lower than the glass transition temperature of the cellulose ester. The polyalcohol ester type plasticizer having a structure obtained by condensing the organic acid represented by Formula (7) and a polyalcohol is excellent in the following points: It makes a melting temperature of a cellulose ester lower and since it has less volatility in the process of melting and producing a film and after production, it has a good process adaptability. In addition, the obtained cellulose ester film is excellent in terms of optical property, dimensional stability and flatness.

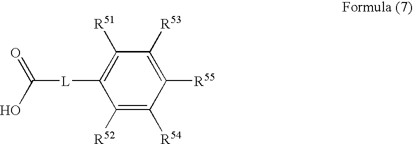

In Formula (7), R⁵¹-R⁵⁵ each independently represent a hydrogen atom, a cycloalkyl group, an aralkyl group, an alkoxy group, a cycloalkoxy group, an aryloxy group, an aralkyloxy group, an acyl group, a carbonyloxy group, an oxycarbonyl group, or an oxycarbonyloxy group, any of which may further be substituted. L represents a divalence linkage group, which includes a substituted or unsubstituted alkylene group, an oxygen atom or a direct bond.

Preferred as the cycloalkyl group represented by R⁵¹-R⁵⁵ is a cycloalkyl group having 3-8 carbon atoms, and specific examples include cycloproyl, cyclopentyl and cyclohexyl groups. These groups may be substituted. Examples of preferred substituents include: halogen atoms such as a chlorine atom, a bromine atom and a fluolinr atom, a hydroxyl group, an alkyl group, an alkoxy group, an aralkyl group (the phenyl group may further be substituted with an alkyl group or a halogen atom), an alkenyl group such as a vinyl group or an allyl group, a phenyl group (the phenyl group may further be substituted with an alkyl group, or a halogen atom), a phenoxy group (the phenyl group may further be substituted with an alkyl group or a halogen atom), an acyl group having 2-8 carbon atoms such as an acetyl group or a propionyl group, and a non-substituted carbonyloxy group having 2-8 carbon atoms such as an acetyloxy group and a propionyloxy group.

The aralkyl group represented by R⁵¹-R⁵⁵ includes a benzyl group, a phenetyl group, and a γ-phenylpropyl group, which may be substituted. Listed as the preferred substituents may be those which may substitute the above cycloalkyl group.

The alkoxy group represented by R⁵¹-R⁵⁵ includes an alkoxy group having 1-8 carbon atoms. The specific examples include a methoxy group, an ethoxy group, an n-propoxy group, an n-butoxy group, an n-octyloxy group, an isopropoxy group, an isobutoxy group, a 2-ethylhexyloxy group and a t-butoxy group. The above groups may further be substituted. Examples of preferred substituents include-halogen atoms such as a chlorine atom, a bromine atom and a fluorine atom; a hydroxyl group; an alkoxy group; a cycloalkoxy group; an aralkyl group (the phenyl group may be substituted with an alkyl group or a halogen atom); an alkenyl group; a phenyl group (the phenyl group may further be substituted with an alkyl group or a halogen atom); an aryloxy group (for example, a phenoxy group (the phenyl group may further be substituted with an alkyl group or a halogen atom)); an acyl group having 2-8 carbon atoms such as an acetyl group or a propionyl group; an acyloxy group such as a propionyloxy group; and an arylcarbonyloxy group such as a benzoyloxy group.

The cycloalkoxy groups represented by R⁵¹-R⁵⁵ include a cycloalkoxy group having 1-8 carbon atoms as an unsubstituted cycloalkoxy group. Specific examples include a cyclopropyloxy group, a cyclopentyloxy group and a cyclohexyloxy group. These groups may further be substituted. Listed as the preferred substituents may be those which may substitute the above cycloalkyl group.

The aryloxy groups represented by R⁵¹-R⁵⁵ include a phenoxy group, the phenyl group of which may further be substituted with the substituent listed as a substituent such as an alkyl group or a halogen atom which may substitute the above cycloalkyl group.

The aralkyloxy group represented by R⁵¹-R⁵⁵ includes a benzyloxy group and a phenethyloxy group, which may further be substituted. Listed as the preferred substituents may be those which may substitute the above cycloalkyl group.

The acyl group represented by R⁵¹-R⁵⁵ includes an unsubstituted acyl group having 2-8 carbon atoms such as an acetyl group and a propionyl group (an alkyl, alkenyl, or alkynyl group is included as a hydrocarbon group of the acyl group)/which may further be substituted. Listed as the preferred substituents may be those which may substitute the above cycloalkyl group.

The carbonyloxy group represented by R⁵¹-R⁵⁵ includes an unsubstituted acyloxy group (an alkyl, alkenyl, or alkynyl group is included as a hydrocarbon group of the acyl group) having 2-8 carbon atoms such as an acetyloxy group or a propionyloxy group, and an arylcarbonyloxy group such as a benzoyloxy group, which may further be substituted with the group which may substitute the above cycloalkyl group.

The oxycarbonyl group represented by R⁵¹-R⁵⁵ includes an alkoxycarbonyl group such as a methoxycarbonyl group, an ethoxycarbonyl group or a propyloxycarbonyl group, and an aryloxycarbonyl group such as a phonoxycarbonyl group, which may further be substituted. Listed as the preferred substituents may be those which may substitute the above cycloalkyl group.

The oxycarbonyloxy group represented by R⁵¹-R⁵⁵ includes an alkoxycarbonyloxy group having 1-8 carbon atoms such as a methoxycarbonyloxy group, which may further be substituted. Listed as the preferred substituents may be those which may substitute the above cycloalkyl group.

Further, any of R⁵¹-R⁵⁵ may be combined with each other to form a ring structure.

Further, the linkage group represented by L includes a substituted or unsubstituted alkylene group, an oxygen atom, or a direct bond. The alkylene group includes a methylene group, an ethylene group, and a propylene group, which may further be substituted with the substituent which is listed as the substituent which may substitute the groups represented by above R⁵¹-R⁵⁵.

Of these, one which is particularly preferred as the linking group L is the direct bond which forms an aromatic carboxylic acid.

In the present invention, the organic acids which substitute the hydroxyl groups of a polyalcohol having a valence of 3 or more may either be of a single kind or of a plurality of kinds.

In the present invention, the polyalcohol which reacts with the organic acid represented by above Formula (7) to form a polyalcohol ester is preferably an aliphatic polyalcohol having a valence of 3-20. In the present invention, preferred as a polyalcohol having a valence of 3 or more is represented by following Formula (8).

R′—(OH)m Formula (8)

In Formula (8), R′ represents an m-valence organic group, m is a positive integer of 3 or more and OH group represents an alcoholic hydroxyl group. Especially, a polyvalent alcohol of 3 or 4 valences as m is preferable.

Preferable examples of the polyvalent alcohol include adonitol, arabitol, 1,2,4-butane trial, 1,2,3-hexane triol, 1,2,6-hexane triol, glycerol, diglycerol, erythritol, pentaerythritol, dipenta erythritol, tri pentaerythritol, galactitol, inositol, mannitol, 3-methylpentane-1,3,5-triol, pinacol, sorbitol, trimethylolpropane, methyltrimethylolmethane, xylitol, etc. However, the present invention is not limited to these examples. In particular, glycerol, methyltrimethylolmethane, trimethylolpropane, and pentaerythritol may more desirable.

An ester of an organic acid represented by Formula (7) and a polyalcohol having a valence of 3-20 can be synthesized employing methods known in the art. Typical synthesis examples are shown in the examples. Examples of the synthetic method include: a method in which an organic acid represented by Formula (7) and a polyalcohol undergo etherification via condensation in the presence of, for example, an acid; a method in which an organic acid is converted to an acid chloride or an acid anhydride which is allowed to react with a polyalcohol; and a method in which a phenyl ester of an organic acid is allowed to react with a polyalcohol. Depending on the targeted ester compound, it is preferable to select an appropriate method which results in a high yield.

As an example of a plasticizer containing an ester of an organic acid represented by Formula (7) and a polyalcohol, the compound represented by Formula (9) is preferable.

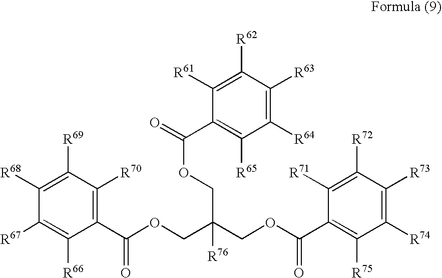

In Formula (9), R⁶¹ to R⁶⁵ each independently represent a hydrogen atom, a cycloalkyl group, an aralkyl group, an alkoxy group, a cycloalkoxy group, an aryloxy group, an aralkyloxy group, an acyl group, a carbonyloxyl group, an oxycarbonyl group or an oxycarbonyloxy group, provided that R⁶¹ to R⁶⁵ may further have a substituent. R⁶⁶ represents an alkyl group

As examples of the above described cycloalkyl group, aralkyl group, alkoxy group, cycloalkoxy group, aryloxy group, aralkyloxy group, acyl group, carbonyloxyl group, oxycarbonyl group and oxycarbonyloxy group represented by R⁶¹ to R⁶⁵, the same groups as described for R⁵¹ to R⁵⁵ can be cited.

The molecular weight of the polyalcohol esters prepared as above is not particularly limited, but is preferably 300-1,500, more preferably 400-1,000. A greater molecular weight is preferred due to reduced volatility, while a smaller molecular weight is preferred in view of reducing water vapor permeability and improving the compatibility with cellulose ester.

Specific compounds of polyalcohol esters according to the present invention will be exemplified below.

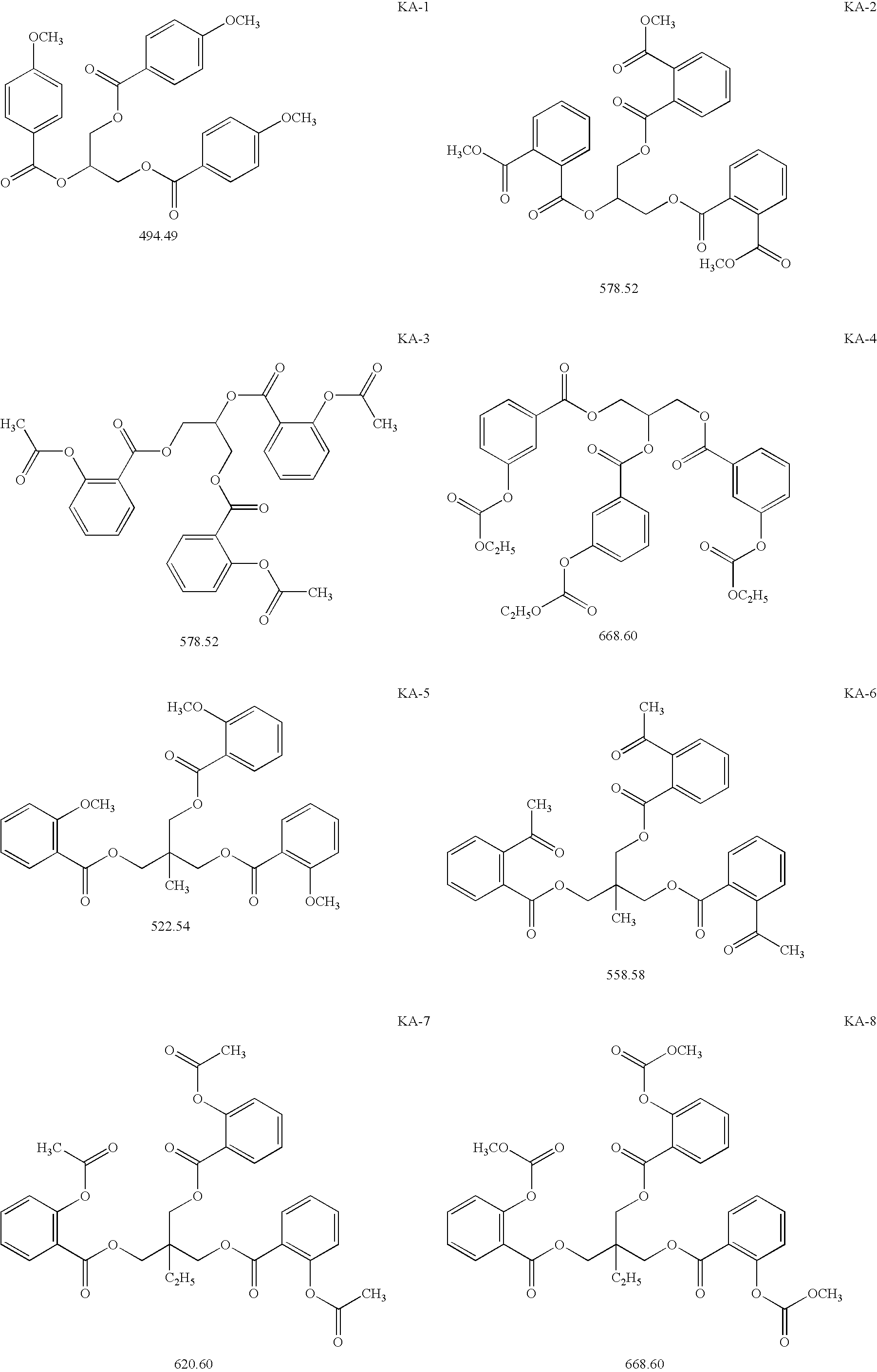

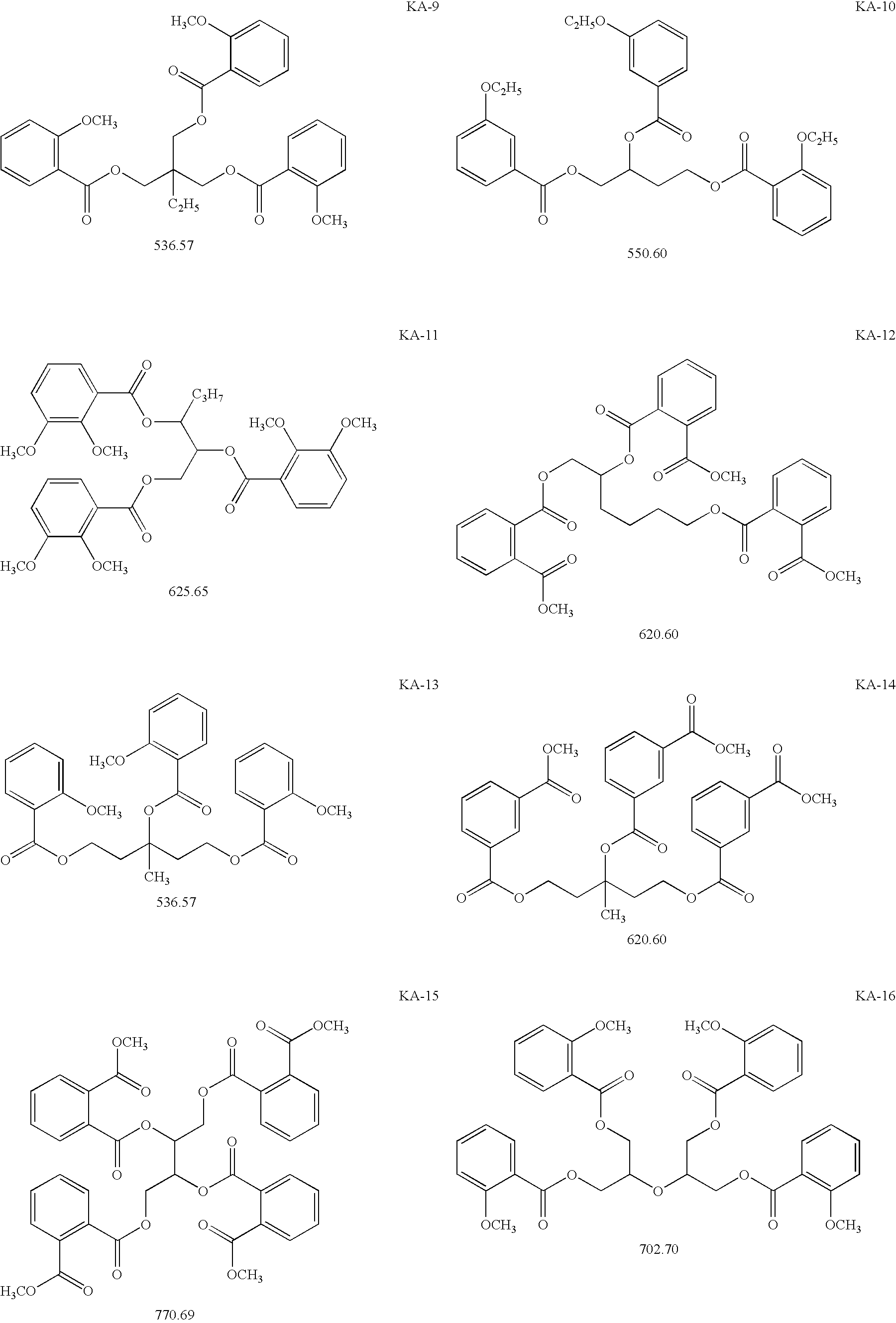

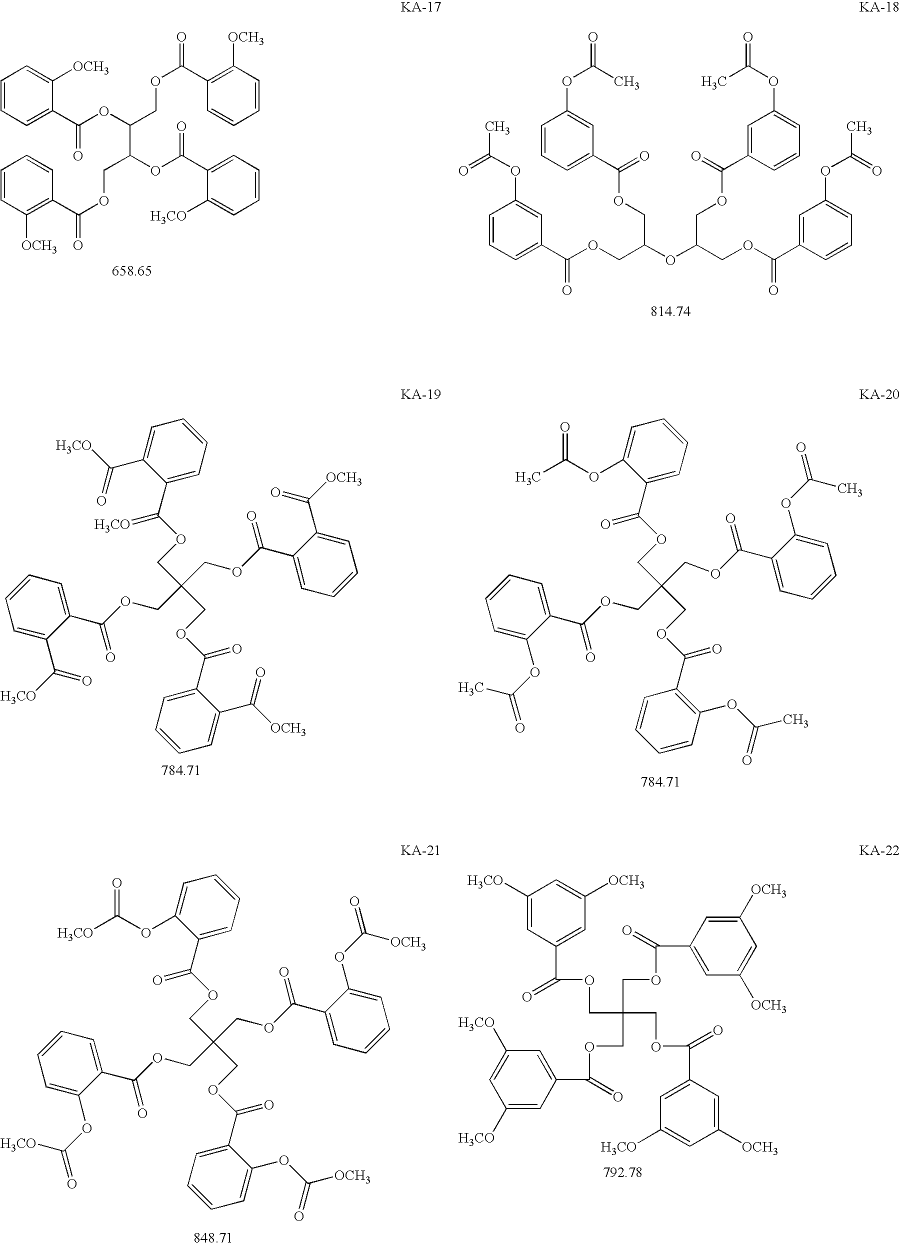

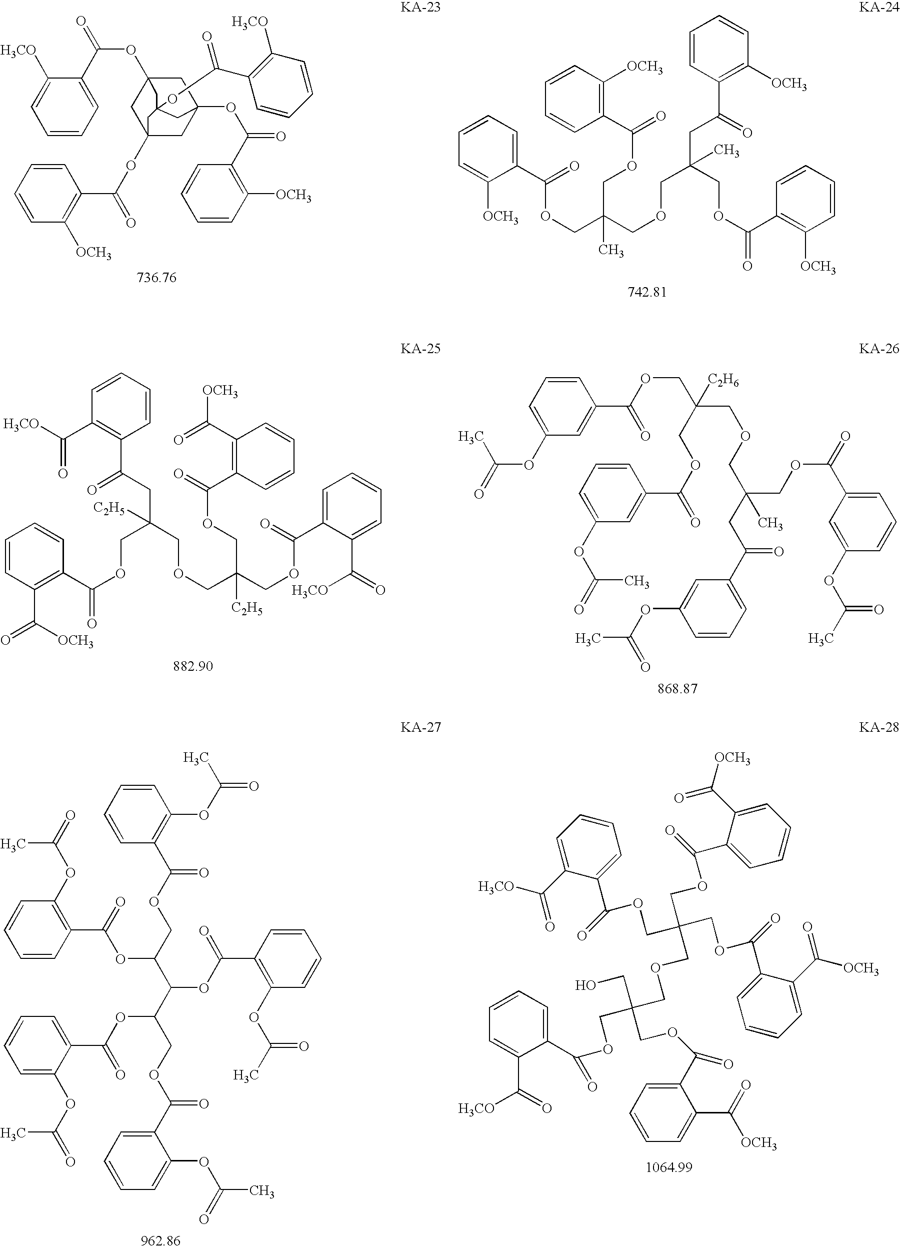

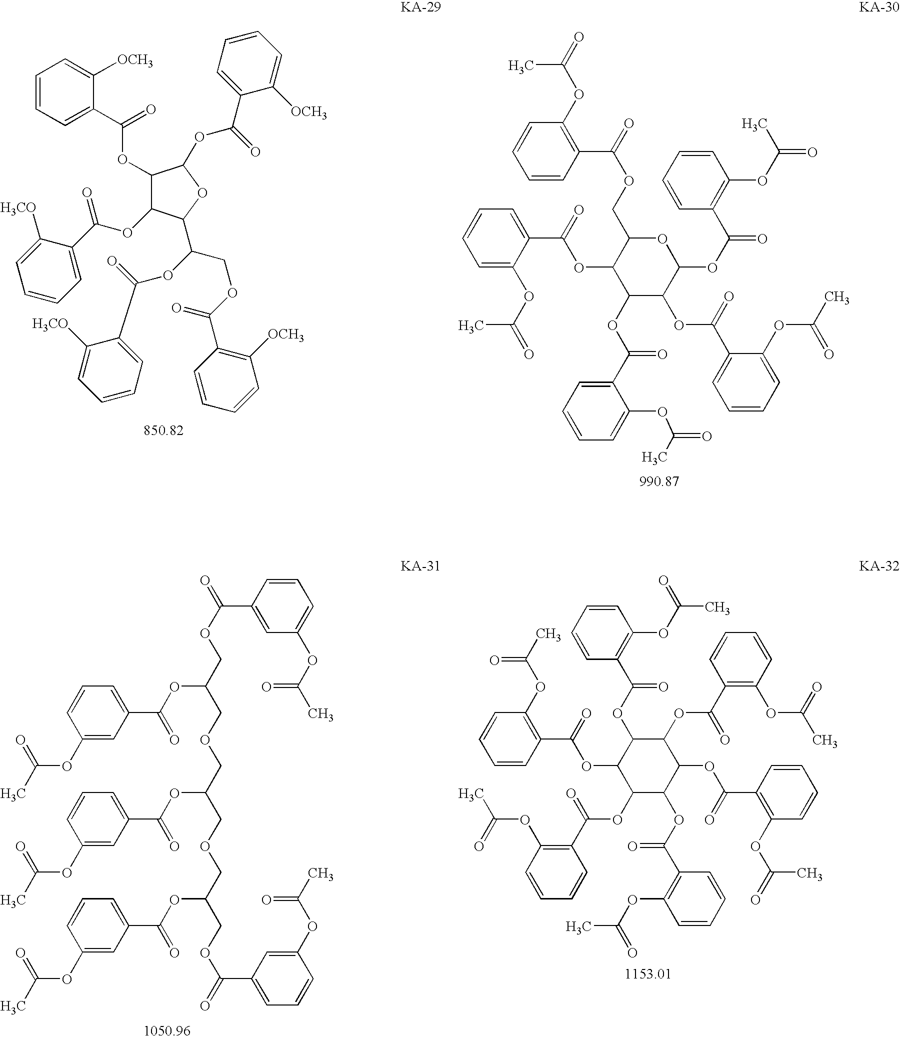

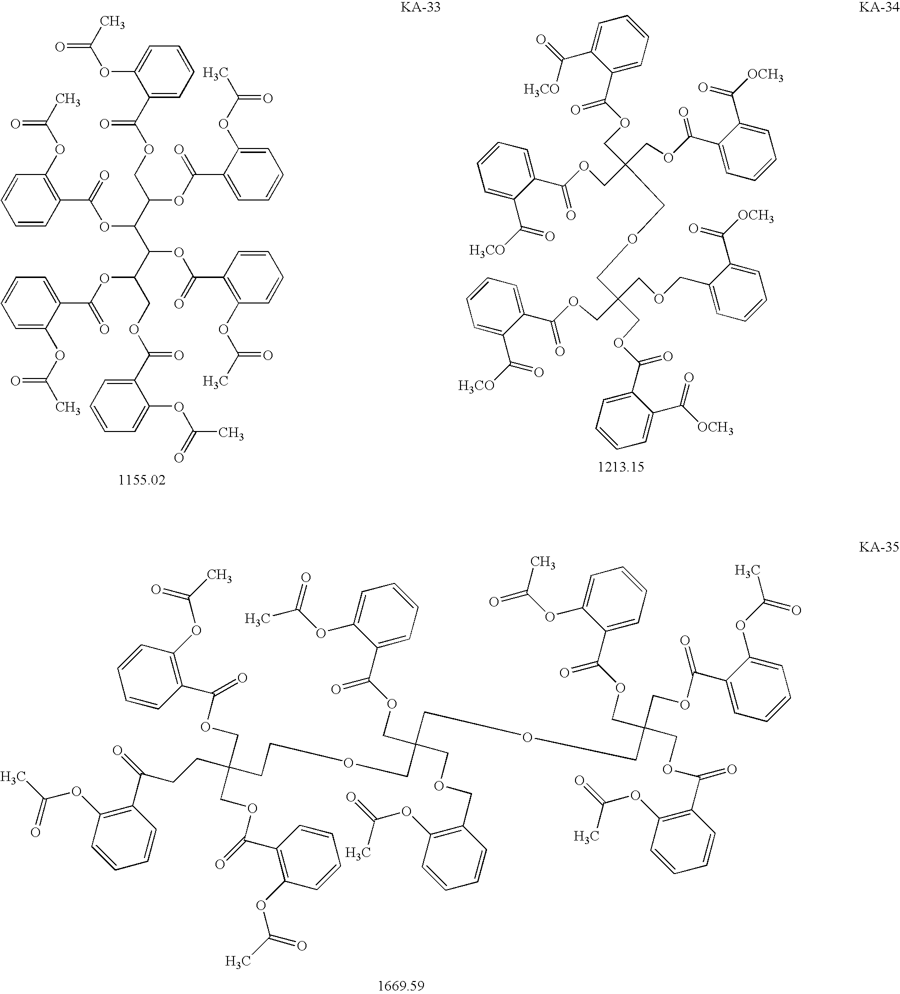

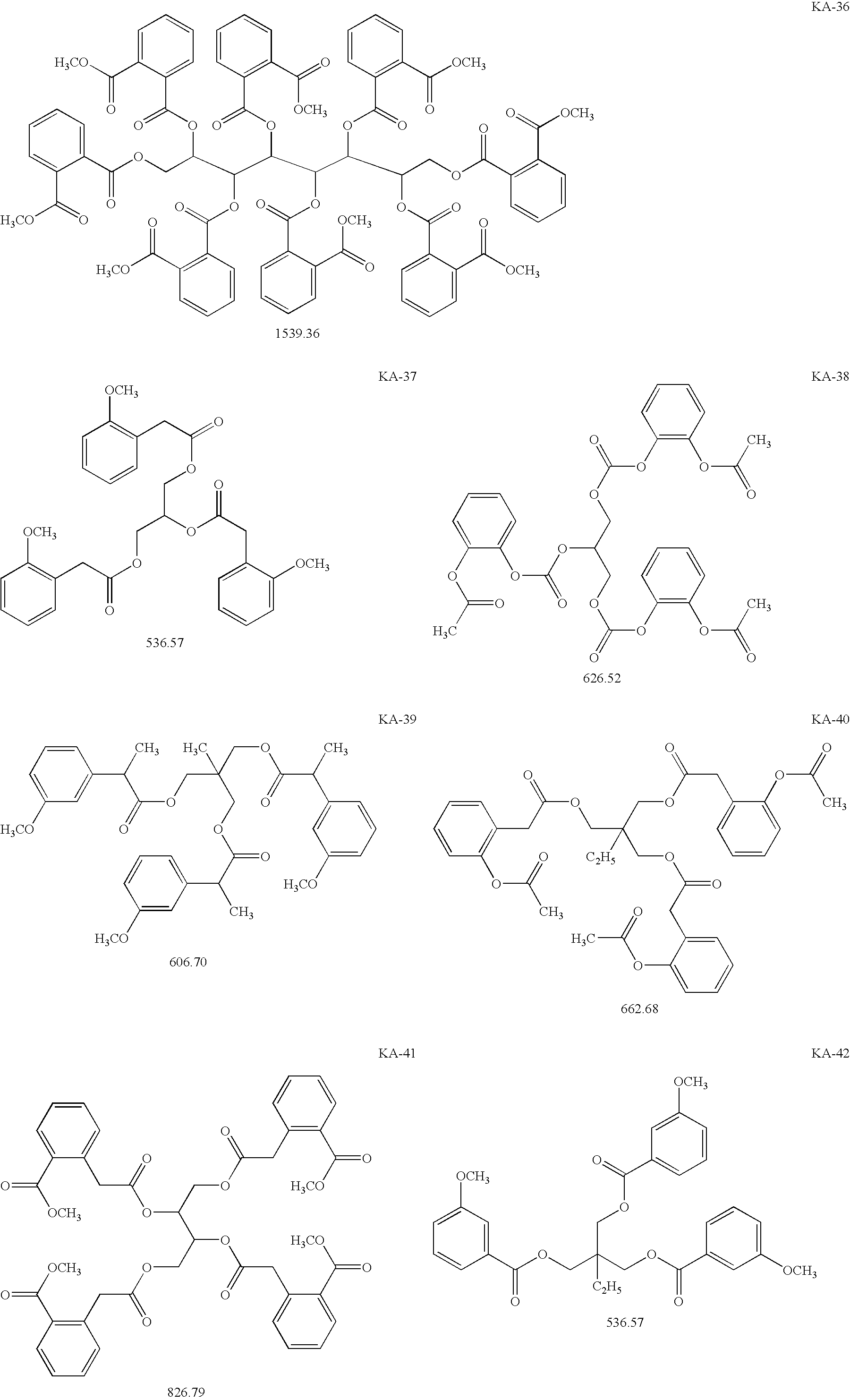

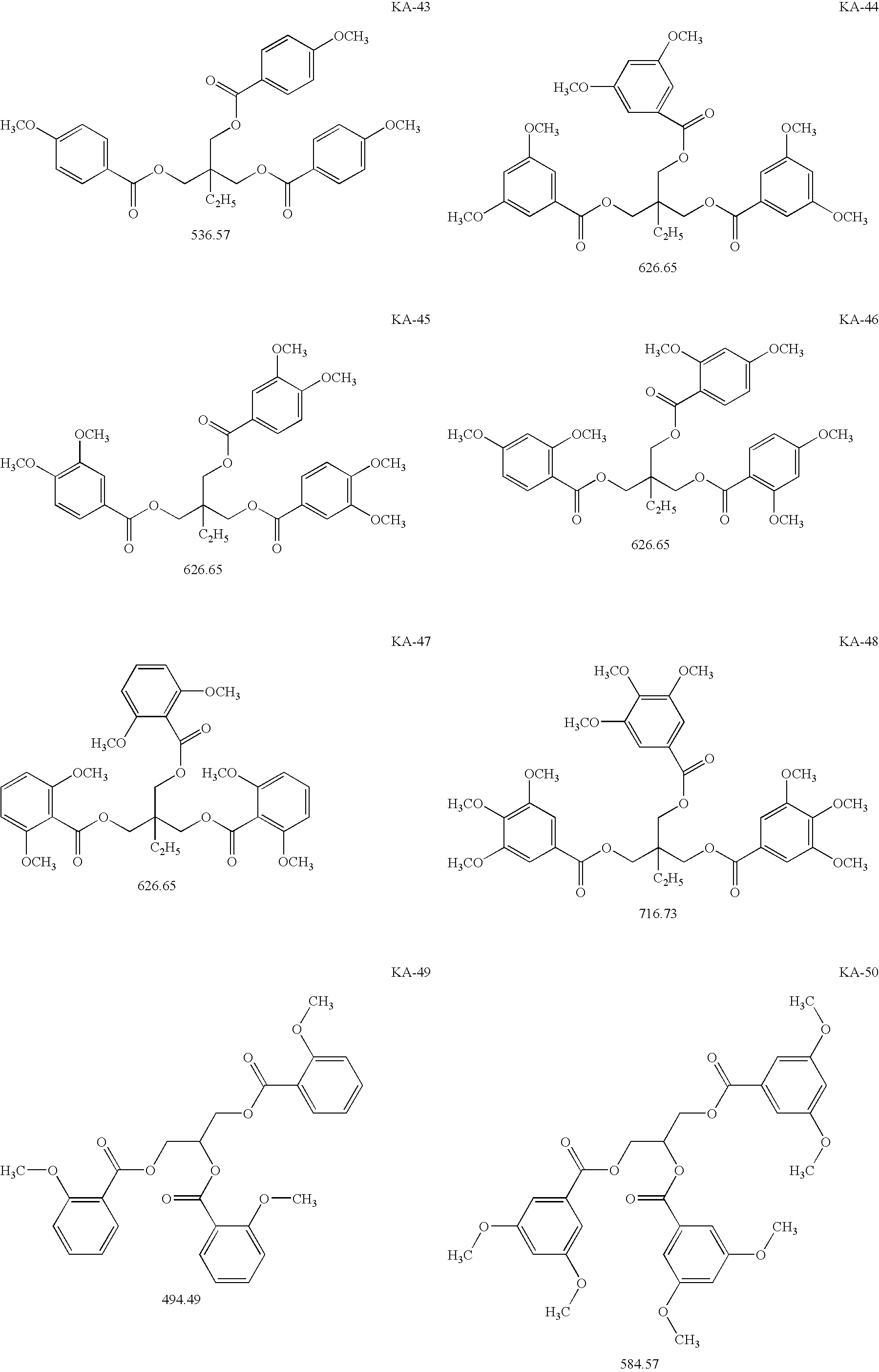

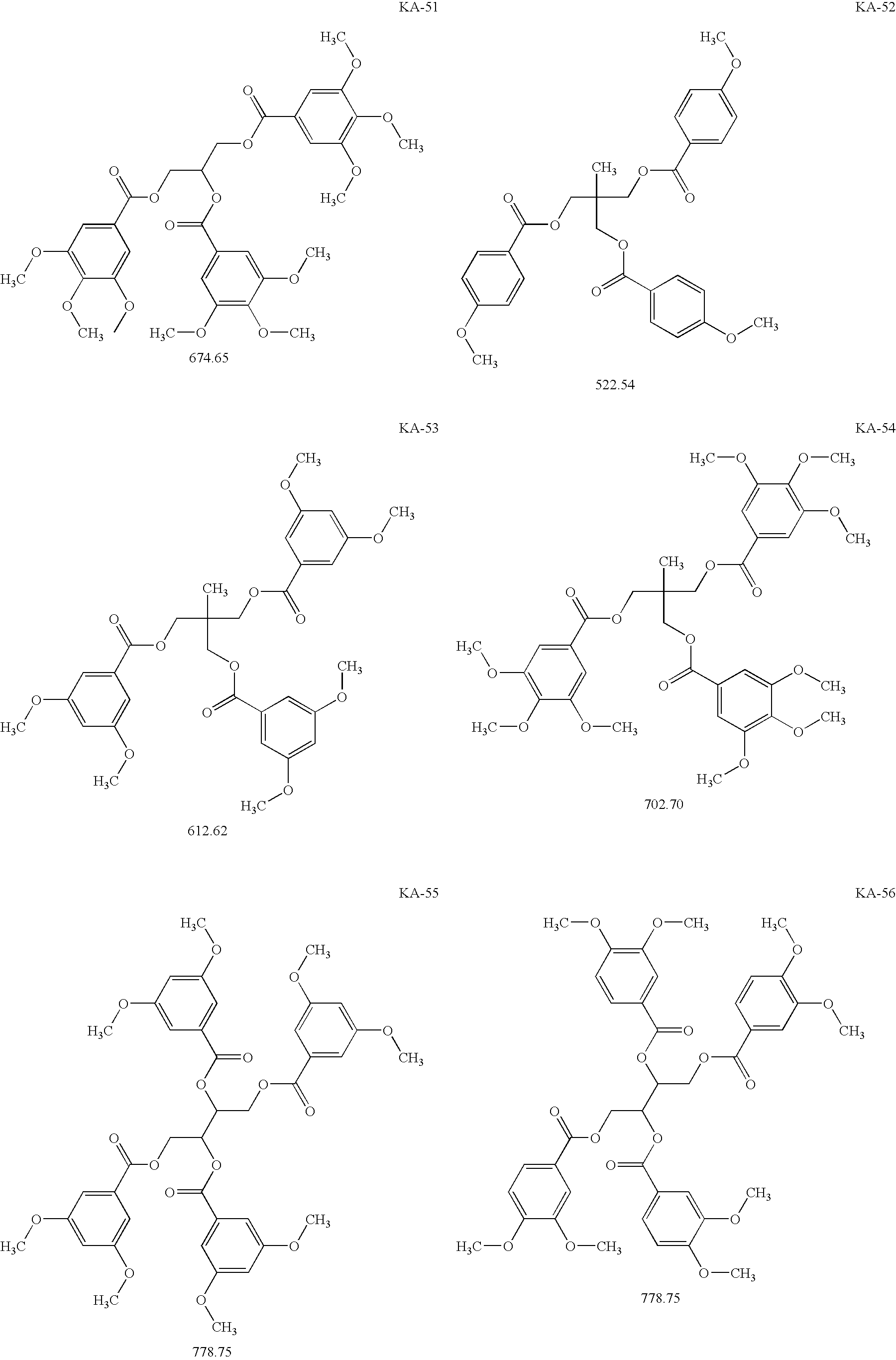

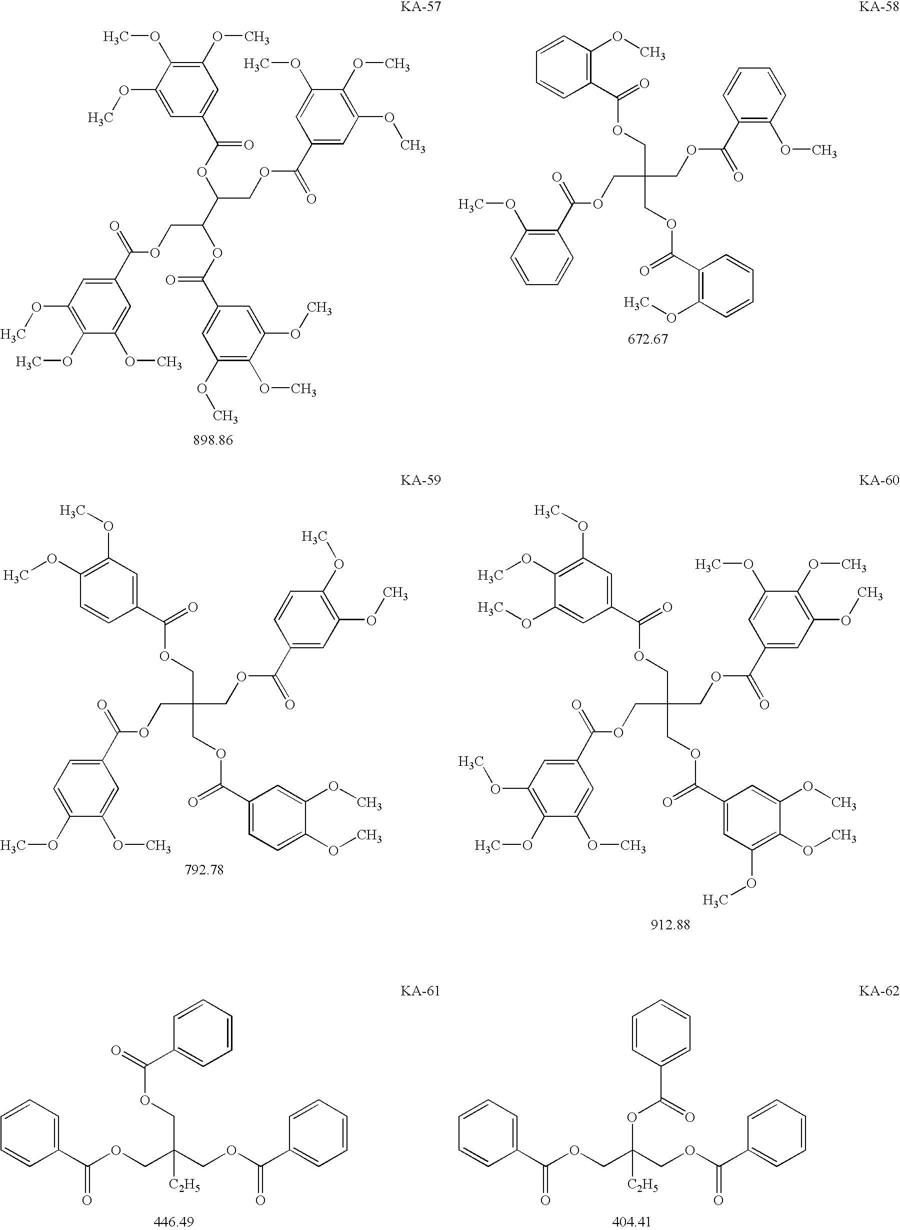

The cellulose ester optical film of the present invention may use another plasticizer together with the above.

An ester compound derived from an organic acid represented by Formula (7) and a polyalcohol exhibits high compatibility with cellulose ester and can be incorporated in the cellulose ester at high addition content. Consequently, bleeding-out tends not to occur even when another plasticizer or additive is used together, whereby other plasticizer or additive can be easily used together, if desired.

Further, when another plasticizer is simultaneously employed, the plasticizers represented by Formula (7) is preferably at least 50% by weight, more preferably at least 70%, but still more preferably at least 80%, based on the total weight of the plasticizers. When the plasticizer of the present invention is employed in the above range, it is possible to achieve a definite effect that the flatness of cellulose ester film produced by a melt-casting method is improved even under simultaneous use of other plasticizers.

Examples of other preferable plasticizers include the following plasticizers.

The ethylene glycol ester plasticizer as one of the polyvalent alcohol esters is exemplified by an ethylene glycol alkyl ester plasticizer such as ethylene glycol diacetate and ethylene glycol dibutylate; an ethylene glycol cycloalkyl ester plasticizer such as ethylene glycol dicyclopropyl carboxylate and ethyleneglycol dicyclohexyl carboxylate; and an ethylene glycol aryl ester plasticizer such as ethylene glycol dibenzoate and ethylene glycol di-4-methyl benzoate. The aforementioned alkylate group, cycloalkylate group and arylate group can be either the same with each other or different from each other. Further, they can be replaced. A mixture of the alkylate group, cycloalkylate group and arylate group can also be used. The substituents thereof can be linked by a covalent bond. The ethylene glycol part can be substituted. The partial structure of the ethylene glycol ester can be pended to part of the polymer or regularly, or can be introduced into part of the molecular structure of an additive such as antioxidant, acid scavenger and ultraviolet absorber.

The glycerine ester plasticizer as one of the polyvalent alcohol esters is exemplified by a glycerine alkyl ester such as triacetin, tributyrin, glycerine diacetate caprylate and glycerineolate propionate; a glycerine cycloalkyl ester such as glycerine tricyclopropyl carboxylater and glycerine tricyclohexyl carboxylate; a glycerine aryl ester such as glycerine tribenzoate, and glycerine 4-methyl benzoate; a diglycerine alkyl ester such as diglycerine tetraacetylate, diglycerine tetra propionate, diglycerine acetate tricaprylate, and diglycerine tetralaurate; a diglycerine cycloalkyl ester such as diglycerine tetra cyclobutyl carboxylate and diglycerine tetra cyclopentyl carboxylate; and a diglycerine aryl ester such as diglycerine tetrabenzoate and diglycerine 3-methyl benzoate. The alkylate group, cycloalkyl carboxylate group and arylate group can be the same with each other, different from each other, or can be substituted. Further, a mixture of alkylate group, cycloalkyl carboxylate group and arylate group can be used. The substituents thereof can be linked by covalent bond. Further, the glycerine and diglycerine part can be substituted. The partial structure of the glycerine ester and diglycerine ester can be pended to part of the polymer or regularly, or can be introduced into part of the molecular structure of an additive such as antioxidant, acid scavenger and ultraviolet absorber.

Other polyvalent alcohol ester plasticizers are exemplified by the polyvalent alcohol ester plasticizers described in paragraphs 30 through 33 of JP-A No. 2003-12823.

The dicarboxylic acid ester plasticizer as one of the polyvalent carboxylic acid esters is exemplified by:

an alkyldicarboxylate alkyl ester plasticizer such as didodesylmalonate (C1), dioctyladipate (C4) and dibutylsebacate (C8);

an alkyldicarboxylate cycloalkyl ester plasticizer such as dicyclopentyl succisinate and dicyclohexyl adipate;

an alkyldicarboxylate aryl ester plasticizer such as diphenylsuccisinate, di-4-methyl phenylglutarate;

a cycloalkyldicarboxylate alkyl ester plasticizer such as dihexyl-1,4-cyclohexane dicarboxylate and didesyl bicyclo[2.2.1]heptane-2,3-dicarboxylate;

a cycloalkyldicarboxylate cycloalkyl ester plasticizer such as dicyclohexyl-1,2-cyclobutane dicarboxylate, and dicyclopropyl-1,2-cyclohexyl dicarboxylate;

a cycloalkyldicarboxylate aryl ester plasticizer such as, diphenyl-1,1-cyclopropyl dicarboxylate and di-2-naphthyl-1,4-cyclohexane dicarboxylate;

an aryldicarboxylate alkyl ester plasticizer such as diethyl phthalate, dimethyl phthalate, dioctylphthalate, dibutylphthalate and di-2-ethyl hexyl phthalate;

an aryldicarboxylate cycloalkyl ester plasticizer such as dicyclopropyl phthalate and dicyclohexyl phthalate; and

an aryldicarboxylate aryl ester plasticizer such as diphenylphthalate and di-4-methyl phenylphthalate.

These alkoxy group and cycloalkoxy group can be the same with each other, different from each other, or can be mono-substituted. These substituents may be further substituted. Further, a mixture of alkylate group and cycloalkyl carboxylate group can be used. The substituents thereof can be linked by covalent bond. Further, the aromatic ring of the phthalic acid can be substituted. A polymer such as a dimer, trimer or tetramer may be used. The partial structure of the phthalic acid ester can be pended to part of the polymer or regularly, or can be introduced into part of the molecular structure of an additive such as antioxidant, acid scavenger and ultraviolet absorber.

Other polyvalent carboxylic acid ester plasticizers are exemplified by:

an alkyl polyvalent carboxylic acid alkyl ester plasticizer such as tridodesyltricarbalate and tributyl-meso-butane-1,2,3,4-tetracarboxylate;

an alkyl polyvalent carboxylic acid cycloalkyl ester plasticizer such as tricyclohexyl tricarbalate and tricyclopropyl-2-hydroxy-1,2,3-propane tricarboxylate;

an alkyl polyvalent carboxylic acid aryl ester plasticizer such as triphenyl 2-hydroxy-1,2,3-propane tricarboxylate and tetra 3-methyl phenyltetrahydrofuran-2,3,4,5-tetracarboxylate;

a cycloalkyl polyvalent carboxylic acid alkyl ester plasticizer such as tetrahexyl-1,2,3,4-cyclobutane tetracarboxylate and tetrabutyl-1,2,3,4-cyclopentane tetracarboxylate;

a cycloalkyl polyvalent carboxylic acid cycloalkyl ester plasticizer such as tetra cyclopropyl-1,2,3,4-cyclobutane tetracarboxylate and tricyclohexyl-1,3,5-cyclohexyl tricarboxylate;

a cycloalkyl polyvalent carboxylic acid aryl ester plasticizer such as triphenyl-1,3,5-cyclohexyl tricarboxylate, hexa-4-methyl phenyl-1,2,3,4,5,6-cyclohexyl hexacarboxylate;

an aryl polyvalent carboxylic acid alkyl ester plasticizer such as tridodesylbenzene-1,2,4-tricarboxylate, tetraoctyl benzene-1, 2,4,5-tetracarboxylate;

an aryl polyvalent carboxylic acid cycloalkyl ester plasticizer such as tricyclopentyl benzene-1,3,5-tricarboxylate and tetra cyclohexyl benzene-1,2,3,5-tetracarboxylate; and

an aryl polyvalent carboxylic acid aryl ester plasticizer such as triphenylbenzene-1,3,5-tetracarboxylate, hexa 4-methyl phenylbenzene-1,2,3,4,5,6-hexacarboxylate. These alkoxy group and cycloalkoxy group can be the same with each other, different from each other, or can be mono-substituted. These substituents may be further substituted. Further, a mixture of alkyl group and cycloalkyl group can be used. The substituents thereof can be linked by covalent bond. Further, the aromatic ring of the phthalic acid can be substituted. A polymer such as a dimer, trimer or tetramer may be used. The partial structure of the phthalic acid ester can be pended to part of the polymer or regularly, or can be introduced into part of the molecular structure of an additive such as antioxidant, acid scavenger and ultraviolet absorber.

Of the ester plasticizers made up of the polyvalent carboxylic acid and monovalent alcohol, the dialkyl carboxylic acid alkyl ester is preferably used, and is exemplified by the aforementioned dioctyladipate and tridesyltricarbalate.

Other plasticizers used in the present invention are exemplified by a phosphoric acid ester plasticizer, carbohydrate ester plasticizer and polymer plasticizer.

The phosphoric acid ester plasticizer is exemplified by:

a phosphate alkyl ester such as triacetyl phosphate and tributyl phosphate;

a phosphate cycloalkyl ester such as tricyclopentyl phosphate, cyclohexyl phosphate; and

a phosphate aryl ester such as triphenyl phosphate, tricresyl phosphate, cresyl phenyl phosphate, octyl diphenyl phosphate, diphenylbiphenyl phosphate, trioctyl phosphate, tributyl phosphate, trinaphthyl phosphate, trixylylphosphate and trisortho-biphenyl phosphate.

These substitutes can be the same with each other, different from each other, or can be further substituted. Further, a mixture of an alkyl group, cycloalkyl group and aryl group can be used. The substituents can be linked with each other by covalent bond.

It is also possible to mention:

an alkylene bis(dialkyl phosphate) such as ethylene bis(dimethyl phosphate) and butylene bis(diethyl phosphate);

an alkylene bis(diaryl phosphate) such as ethylene bis(diphenyl phosphate) and propylene bis(dinaphthyl phosphate);

an arylene bis(dialkyl phosphate) such as phenylene bis(dibutyl phosphate) and biphenylene bis(dioctyl phosphate); and

a phosphoric acid ester such as arylene bis(diaryl phosphate) including phenylene bis(diphenyl phosphate) and naphthylene bis(ditoluoyl phosphate).

These substitutes can be the same with each other, different from each other, or can be further substituted. Further, a mixture of an alkyl group, cycloalkyl group and aryl group can be used. The substituents can be linked with each other by covalent bond.

Further, the partial structure of the phosphoric acid ester can be pended to part of the polymer or regularly, or can be introduced into part of the molecular structure of an additive such as antioxidant, acid scavenger and ultraviolet absorber. Of the aforementioned compounds, phosphate aryl ester and arylene bis(diaryl phosphate) are preferably used, and is exemplified by triphenyl phosphate, phenylene bis(diphenyl phosphate).

The following describes the carbohydrate ester plasticizer: The carbohydrate can be defined as a monosaccharide, disaccharide or trisaccharide wherein the saccharides are present in the form of pyranose or furanose (six- or five-membered ring). The carbohydrate can be exemplified in an unrestricted sense by glucose, saccharose, lactose, cellobiose, mannose, xylose, ribose, galactose, arabinose, fructose, sorbose, cellotriose and raffinose. The carbohydrate ester refers to the ester compound formed by the hydroxyl group of carbohydrate and carboxylic acid by dehydration and condensation. To put it in greater details, it refers to the aliphatic carboxylic acid ester of the carbohydrate or aromatic carboxylic acid ester. The aliphatic carboxylic acid can be exemplified by acetic acid and propionic acid. The aromatic carboxylic acid is exemplified by benzoic acid, toluic acid and anisic acid. The carbohydrate has the number of hydroxyl groups in conformity to the type. The ester compound can be formed by reaction between part of the hydroxyl group and carboxylic acid, or by reaction between the entire hydroxyl group and carboxylic acid. In the present invention, the ester compound is preferably formed by reaction between the entire hydroxyl group and carboxylic acid.

The carbohydrate ester plasticizer can be preferably exemplified by glucose penta acetate, glucose penta propionate, glucose pentabutylate, saccharose octaacetate, and saccharose octabenzoate. Of these, saccharose octabenzoate is preferably used

The polymer plasticizer is exemplified by: an aliphatic hydrocarbon polymer; an alicyclic hydrocarbon polymer; an acryl polymer such as polyacrylic acid ethyl, polymethacrylic acid methyl, copolymer between methacrylic acid methyl and methacrylic acid-2-hydroxyethyl (e.g., copolymer of any ratio between 1:99 and 99:1); a vinyl based polymer, such as polyvinyl isobutylether and poly-N-vinyl pyrrolidone; copolymer between methacrylic acid methyl and N-vinyl pyrrolidone (e.g., copolymer of any ratio between 1:99 and 99:1); a styrene polymer such as polystyrene and poly-4-hydroxystyrene; copolymer between methacrylic acid methyl and 4-hydroxystyrene (e.g., copolymer of any ratio between 1:99 and 99:1); a polyester such as polybutylene succisinate, polyethylene terephthalate, polyethylene naphthalate; a polyether such as polyethylene oxide and polypropylene oxide; polyamide, polyurethane, and polyurea. The number average molecular weight is preferably about 1,000 through 500,000, and more preferably 5,000 through 200,000. If this value is less than 1,000, a volatilization problem will occur. If it is over 500,000, the plasticization performance will deteriorate to give an adverse effect to the mechanical properties of the cellulose ester film. The polymer plasticizer can be an independent polymer made up of one repeating unit or a copolymer containing a plurality of repeating structures. Further, two or more of the aforementioned polymers can be used in combination.

If a cellulose acylate film of the present invention is colored, since the colored film provides some influence for an optical use, the degree of yellow (an yellow index, YI) is preferably 3.0 or less, more preferably 3.0 or less. The degree of yellow can be measured based on JIS-K7103.

Similarly to the case of the aforementioned cellulose ester, the plasticizer is preferably cleared of impurities such as residual acids, inorganic salts and organic low molecules that were produced in the manufacturing phase or that have occurred during storage. The plasticizer is more preferably purified to a purity level of 99- or more. The amount of the residual acids and water is preferably 0.01 through 100 ppm. This will reduce the thermal deterioration and will enhance the film making stability, film optical property and film mechanical property when the cellulose resin is subjected to the process of melting film formation method.

(Ultraviolet Absorbent)

The ultraviolet absorbent preferably has excellent ultraviolet light absorbance for wavelengths not greater than 370 nm in view of preventing deterioration of the polarizer or the display device due to ultraviolet light, and from the viewpoint of the liquid crystal display it is preferable that there is little absorbance of visible light which has wavelength of not less than 400 nm.

Examples of the ultraviolet absorbent includes salicylic acid type ultraviolet absorbents (such as phenyl salicylate, p-tert-butyl salicylate), or benzophenone type ultraviolet absorbents (such as 2,4-dihydroxybenzophenone, 2,2′-dihydroxy-4,4′-dimethoxybenzophenone), benzotriazole type ultraviolet absorbents (such as 2-(2′-hydroxy-3′-tert-butyl-5′-methyl phenyl)-5-chloro benzotriazole, 2-(2′-hydroxy-3′,5′-di-tert-butylphenyl)-5-chloro benzotriazole, 2-(2′-hydroxy-3″,5′-di-tert-amylphenyl)benzotriazole, 2-(2-hydroxy-3′-dodecyl-5′-methyl phenyl)benzotriazole, 2-(2′-hydroxy-3′-tert-butyl-5′-(2-octyl oxycarbonyl ethyl)-phenyl)-5-chlorobenzotriazol, 2-(2′-hydroxy-3′-(1-methyl-1-phenyl ethyl)-5-(1,1,3,3,-tetramethyl butyl)-phenyl)benzotriazol, 2-(2′-hydroxy-3′,5′-di-(1-methyl-1-phenyl ethyl)-phenyl)benzotriazol), cyano acrylate type ultraviolet absorbents (such as 2′-ethylhexyl-2-cyano-3,3-diphenyl acrylate, ethyl-2-cyano-3-(3′,4-methylene dioxyphenyl)-acrylate), triazin type ultraviolet absorbents, compounds described in JP-A Nos. 58-185677, 59-149350, nickel complex compounds and inorganic powders.

As the ultraviolet absorbent concerning the present invention, the benzotriazole type ultraviolet absorbents and the triazin type ultraviolet absorbents which have high transparency and are excellent in effect to prevent the deterioration of a polarizing plate an a liquid crystal element, are preferable, and the benzotriazole type ultraviolet absorbents having a more suitable absorption spectrum is specifically preferable.

A conventionally well-known the benzotriazole type ultraviolet absorbents specifically preferably usable together with the ultraviolet absorbents according to the present invention may be made in his, for example, 6,6′-methylene bis(2-(2H-benzo[d][11,23]triazol-2-yl))-4-(2,4,4,-trimethyl pentan-2-yl)phenol, 6,6′-methylene bis(2-(2H-benzo[d][1,2,3]triazol(e)-2-yl))-4-(2-hydroxyethyl)phenol may be employed.

In the invention, a conventional ultraviolet absorbing polymer can be used in combination. The conventional ultraviolet absorbing polymer is not specifically limited, but there is, for example, a homopolymer obtained by polymerization of LUVA-93 (produced by Otuka Kagaku Co., Ltd.) and a copolymer obtained by copolymerization of LUVA-93 and another monomer. Typical examples of the ultraviolet absorbing polymer include PUVA-30M obtained by copolymerization RUVA 93 and methyl methacrylate (3:7 by weight ratio), PUVA-50M obtained by copolymerization RUVA 93 and methyl methacrylate (5:5 by weight ratio), and ultraviolet absorbing polymers disclosed in JP-A No. 2003-113317.

Commercially available TINUVIN 109, TINUVIN 171, TINUVIN 360, TINUVIN 900 and TINUVIN 928 (each being manufactured by Chiba Specialty Chemical Co., Ltd.), LA-31 (manufactured by Asahi Denka Co., Ltd.), RUVA-100 (manufactured by Otsuka Chemical Co., Ltd.), and Sumisorb 250 (manufactured by Sumitomo Chemical Co., Ltd.) may also be used.

Examples of the benzophenone based compound include 2,4-hydroxy benzophenone, 2,2′-dihydroxy-4-methoxy benzophenone, 2-hydroxy-4-methoxy-5-sulfobenzophenone, bis (2-methoxy-4-hydroxy-s-benzoyl phenyl methane) and the like, but are not limited thereto.

In the present invention, the ultraviolet absorbents may be preferably added in an amount of 0.1 to 20% by weight, more preferably 0.5 to 10% by weight, still more preferably 1 to 59 by weight. These may be used in a combination of two or more kinds.

(Fine Particles)

In order to provide a lubricant property, as well as optical and mechanical functions, fine particles such as matting agent is incorporated into to the cellulose ester optical film of the present invention. Listed as such fine particles are particles of inorganic or organic compounds. Employed matting agents are preferably as fine as possible. Examples of fine particles include: inorganic particles such as silicon dioxide, titanium dioxide, aluminum oxide, zirconium oxide, calcium carbonate, kaolin, talc, calcined calcium silicate, hydrated calcium silicate, aluminum silicate, magnesium silicate, or calcium phosphate and crosslinking polymer particles. Of these, silicon dioxide is preferred due to a resulting decrease in film haze. It is preferable that these particles are subjected to a surface treatment, since it is possible to lower the film haze.

The above surface treatment is preferably carried out employing halosilanes, alkoxysilanes, silazane, or siloxane. As the average diameter of the particles increases, lubricant effect is enhanced, while, as the average diameter decreases, the transparency of the film increases. The average diameter of the fine particles is 0.005-1.0 μm, preferably 5-50 nm, but is more preferably 7-14 nm. The average diameter may be based on primary or secondary particle. The average diameter can be determined by observing a length of long axis of two hundred particles selected at random via an electron microscope. These particles are preferably employed to form unevenness of 0.01-1.0 μm on the surface of the cellulose acylate film. The content of the particles in cellulose ester is preferably 0.005 to 0,3% by weight for the cellulose ester.

Examples of silicon dioxide particles include AEROSIL 200, 200V, 300, R972, R972V, R974, R202, R812, OX50, TT600 and NAX50 (all of which are produced by Nihon Aerosil Co., Ltd); SEAHOSTAR KE-P100, SEAHOSTAR KE-P30 (Produced by NIPPON SHOKUBAI Co., Ltd.). Of these, preferred are AEROSIL 200V, R972, R972V, R974, R202, R812, NAX50, KE-P100 and KE-P30. When two types of the particles are employed in combination, they may be mixed at an optional ratio to use. It is possible to use particles different in the average particle diameter or in materials, for example, AEROSIL 200V and R972V can be used at a weight ratio in the range of 0.1:99.9 to 99.9:0.1.

Existence of particles used as the above-mentioned matting agent in a film may also be used to increase the strength of a film as other purposes. Moreover, the existence of the above-mentioned particles in a film can also improve the orientation ability of cellulose ester constituting the cellulose ester optical film of the present invention.

### (Other Additives)

The cellulose ester optical film can further contain a viscosity lowering agent, a retardation controlling agent, an acid scavenger, a dye or a pigment, in addition to the plasticizer, a UV absorbent or fine particles described above.

(Viscosity Lowering Agent)

In the present invention, a hydrogen bondable solvent may be added in order to reduce a melt viscosity. The hydrogen bondable solvent means an organic solvent capable of causing “bonding” of a hydrogen atom mediation generated between electrically negative atoms (oxygen, nitrogen, fluorine, chlorine) and hydrogen covalent bonding with the electrically negative atoms, in other word, it means an organic solvent capable of arranging molecules approaching to each other with a large bonding moment and by containing a bond including hydrogen such as O—H (oxygen hydrogen bond), N—H (nitrogen hydrogen bond) and F—H (fluorine hydrogen bond), as disclosed in the publication “inter-molecular force and surface force” written by J. N. Israelachibiri (translated by Yasushi Kondo and Hiroyuki Ohshima, published by McGraw-Hill, 1991). Since the hydrogen bondable solvent has an ability to form a hydrogen bond between celluloses stronger than that between molecules of cellulose ester, the melting temperature of a cellulose ester composition can be lowered by the addition of the hydrogen bondable solvent than the glass transition temperature of a cellulose ester alone in the melting casting method conducted in the present invention. Further, the melting viscosity of a cellulose ester composition containing the hydrogen bondable solvent can be lowered than that of a cellulose ester in the same melting temperature.

Examples of the hydrogen bondable solvents include alcohol such as methanol, ethanol, propanol, isopropanol, n-butanol, sec-butanol, t-butanol, 2-ethyl hexanol, heptanol, octanol, nonanol, dodecanol, ethylene glycol, propylene glycol, hexylene glycol, dipropylene glycol, polyethylene glycol, polypropylene glycol, methyl cellosolve, ethyl cellosolve, butyl cellosolve, hexyl cellosolve, and glycerol; ketone such as acetone and methyl ethyl ketone; carboxylic acid such as formic acid, acetic acid, propionic acid, and butyric acid; ether such as diethyl ether, tetrahydrofuran, and dioxaner pyrolidone such as N-methylpyrolidone; and amines such as trimethylamine and pyridine. These hydrogen bondable solvents may be used alone or a mixture of two or more kinds. Among them, alcohol, ketone, and ether are desirable, and especially, methanol, ethanol, propanol, isopropanol, octanol, dodecanol, ethylene glycol, glycerol, acetone, and tetrahydrofuran are desirable. Further, water-soluble solvents such as methanol, ethanol, propanol, isopropanol, ethylene glycol, glycerol, acetone, and tetrahydrofuran are more preferable. Here, “water soluble” means that the solubility for 100 g of water is 10 g or more.

(Retardation Adjusting Agent)

In the cellulose ester optical film of the present invention, a polarizing plate treatment to provide an optical compensation function may be conducted such that a liquid crystal layer is formed on the cellulose ester film by forming an orientation layer so as to combine the retardation of the cellulose ester film and that of the liquid crystal layer, or a polarizing plate protection film may be made to contain a compound for adjusting the retardation. As the composition to be added to adjust the retardation, an aromatic compound including two or more aromatic rings disclosed in the specification of the European patent No. 911,656 A2 may be used or two or more kinds of aromatic compound may be used. Examples of the aromatic rings of the aromatic compound include aromatic hetero rings in addition to aromatic hydrocarbon rings. The aromatic hetero rings may be more preferable, and the aromatic hetero rings are generally unsaturated hetero rings. Especially, compounds having 1,3,5-triazine ring are desirable.

### (Acid Scavengers)

The acid scavenger is an agent that has the role of trapping the acid (proton acid) remaining in the cellulose ester that is brought in. Also when the cellulose ester is melted, the side chain hydrolysis is promoted due water in the polymer and the heat, and in the case of CAP, acetic acid or propionic acid is formed. It is sufficient that the acid scavenger is able to chemically bond with acid, and examples include but are not limited to compounds including epoxy, tertiary amines, and ether structures.

Examples thereof include epoxy compounds, which are acid trapping agents described in U.S. Pat. No. 4,137,201. The epoxy compounds which are trapping agents include those known in the technological field, and examples include polyglycols derived by condensation such as diglycidyl ethers of various polygycols, especially those having approximately 8-40 moles of ethylene oxide per mole of polyglycol, diglycidyl ethers of glycerol and the like, metal epoxy compounds (such as those used in the past in vinyl chloride polymer compositions and those used together with vinyl chloride polymer compositions), epoxy ether condensation products, a diglycidyl ether of Bisphenol A (namely 2,2-bis(4-glycidyloxyphenyl) propane) epoxy unsaturated fatty acid esters (particularly alkyl esters having about 4-2 carbon atoms of fatty acids having 2-22 carbon atoms (such as butyl epoxy stearate) and the like, and various epoxy long-chain fatty acid triglycerides and the like (such as epoxy plant oils which are typically compositions of epoxy soy bean oil and the like and other unsaturated natural oils (these are sometimes called epoxidized natural glycerides or unsaturated fatty acids and these fatty acids generally have 12 to 22 carbon atoms)). Particularly preferable are commercially available epoxy resin compounds, which include an epoxy group such as EPON 815c, and other epoxidized ether oligomer condensates such as those represented by the general Formula (10).

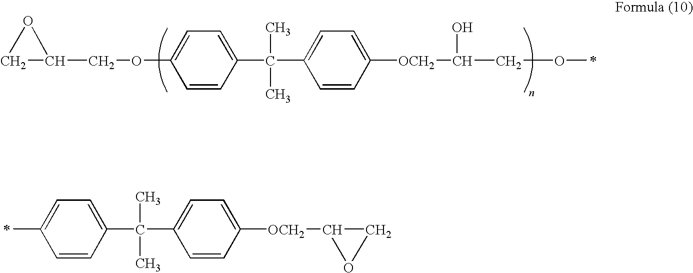

in Formula (10), n is an integer of 0-12. Other examples of acid trapping agents that can be used include those described in paragraphs 87-105 in JP-A 5-194788.

As same as the above mentioned cellulose resin, the acid trapping agent desirably removes impurities such as a residual acid, an inorganic salt and an organic low molecule which is be carried over from the time of manufacturing or generated during preservation, and more preferably to obtain a purity of 99% or more. The residual acid and water are preferably 0.01 to 100 ppm, whereby heat deterioration can be refrained in the process of forming a film by melting a cellulose resin, and the film formation stability, the optical property of a film and a mechanical physical property can be improved.

Incidentally, the acid trapping agents may be called an acid capturing agent, an acid scavenging agent, an acid catcher, etc., however, it may be used in the present invention without any difference regardless of these names.

(Melt Casting Method)

The film constituting material is required to generate very small amount of volatile matter or no volatile matter at all in the melting and film formation process. This is intended to ensure that the foaming occurs at the time of heating and melting to remove or avoid the defect inside the film and poor flatness on the film surface.

When the film constituting material is molten, the amount of the volatile matter contained is 1.0% by mass or less, preferably 0.5% by mass or less, more preferably 0.2% by mass or less. In the present invention, a differential thermogravimetric apparatus (differential weight calorimetry (TI/DTA 200 by Seiko Denshi Kogyo Co., Ltd.) is used to get a weight loss on heating from 30° C. through 250° C. The result is used as the amount of the volatile matter contained.

Before film formation or at the time of heating, the moisture and the volatile components represented the aforementioned solvent are preferably removed from the film constituting material to be used. They can be removed by the conventional known method. A heating method, depressurization method, or heating/depressurization method can be used to remove them in air or in nitrogen atmosphere as an inert gas atmosphere. When the known drying method is used, this procedure is carried out in the temperature range wherein the film constituting material is not decomposed. This is preferred to ensure good film quality.

Generation of the volatile components can be reduced by the drying step prior to film formation. It is possible to dry the resin independently, or dry the resin and film constituting materials by separating into a mixture or compatible substances made of at least one or more types other than the resin. The drying temperature is preferably 100° C. or more. If the material to be dried contains any substance having a glass-transition temperature, and is heated up to a drying temperature higher than that glass-transition temperature, the material will be fused and will become difficult to handle. To avoid this, the drying temperature is preferably kept at a level not exceeding the glass-transition temperature. If a plurality of substances has a glass-transition temperature, the glass-transition temperature of the substance having a lower glass-transition temperature should be used as a standard. This temperature is preferably 100° C. or more through (glass-transition temperature −5)° C. or less, more preferably 110° C. or more through (glass-transition temperature −20) ° C. or less. The drying time is preferably 0.5 through 24 hours, more preferably 1 through 18 hours, still more preferably 1.5 through 12 hours. If the drying temperature is too low, the rate of removing the volatile components will be reduced and much time will be required for drying. The drying process can be divided into two or more steps. For example, the drying process may includes a pre-drying step for storing the material, and a preliminary drying step for the period one week before film formation through the period immediately before film formation.

The film forming method by melt casting can be divided into heating melting molding methods such as a melt-extrusion molding method, press molding method, inflation method, injection molding method, blow molding method, draw molding method, and others. Of these methods, melt-extrusion molding method is preferred to produce a polarizing plate protective film characterized by excellent mechanical strength and surface accuracy. The following describes the film manufacturing method of the present invention with reference to the melt extrusion method.

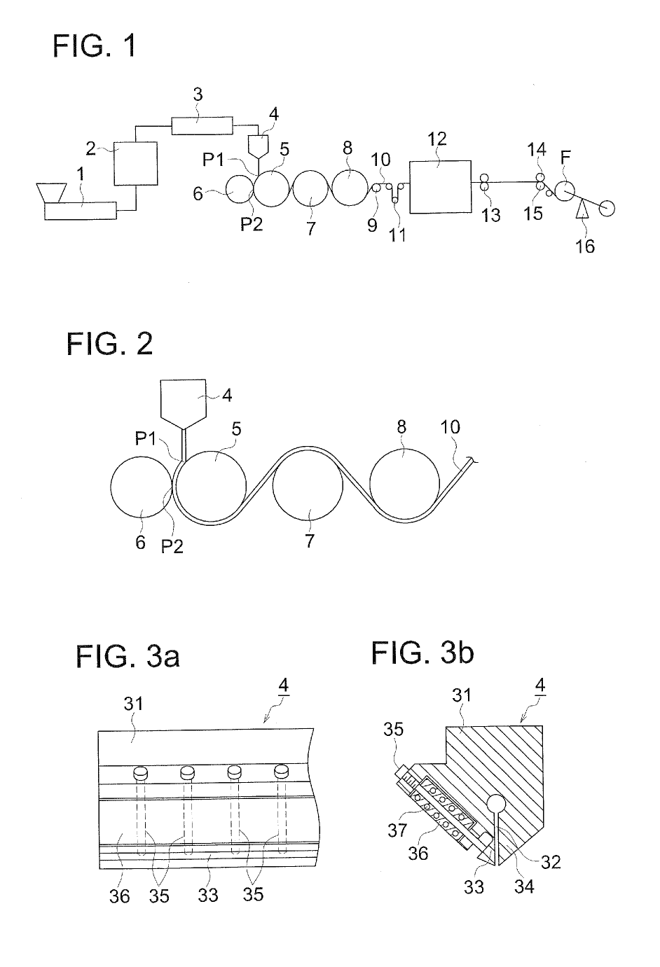

FIG. 1 is a schematic flow sheet showing the overall structure of the apparatus for manufacturing the cellulose acylate film preferably used in the present invention. FIG. 2 is an enlarged view of the cooling roll portion from the flow casting die.

In the cellulose ester optical film manufacturing method shown in FIG. 1 and FIG. 2, the film material such as cellulose resin is mixed, then melt extrusion is conducted on a first cooling roll 5 from the flow casting die 4 using the extruder 1. The material is be circumscribed on a first cooling roll 5, second cooling roll 7 and third cooling roll 8—a total of three cooling rolls—sequentially. Thus, the material is cooled, solidified and formed into a film 10. With both ends gripped by a stretching apparatus 12, the film 10 separated by a separation roll 9 is stretched across the width and is wound by a winding apparatus 16. To correct flatness, a touch roll 6 is provided. This is used to press the film against the surface of the first cooling roll 5. This touch roll 6 has an elastic surface and forms a nip with the first cooling roll 5. The details of the touch roll 6 will be described later.

The conditions for the cellulose ester optical film manufacturing method are the same as those for thermoplastic resins such as other polyesters. The material is preferably dried in advance. A vacuum or depressurized dryer, or dehumidified hot air dryer is used to dry the material until the moisture is reduced to 1000 ppm or less, preferably 200 ppm or less.

For example, the cellulose ester based resin having been dried under hot air, vacuum or depressurized atmosphere is extruded by the extruder 1 and is molten at a temperature of about 200 through 300° C. The leaf disk filter 2 is used to filter the material to remove foreign substances.

Stainless fiber sintered filter is preferably used for the filter of removing foreign substances. Stainless fiber sintered filter is provided as integrated form by complexly interlining with stainless fibers, compressing and sintering the contacted portion. Filtering accuracy can be adjustable by changing density of the fibers via thickness of the fibers and compression amount. Puluraly laminated structure having filtering accuracy from coarse to fine sequencially is preferred. Further by arranging for increasing filtering accuracy gradually or repeating coarse and fine filtering accuracy, filtering life is extended and capturing capacity of foreign substances or gels is increasing and preferably used.

When the material is fed from the feed hopper (not illustrated) to the extruder 1, the material is preferably placed in the vacuum, depressurized or insert gas atmosphere to prevent oxidation and decomposition.

When additives such as plasticizer are not mixed in advance, they can be kneaded into the material during the process of extrusion. To ensure uniform mixing, a mixer such as a static mixer 3 is preferably utilized.

In the present invention, the cellulose resin and the additives such as a stabilizer to be added as required are preferably mixed before being molten. It is more preferred that the cellulose resin and stabilizer should be mixed first. A mixer may be used for mixing. Alternatively, mixing may be completed in the process of preparing the cellulose resin, as described above. It is possible to use a commonly used mixer such as a V-type mixer, conical screw type mixer, horizontal cylindrical type mixer, Henschel mixer and ribbon mixer.

As described above, subsequent to mixing of the film constituting material, the mixture can be directly molten by the extruder 1 to form a film. Alternatively, it is also possible to palletize the film constituting material, and the resultant pellets may be molten by the extruder 1, whereby a film is formed. The following arrangement can also be used: When the film constituting material contains a plurality of materials having different melting points, so-called patchy half-melts are produced at the temperature wherein only the material having a lower melting point is molten. The half-melts are put into the extruder 1, whereby a film is formed. Further, the following arrangement can also be used: If the film constituting material contains the material vulnerable thermal decomposition, a film is directly formed without producing pellets, thereby reducing the frequency of melting. Alternatively, a film is produced after patchy half-melts have been formed, as described above.

Various types of commercially available extruders can be used as the extruder 1. A melt-knead extruder is preferably utilized. Either a single-screw extruder or a twin-screw extruder can be used. When producing a film directly without pellets being formed from the film constituting material, an adequate degree of mixing is essential. In this sense, a twin-screw extruder is preferably used. A single-screw extruder can be used if the screw is changed into a kneading type screw such as a Madoc screw, Unimelt screw or Dulmage screw, because a proper degree of mixing can be obtained by this modification. When pellets or patchy half-melts are used as film constituting materials, both the single screw extruder and twin screw extruder can be used.

In the cooling process inside the extruder 1 and after extrusion, oxygen density is preferably reduced by an inert gas such as nitrogen gas or by depressurization.

The preferred conditions for the melting temperature of the film constituting material inside the extruder 1 vary according to the viscosity and discharge rate of the film constituting material as well as the thickness of the sheet to be produced. Generally, the melting temperature is Tg or more through Tg+100° C. or less with respect to the glass-transition temperature Tg of the film, preferably Tg+10° C. or more through Tg+90° C. or less. The melting temperature is generally in the range of 150-300° C., preferably 180-270° C., more preferably 200-270° C. The melt viscosity at the time of extrusion is 1 through 10000 Pa·s, preferably 10 through 1000 Pa·s. The retention time of the film constituting material inside the extruder 1 should be as short as possible. It is within 10 minutes, preferably within 5 minutes, more preferably within 3 minutes. The retention time varies according to the type of the extruder and the conditions for extrusion. It can be reduced by adjusting the amount of the material to be supplied, the L/D, the speed of screw and the depth of screw groove.

The shape and speed of the screw or the extruder 1 are adequately selected in response to the viscosity and discharge rate of the film constituting material. In the present invention, the shear rate of the extruder 1 is 1/sec. through 10000/sec., preferably 5/sec. through 1000/sec., more preferably 10/sec. through 100/sec.

The extruder 1 that can be used in the present invention can be obtained as a plastic molding machine generally available on the market.

The film constituting material extruded from the extruder 1 is fed to the flow casting die 4, and the slit of the flow casting die 4 is extruded as a film. There is no restriction to the flow casting die 4 if it can be used to manufacture a sheet or film. The material of the flow casting die 4 are exemplified by hard chromium, chromium carbonate, chromium nitride, titanium carbide, titanium carbonitride, titanium nitride, cemented carbide, ceramic (tungsten carbide, aluminum oxide, chromium oxide), which are sprayed or plated. Then they are subjected to surface processing, as exemplified by buffing and lapping by a grinder having a count of #1000 or later planar cutting (in the direction perpendicular to the resin flow) by a diamond wheel having a count of #1000 or more, electrolytic grinding, and electrolytic complex grinding. The preferred material of the lip of the flow casting die 4 is the same as that of the flow casting die 4. The surface accuracy of the lip is preferably 0.5 S or less, more preferably 0.2 S or less.

The slit of this flow casting die 4 is designed in such a way that the gap can be adjusted. This is shown in FIG. 3. FIG. 3a shows a schematic drawing of an example of principal portion of casting die, and FIG. 3b shows a cross section of principal portion of casting die. Of a pair of lips forming the slit 32 of the flow casting die 4, one is the flexible lip 33 of lower rigidity easily to be deformed, and the other is a stationary lip 34. Many heat bolts 35 are arranged at a predetermined pitch across the flow casting die 4, namely, along the length of the slit 32. Bach heat bolt 35 includes a block 36 containing a recessed type electric heater 37 and a cooling medium passage. Each heat bolt 35 penetrates the block 36 in the vertical direction. The base of the heat bolt 35 is fixed on the die (main body) 31, and the front end is held in engagement with the outer surface of the flexible lip 33. While the block 36 is constantly cooled, the input of the recessed type electric heater 37 is adjusted to increase or decrease the temperature of the block 36, this adjustment causes thermal extension and contraction of the heat bolt 35, and hence, displacement of the flexible lip 33, whereby the film thickness is adjusted. The following arrangement can also be used: A thickness gauge is provided at predetermined positions in the wake of the die. The web thickness information detected by this gauge is fed back to the control apparatus. This thickness information is compared with the preset thickness information of the control apparatus, whereby the power of the heat generating member of the heat bolt or the ON-rate thereof is controlled by the signal for correction control amount sent from this apparatus. The heat bolt preferably has a length of 20 through 40 cm, and a diameter of 7 through 14 mm. A plurality of heat bolts, for example, several tens of heat bolts are arranged preferably at a pitch of 20 through 40 mm. A gap adjusting member mainly made up of a bolt for adjusting the slit gap by manually movement in the axial direction can be provided, instead of a heat bolt. The slit gap adjusted by the gap adjusting member normally has a diameter of 200 through 3000 μm, preferably 500 through 2000 μm.

The first through third cooling roll is made of a seamless steel pipe having a wall thickness of about 20 through 30 mm. The surface is mirror finished. It incorporates a tune for feeding a coolant or heating medium. Heat is absorbed or added from the film on the roll by the coolant or heating medium flowing through the tube.

In the meantime, the touch roll 6 held in engagement with the first cooling roll 5 has an elastic surface. It is deformed along the surface of the first cooling roll 5 by the pressure against the first cooling roll 5, and forms a nip between this roll and the first roll 5. To be more specific, the touch roll 6 corresponds to the pressing rotary member of the present invention. As the touch roll 6, the touch roll disclosed in Japanese Registration Patent Nos. 3194904, 3422798, JP-A 2002-36332 and JP-A 2002-36333 can be preferably utilized. Commercially available touch roll can be also utilized. Details are explained bellow.

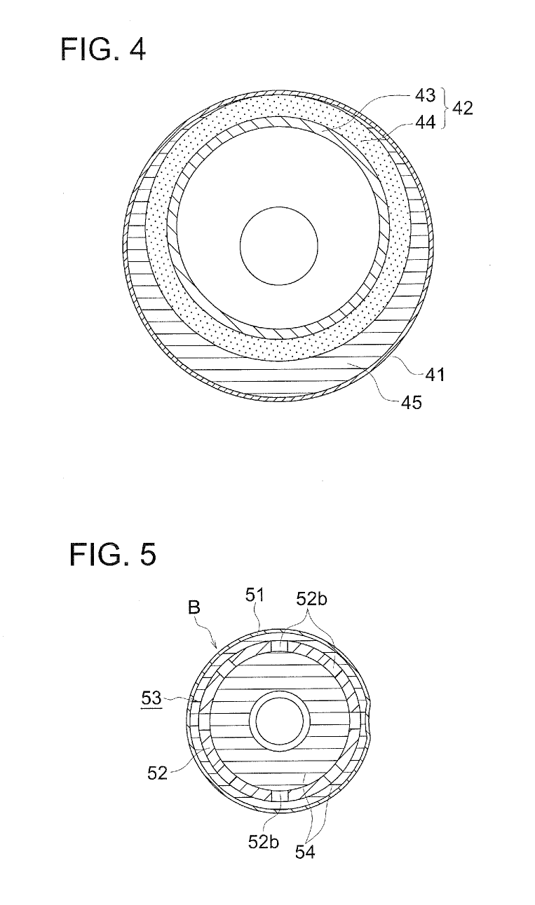

FIG. 4 is a schematic cross section of pressing rotation member (the touch roll 6 as the first embodiment (hereinafter referred to as “touch roll A”)). As illustrated, the touch roll A is made up of an elastic roller 42 arranged inside the flexible metallic sleeve 41.

The metallic sleeve 41 is made of a stainless steel having a thickness of 0.3 mm, and is characterized by high degree of flexibility. If the metallic sleeve 41 is too thin, strength will be insufficient. If it is too thick, elasticity will be insufficient. Thus, the thickness of the metallic sleeve 41 is preferably 0.1 through 1.5 mm. The elastic roller 42 is a roll formed by installing a rubber 44 on the surface of the metallic inner sleeve 43 freely rotatable through a bearings. When the touch roll A is pressed against the first cooling roll 5, the elastic roller 42 presses the metallic sleeve 41 against the first cooling roll 5, and the metallic sleeve 41 and elastic roller 42 is deformed, conforming to the shape of the first cooling roll 5, whereby a nip is formed between this roll and the first cooling roll. The cooling water 45 is fed into the space formed inside the metallic sleeve 41 with the elastic roller 42.

FIG. 5 shows a cross section of the second embodiment of pressing rotation member (hereinafter referred to as “touch roll B”) on the plane vertical to the rotating axis.

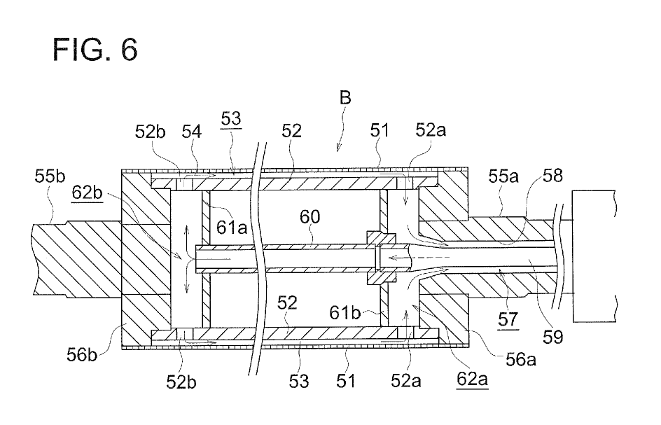

FIG. 6 shows a cross section of the second embodiment of pressing rotation member (touch roll B) on the plane including the rotating axis.

The touch roll B in FIG. 5 and FIG. 6 is formed of an outer sleeve 51 of flexible seamless stainless steel tube (having a thickness of 4 mm), and metallic inner sleeve 52 of high rigidity arranged coaxially inside this outer sleeve 51. Coolant or heating medium 54 is led into the space 53 formed between the outer sleeve 51 and inner sleeve 52. To put it in greater details, the touch roll B is formed in such a way that the outer sleeve supporting flanges 56a and 56b are mounted on the rotary shafts 55a and 55b on both ends, and a thin-walled metallic outer sleeve 51 is mounted between the outer peripheral portions of these outer sleeve supporting flanges 56a and 56b. The fluid supply tube 59 is arranged coaxially inside the fluid outlet port 58 which is formed on the shaft center of the rotary shaft 55a and constitutes a fluid return passage 57. This fluid supply tube 59 is connected and fixed to the fluid shaft sleeve 60 arranged on the shaft center which is arranged inside the thin-walled metallic outer sleeve 51. Inner sleeve supporting flanges 61a and 61b are mounted on both ends of this fluid shaft sleeve 60, respectively. A metallic inner sleeve 52 having a wall thickness of about 15 through 20 mm is mounted in the range from the position between the outer peripheral portions of these inner sleeve supporting flanges 61a and 61b to the outer sleeve supporting flange 56b on the other end. For example, a coolant flow space 53 of about 10 mm is formed between this metallic inner sleeve 52 and thin-walled metallic outer sleeve 51. An outlet 52a and an inlet 52b communicating between the flow space 53 and intermediate passages 62a and 62b outside the inner sleeve supporting flanges 61a and 61b are formed on the metallic inner sleeves 52 close to both ends, respectively.

To provide pliability, flexibility and restoring force close to those of the rubber, the outer sleeve 51 is designed thin within the range permitted by the thin cylinder theory of elastic mechanics. The flexibility evaluated by the thin cylinder theory is expressed by wall thickness t/roll radium r. The smaller the t/r, the higher the flexibility. The flexibility of this touch roll B meets the optimum condition when t/r≦0.03. Normally, the commonly used touch roll has a roll diameter R=200 through 500 mm (roll radius r=R/2) a roll effective width L=500 through 1600 mm, and an oblong shape of r/L<1. As shown in FIG. 6, for example, when roll diameter R=300 mm and the roll effective width L=1200 mm, the suitable range of wall thickness t is 150×0.03=4.5 mm or less. When pressure is applied to the molten sheet width of 1300 mm at the average linear pressure of 100 N/cm, the wall thickness of the outer sleeve 51 is 3 mm. Then the corresponding spring constant becomes the same as that of the rubber roll of the same shape. The width k of the nip between the outer sleeve 51 and cooling roll in the direction of roll rotation is about 9 mm. This gives a value approximately close to the nip width of this rubber roll is about 12 mm, showing that pressure can be applied under the similar conditions. The amount of deflection in the nip width k is about 0.05 through 0.1 mm.

Here, t/r≦0.03 is assumed. In the case of the general roll diameter R=200 through 500 mm, sufficient flexibility is obtained if 2 mm≦t≦5 mm in particular. Thickness can be easily reduced by machining. Thus, this is very practical range.

The equivalent value of this 2 mm≦t≦5 mm can be expressed by 0.008≦t/r≦0.05 for the general roll diameter. In practice, under the conditions of t/r≈0.03, wall thickness is preferably increased in proportion to the roll diameter. For example, selection is made within the range of t=2 through 3 mm for the roll diameter: R=200; and t=4 through 5 mm for the roll diameter: R=500.

These touch rolls A and B are energized toward the first cooling roll by the energizing section (not illustrated). The F/W (linear pressure) obtained by dividing the energizing force F of the energizing section by the width W of the film in the nip along the rotary shaft of the first cooling roll 5 is set at 10 N/cm through 150 N/cm. According to the present embodiment, a nip is formed between the touch rolls A and B, and the first cooling roll 5. Flatness should be corrected while the film passes through this nip. Thus, as compared to the cases where the touch roll is made of a rigid body, and no nip is formed between the touch roll and the first cooling roll, the film is sandwiched and pressed at a smaller linear pressure for a longer time. This arrangement ensures more reliable correction of flatness. To be more specific, if the linear pressure is smaller than 10 N/cm, the die line cannot be removed sufficiently. Conversely, if the linear pressure is greater than 150 N/cm, the film cannot easily pass through the nip. This will cause uneven thickness of the film.

The surfaces of the touch rolls A and B are made of metal. This provides smooth surfaces of the touch rolls A and B, as compared to the case where touch rolls have rubber surfaces. The elastic body 44 of the elastic roller 42 can be made of ethylene propylene rubber, neoprene rubber, silicone rubber or the like.

To ensure that the die line is removed sufficiently by the touch roll 6, it is important that the film viscosity should lie within the appropriate range when the film is sandwiched and pressed by the touch roll 6. Further, cellulose ester is known to be affected by temperature to a comparatively high degree. Thus, to set the viscosity within an appropriate range when the cellulose ester optical film is sandwiched and pressed by the touch roll 6, it is important to set the film temperature within an appropriate range when the cellulose ester optical film is sandwiched and pressed by the touch roll 6. When the glass-transition temperature of the cellulose ester optical film is assumed as Tg, the temperature T of the film immediately before the film is sandwiched and pressed by the touch roll 6 is preferably set in such a way that Tg<T<Tg+110° C. can be met. If the film temperature T is lower than Tg, the viscosity of the film will be too high to correct the die line. Conversely, if the film temperature T is higher than Tg+110° C., uniform adhesion between the film surface and roll cannot be achieved, and the die line cannot be corrected. This temperature is preferably Tg+10° C.<T<Tg+90° C., more preferably Tg+20° C.<T<Tg+70° C. To set the film temperature within the appropriate range when the cellulose film is sandwiched and pressed by the touch roll 6, one has only to adjust the length L of the nip between the first cooling roll 5 and touch roll 6 along the rotating direction of the first cooling roll 5, from the position P1 wherein the melt pressed out of the flow casting die 4 comes in contact with the first cooling roll 5. Alternatively, to set the surface temperature of the touch roll 6, the first cooling roll 5, the second cooling roll 7 and the third cooling roll 8 each within the appropriate range. The surface temperature of the touch roll 6 and the first cooling roll 5 is generally preerable in the range of 60-230° C., more preferably 100-150° C. he surface temperature of the second cooling roll 7 is generally preerable in the range of 30-150° C., more preferably 60-130° C.

In the present invention, the material preferably used for the first roll 5 and second roll 6 is exemplified by carbon steel, stainless steel and resin, The surface accuracy is preferably set at a higher level. In terms of surface roughness, it is preferably set to 0.3 S or less, more preferably 0.01 S or less.

The inventor found that when the portion from the opening (lip) of the flow casting die 4 to the first roll 5 is reduced to 70 kPa Pr less, the die line can be correct effectively. Pressure reduction is preferably 50 through 70 kPa. There is no restriction to the method of ensuring that the pressure in the portion from the opening (lip) of the flow casting die 4 to the first roll 5 is kept at 70 kPa or less. One of the methods is to reduce the pressure by using a pressure-resistant member to cover the portion from the flow casting die 4 to the periphery of the roll. In this case, the vacuum suction machine is preferably heated by a heater or the like to ensure that a sublimate will be deposited on the vacuum suction machine. In the present invention, if the suction pressure is too small, the sublimate cannot be sucked effectively. To prevent this, adequate suction pressure must be utilized.

In the present invention, the film-like cellulose ester based resin in the molten state from the T-die 4 is conveyed in contact with the first roll (the first cooling roll) 5, second cooling roll 7, and third cooling roll 8 sequentially, and is cooled and solidified, whereby an unoriented cellulose ester based resin film 10 is produced.

In the embodiment of the present invention shown in FIG. 1, the unoriented film 1 cooled, solidified and separated from the third cooling roll 8 by the separation roll 9 is passed through a dancer roll (film tension adjusting roll) 11, and is led to the stretching machine 12, wherein the film 10 is stretched in the lateral direction (across the width). This stretching operation orients the molecules in the film.

A known tender or the like can be preferably used to draw the film across the width. Especially when the film is stretched across the width, the lamination with the polarized film can be preferably realized in the form of a roll. The stretching across the width ensures that the low axis of the cellulose ester film made up of a cellulose ester based resin film is found across the width.

In the meantime, the transmission axis of the polarized film also lies across the width normally. If the polarizing plate wherein the transmission axis of the polarized film and the low axis of the optical film will be parallel to each other is incorporated in the liquid crystal display apparatus, the display contrast of the liquid crystal display apparatus can be increased and an excellent angle of view field is obtained.

The glass transition temperature Tg of the film constituting material can be controlled when the types of the materials constituting the film and the proportion of the constituent materials are made different. When the phase difference film is manufactured as a cellulose ester optical film, Tg is 110° C. or more, preferably 125 CC or more, In the liquid crystal display apparatus, the film temperature environment is changed in the image display mode by the temperature rise of the apparatus per se, for example, by the temperature rise caused by a light source. In this case, if the Tg of the film is lower than the film working environment temperature, a big change will occur to the retardation value and film geometry resulting from the orientation status of the molecules fixed in the film by stretching. If the Tg of the film is too high, temperature is raised when the film constituting material is formed into a film. This will increase the amount of energy consumed for heating. Further, the material may be decomposed at the time of forming a film, and this may cause coloring. Thus, Tg is preferably kept at 250° C. or less.

The process of cooling and relaxation under a known thermal setting condition can be applied in the stretching process. Appropriate adjustment should be made to obtain the characteristics required for the intended optical film.

The aforementioned stretching process and thermal setting process are applied as appropriate on a selective basis to provide the phase difference film function for the purpose of improving the physical properties of the phase difference film and to increase the angle of field in the liquid crystal display apparatus. When such a stretching process and thermal setting process are included, the heating and pressing process should be performed prior to the stretching process and thermal setting process.

When a phase difference film is produced as a cellulose ester optical film, and the functions of the polarizing plate protective film are combined, control of the refractive index is essential. The refractive index control can be provided by the process of stretching. The process of stretching is preferred. The following describes the method for stretching:

As stretching, stretching in the longitudinal direction, stretching in the transverse direction or stretching in longitudinal and transverse directions is carried out. The longitudinal stretching can be carried out by roll stretching (stretching in the mechanical direction employing two or more pairs of nip rolls on the outlet side which increases the rotational speed) or fixed end stretching (which gradually increase a transporting speed in the mechanical direction, while holding both ends of the film). The stretching in the transverse direction can be carried out by tenter stretching (stretching the film in the transverse direction (in the direction perpendicular to the mechanical direction) while holding both ends of the film by a chuck.

The stretching in the longitudinal direction and the stretching in the transverse direction may be carried out alone, respectively, or may be carried out in combination (biaxial stretching). When the biaxial stretching is carried out, the stretching in the longitudinal direction and the stretching in the transverse direction may be carried out successively (successive stretching) or simultaneously (simultaneous stretching). The stretching speed in the in the longitudinal direction and in the transverse direction is preferably from 10 to 10000%/minute, more preferably from 20 to 1000%/minute, and still more preferably from 30 to 800%/minute. When a multistep stretching is carried out, the stretching speed implies an average of the stretching speed at each stage. It is preferred that the stretching is followed by relaxing in the longitudinal or transverse direction by 0 to 10%. Further, it is also preferred that the stretching is preferably followed by heat fixed at 150 to 250° C. for 1 second to 3 minutes.

In the phase difference film stretching process, required retardations Ro and Rt can be controlled by a stretching at a magnification of 1.0 through 4.0 times in one direction of the cellulose resin, and at a magnification of 1.01 through 4.0 times in the direction perpendicular to the inner surface of the film. Here Ro denotes an in-plane retardation. It is obtained by multiplying the thickness by the difference between the refractive index in the longitudinal direction MD in the same plane and that across the width TD. Rt denotes the retardation along the thickness, and is obtained by multiplying the thickness by the difference between the refractive index (an average of the values in the longitudinal direction MD and across the width TD) in the same plane and that along the thickness.

Stretching can be performed sequentially or simultaneously, for example, in the longitudinal direction of the film and in the direction perpendicular thereto in the same plane of the film, namely, across the width. In this case, if the stretching magnification at least in one direction is insufficient, sufficient retardation cannot be obtained. If it is excessive, stretching difficulties may occur and the film may break.

Stretching in the biaxial directions perpendicular to each other is an effectively way for keeping the film refractive indexes ax, ny and nz within a predetermined range. Here nx denotes a refractive index in the longitudinal direction MD, ny indicates that across the width TD, and nz represents that along the thickness.

When the material is stretched in the melt-casting direction, the nz value will be excessive if there is excessive shrinkage across the width. This can be improved by controlling the shrinkage of the film across the width or by stretching across the width. In the case of stretching across the width, distribution may occur to the refractive index across the width. This distribution may appear when a tenter method is utilized. Stretching of the film across the width causes shrinkage force to appear at the center of the film because the ends are fixed in position, This is considered to be what is called “bowing”. In this case, bowing can be controlled by stretching in the casting direction, and the distribution of the retardation across the width can be reduced.

Stretching in the biaxial directions perpendicular to each other reduces the fluctuation in the thickness of the obtained film. Excessive fluctuation in the thickness of the phase difference film will cause irregularity in retardation. When used for liquid crystal display, irregularity in coloring or the like will occur.

The fluctuation in the thickness of the cellulose resin film is preferably kept within the range of ±3%, preferably ±1%. To achieve the aforementioned object, it is effective to use the method of stretching in the biaxial directions perpendicular to each other. The magnification rate of stretching in the biaxial directions perpendicular to each other is preferably 1.0 through 4.0 times in the casting direction, and 1.01 through 4.0 times across the width. Stretching in the range of 1.0 through 1.5 times in the casting direction and in the range of 1.05 through 2.0 times across the width will be more preferred to get a retardation value.

When the absorption axis of the polarizer is present in the longitudinal direction, matching of the transmission axis of the polarizer is found across the width. To get a longer polarizing plate, the phase difference film is preferably stretched so as to get a low axis across the width.

When using the cellulose resin to get positive double refraction with respect to stress, stretching across the width will provide the low axis of the phase difference film across the width because of the aforementioned arrangement. In this case, to improve display quality, the low axis of the phase difference film is preferably located across the width. To get the target retardation value, it is necessary to meet the following condition:

(stretching magnification across the width)>(stretching magnification in casting direction)

After stretching, the end of the film is trimmed off by a slitter 13 to a width predetermined for the product. Then both ends of the film are knurled (embossed) by a knurling apparatus made up of an emboss ring 14 and back roll 15, and the film is wound by a winder 16. This arrangement prevents sticking in the cellulose ester film F (master winding) or scratch. Knurling can be provided by heating and pressing a metallic ring having a pattern of projections and depressions on the lateral surface. The gripping portions of the clips on both ends of the film are normally deformed and cannot be used as a film product. They are therefore cut out and are recycled as a material.

In the melt extrusion method, the retention time at the edge portion of the flow casting die becomes longer and results in promote the coloring of the film edge due to the shape of the flow casting die. However to apply the method for producing the film of the present invention, the coloring of the film edge can be prevented. According to the invention, the yellow index Ye of the edge portion and the yellow index Yc of the center portion of film width just after melt extrusion preferably satisfy Equation (4) below. More preferably Ye/Yc is 3.0 or less. When Ye/Yc exceed 5.0, the coloring of the film increases because both clipped edges of the film are cut out and recycled as a material. In the present invention, the yellow index Ye of the edge portion is defined as the maximum value within 30-mm from both clipped edges of the film.

1.0≦Te/Yc≦5.0 Equation (4)

When the phase difference film is used as a polarizing plate protective film, the thickness of this protective film is preferably 10 through 500 μm. The lower limit is 20 μm or more, preferably 30 μm or more. The upper limit is 150 μm or less, preferably 120 μm or less. The particularly preferred range is 25 μm or more without exceeding 90 μm. If the phase difference film is too thick, the polarizing plate subsequent to processing of the polarizing plate will be too thick. This is not suited for the low-profile, light weight configuration required in the liquid crystal display used in a notebook PC or mobile electronic equipment. In the meantime, if the phase difference film is too thin, difficulties will be involved in the retardation as a phase difference film will be difficult. This will further result in higher film moisture permeability, and lower capacity in protecting the polarizer against humidity.

Assuming that the low axis or high axis of the phase difference film is present in the plane of the film, and the angle formed with respect to film making direction is θ1, then θ1 is −1 degrees or more without exceeding +1 degrees, preferably −0.5 degrees or more without exceeding +0.5 degrees.

The θ1 can be defined as an orientation angle, and θ1 can be measured with automatic double refractometer COBRA-21ADH (made by Oji Scientific Instruments).

When the θ1 meets the aforementioned relation, luminance is increased on the display image and leakage of light is reduced or prevented, whereby faithful color reproduction in a color liquid crystal display apparatus is ensured.

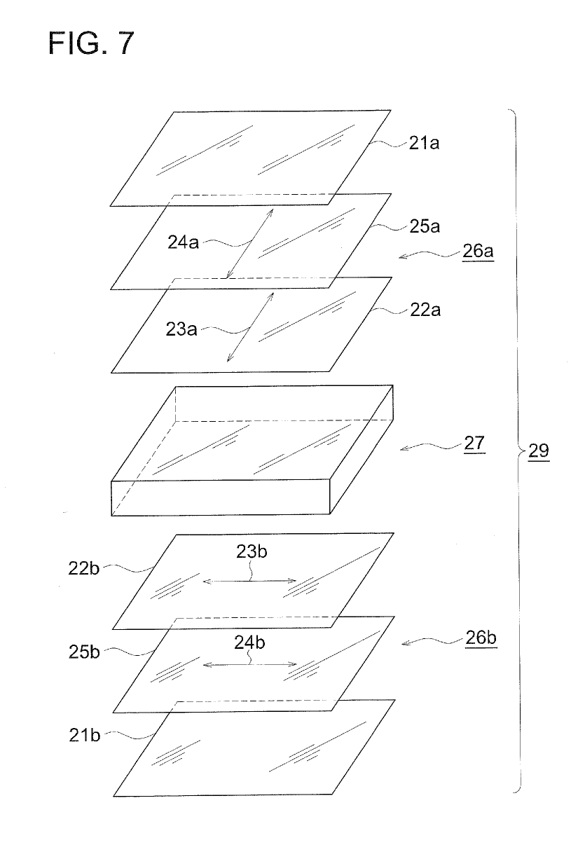

When the phase difference film in the present invention is used in the VA mode subjected to the configuration of multi-domain, the phase difference film is arranged in the aforementioned area with the high axis of phase difference film being θ1. This arrangement improves the display quality, and permits the structure of FIG. 7 to be implemented, when placed in the MVA mode as a polarizing plate and liquid crystal display apparatus.

In FIG. 7, the reference numerals 21a and 21b indicate protective films, the 22a and 22b shows phase difference films, the 25a and 25b represent the polarizers, the 23a and 23b show the low axis direction of the film, the 24a and 24b denote the direction of the transmission axis of polarizer, the 26a and 26b indicate polarizing plates, the 27 denotes a liquid crystal cell, and the 29 indicates a liquid crystal display apparatus.

The retardation Ro distribution in the in-plane direction of the optical film is adjusted to preferably 5% or less, more preferably 2% or less, still more preferably 1.5% or less. Further, the retardation Rt distribution across the thickness of the film is adjusted to preferably 10% or less, more preferably 2.0% or less, still more preferably 1.5% or less.

In the phase difference film, the distribution in the fluctuation of retardation value is preferably smaller. When a polarizing plate containing a phase difference film is used in a liquid crystal display apparatus, it is preferred that the distribution in the fluctuation of retardation should be small for the purpose of avoiding color irregularity.

In order to adjust the phase difference film so as to set the retardation value suited for improvement of the display quality of the liquid crystal cell in the VA or TN mode, and especially to ensure that the VA mode is divided into the aforementioned multi-domains so as to be preferably used in the MVA mode, it is required to make adjustment so that the in-plane retardation Ro should be greater than 30 nm without exceeding 95 nm, and the retardation Rt across the thickness should be greater than 70 nm without exceeding 400 nm.

When in the state of crossed-Nicols as observed in the direction normal to the display surface when two polarizing plates are positioned in a crossed-Nicols arrangement and a liquid crystal cell is placed between the polarizing plates, for example, as shown in FIG. 7, the crossed-Nicols state of the polarizing plate is deviated when observed in the direction normal to the display surface, and the leakage of light caused thereby is mainly corrected by the aforementioned in-plane retardation Ro. The retardation across the thickness mainly corrects the double refraction of the liquid crystal cell observed as viewed obliquely in the same manner when the liquid crystal cell is in the black display mode in the aforementioned TN and VA modes, especially in the MVA mode.

When two polarizing plates are placed above and below the liquid crystal cell in the liquid crystal display apparatus as shown in FIG. 7a the 22a and 22b in the drawing are capable of selecting the distribution of the retardation Rt across the thickness. It is preferred that the requirements of the aforementioned range should be satisfied, and that the total of both retardations Rt across the thickness should be preferably greater than 140 nm without exceeding 500 nm. Here, the in-plane retardation Ro of the 22a and 22b and retardations Rt across the thickness are the same are preferred to be the same in both cases for the purpose of improving the industrial productivity of the polarizing plate. It is particularly preferred that the in-plane retardation Ro should be greater than 35 nm without exceeding 65 nm and the retardation Rt across the thickness should be greater than 90 nm without exceeding 180 nm, wherein they should be applicable to the liquid crystal cell in the MVA mode in FIG. 7.

In the liquid crystal display apparatus, when a TAC film having a thickness of 35 through 85 μm with the in-plane retardation Ro=0 through 4 nm and retardation Rt across the thickness=20 through 50 nm, for example, as a commercially available polarizing plate protective film is used, for example, at the position 22b shown in FIG. 7 on one of the polarizing plates, the polarized film arranged on the other polarizing plate, for example, the phase difference film arranged at 22a in FIG. 7 to be used is preferred to have an in-plane retardation Ro greater than 30 nm without exceeding 95 nm and a retardation Rt across the thickness greater than 140 nm without exceeding 400 nm. This is advantageous for the improvement of display quality and film production.

(Polarization Plate)

The polarization of the invention is described below.

The polarization plate can be produced by a usual method. It is preferable that the back surface of the cellulose ester optical film is subjected to an alkaline saponification treatment, and the treated film is pasted using a completely saponified poly(vinyl alcohol) solution onto at least one surface of a polarization membrane which is prepared by immersing into an iodine solution and extending. On the other surface of the polarization membrane, the cellulose ester optical film or another polarization protection film may be used. Cellulose films available on the market can be used as the polarization plate protection film to be used on the side reverse to the side on which the cellulose ester optical film of the invention is provided. For example, cellulose ester films available on the market such as KC8UX2M, KC4UX, KC5UX, KC4UY, KC8UY, KC12UR, KC8UCR3 and KC8UCR-4, each manufactured by Konica Minolta Opt Products Co., Ltd., are preferably usable. A polarization plate protection film simultaneously having the optical compensation ability which has an optical anisotropic layer prepared by orientating a liquid crystal compound such as discotic liquid crystal, rod-shaped liquid crystal and cholesteric liquid crystal is also preferably usable. The optical anisotropic layer can be formed by the method described in JP-A No. 2003-98348. The polarization plate having excellent flatness and stable visible field angle expanding effect can be obtained by using such the film together with the anti-reflection film of the invention.

The polarization membrane as the principal member of the polarization plate is an element capable of passing only light having a certain polarized plane. Presently known typical polarization membrane is a poly(vinyl alcohol) type polarization film which include a poly(vinyl alcohol) film dyed by iodine and that dyed by a dichromatic dye. A film is used as the polarization membrane, which is prepared by forming a film from a poly(vinyl alcohol) aqueous solution, and the film is mono-axially extended and dyed, or dyed and mono-axially extended, and then subjected to a durability providing treatment by a boron compound. One side of the cellulose ester optical film of the invention is pasted on to the polarization membrane to prepare the polarization plate. The film is preferably pasted by an aqueous type adhesive principally composed of completely saponified poly(vinyl alcohol).

The polarization membrane shrinks in the extended direction (usually length direction) and expands in the direction making a right angle with the extended direction (usually width direction) when the film is placed under high temperature and moisture conditions since the film is extended in a mono-axial direction. The expanding-shrinking ratio is increased accompanied with decreasing in the thickness of the film and the shrinkage in the extending direction is particularly large. It is important to inhibit the expanding-shrinking ratio in the casting direction (MD direction) when the film is made thinner because the polarization plate is pasted with the polarization plate protection film so that the stretching direction of the polarization plate is agreed with the casting direction of the protection film. The optical film of the invention is suitably used as such the polarization plate protection film since the optical film is excellent in the dimensional stability.

Wave-shaped unevenness is not caused after a durability test under conditions of 60° C. and 90% RH and good visibility can be obtained after the durability test even when the polarization plate has an optical compensation film on the back side thereof.

The polarization plate further can be constituted by pasting the protect film onto one side of the polarization plate and a separation film onto another side of the polarization plate. The protection film and the separate film are used for protecting the polarization plate on the occasion of forwarding and inspection of the products. In such the case, the protection film is pasted for protecting the surface of the polarizing plate onto the side reverse to the side on which the polarization plate is pasted with the liquid crystal plate. The separation film is used for covering the adhesion layer to be pasted to the liquid crystal plate and pasted on the side on which the polarization plate is pasted with the liquid crystal plate

(Liquid Crystal Display Apparatus)

The polarizing plate including the phase difference film of the present invention provides higher display quality than a normal polarizing plate, and is suited for application particularly to the multi-domain liquid crystal display apparatus, more preferably to the multi-domain liquid crystal display apparatus due to the double refraction mode.

The polarizing plate of the present invention can be used in the MVA (Multi-domain Vertical Alignment) PVA (Patterned Vertical Alignment) mode, CPA (Continuous Pinwheel Alignment) mode and OCB (Optical Compensated Bend) mode, without the present invention being restricted to a particular liquid crystal mode or particular arrangement of the polarizing plate.

The liquid crystal display apparatus is coming into use as an apparatus for the display of colored and moving images. The display quality, contrast and resistance of the polarizing plate enhanced by the present invention provides a faithful display of moving images without imposing loads on user's eyes.

In a liquid crystal display apparatus equipped with a polarizing plate including the phase difference film of the present invention, one polarizing plate including the phase difference film of the present invention is arranged for the liquid crystal cell or two polarizing plates are arranged on both sides of the liquid crystal cell. The display quality can be improved if used in such a way that the side of the phase difference film of the present invention contained in the polarizing plate faces the liquid crystal cell of the liquid crystal display apparatus. In FIG. 7, the films 22a and 22b face the liquid crystal cell of the liquid crystal display apparatus.

In this structure, the phase difference film of the present invention optically corrects the liquid crystal cell. When the polarizing plate of the present invention is used in a liquid crystal display apparatus, at least one of the polarizing plates used in the liquid crystal display apparatus is the polarizing plate of the present invention. This structure provides a liquid crystal display apparatus characterized by improved display quality and viewing angle properties.

In the polarizing plate of the present invention, the polarizing plate protective film as the cellulose derivative is used on the side opposite the phase difference film as viewed from the polarizer. A general-purpose TAC film and others can be used. To improve the quantity of the display apparatus, the polarizing plate protective film located far away from the liquid crystal cell can also be provided with other functional layers.

For example, to protect against reflection, glare, damage and deposition of dust and to enhance luminance, a conventionally known functional layer for a display can be laminated on the film as a component or the polarizing plate layer of the present invention, without the present invention being restricted thereto.

Generally, in the phase difference film the fluctuation of the Ro or Rth as the aforementioned retardation value is required to be smaller for the purpose of ensuring stable optical characteristics. The aforementioned fluctuation may cause image irregularity especially in the liquid crystal display apparatus of the double refraction mode.

The longer phase difference film formed by the melts casting film formation technique according to the present invention is mainly made up of a cellulose resin, and therefore, saponification inherent to the cellulose resin can be utilized in the process of alkaline treatment. When the resin constituting the polarizer is polyvinyl alcohol, a solution of fully saponified polyvinyl alcohol can be used for lamination with the phase difference film of the present invention, similarly to the case of the conventional polarizing plate protective film. Thus, the present invention is superior in that the conventional polarizing plate processing method can be used and a longer roll polarizing plate in particular can be manufactured.

The manufacturing advantages provided by the present invention are noteworthy especially in a long product measuring 100 meters or more. The advantages in manufacturing the polarizing plate increase with the length of the product, as the length increases, for example, to 1500 m, 2500 m, 5000 m and so on.

In the production of a phase difference film, for example, the roll length is 10 m or more without exceeding 5000 m, more preferably 50 m or more without exceeding 4500 m when consideration is given to productivity and transportability. The film with in this case can be selected to suit the polarizer width and production line requirements. It is possible to make such arrangements that a fill is manufactured with a width of 0.5 m or more without exceeding 4.0 m, preferably 0.6 m or more without exceeding 3.0 m, and is wound in a roll to be processed into a polarizing plate Alternatively, it is also possible to manufacture a film having a width more than twice the intended width which is wound in a roll, whereby a roll having the intended width is obtained. This roll is then processed into a polarizing plate.

At the time of manufacturing the cellulose ester optical film of the present invention, such a functional layer as an antistatic layer, hard coated layer, lubricating layer, adhesive layer, antiglare layer or barrier layer can be coated before and/or after drawing. In this case, various forms of surface treatment such as corona discharging, plasma treatment and medical fluid treatment can be provided wherever required.

In the film manufacturing process, the clip holding section on both ends of the film having been cut is pulverized or is used for granulating wherever required. After that, it can be reused as the material of the same type of film or as the material of a different type of film.

The compositions including the cellulose resin with additives having different concentration such as the aforementioned plasticizer, ultraviolet absorber, and matting agent can be extruded together to manufacture the optical film of lamination structure. For example, it is possible to manufacture an optical film having a structure of a skin layer/core layer/skin layer. For example, a large amount of matting agent can be put into the skin layer, or the matting agent can be put into the skin layer alone. A greater amount of plasticizer and ultraviolet absorber can be put into the core layer than into the skin layer. Alternatively, they can be put into the core layer alone. Further, different types of the plasticizer and ultraviolet absorber can be put into the core layer and skin layer. For example, the skin layer can be impregnated with a plasticizer and/or ultraviolet absorber of low volatility, and the core layer can be impregnated with the plasticizer of excellent plasticity, or with an ultraviolet absorber of superb ultraviolet absorbency. The glass transition temperature of the skin layer can be different from that of the core layer. The glass transition temperature of the core layer is preferably lower than that of the skin layer. In this case, the glass transition temperatures of the scanning and core layers are measured and the average value calculated from these volume fractions can be defined as the aforementioned glass transition temperature Tg, whereby the same procedure is used for handling Further, the viscosity of the melt including the cellulose ester at the time of melt casting can be different between the skin layer and core layer. The viscosity of the skin layer can be greater than that of the core layer, or the viscosity of the core layer can be equal to or greater than that of the skin layer.

The dimensional stability of the cellulose ester film of the present invention is such that, when the dimensions of the film having been left to stand at a temperature of 23° C. with a relative humidity of 55% RH for 24 hours are used as standard, the fluctuation of the dimensions at a temperature of 80° C. with a relative humidity of 90% RH is within ±2.0%, preferably less than 1.0%, more preferably less than 0.5%.

When the cellulose ester film of the present invention is a phase difference film, and is used as a protective film of the polarizing plate, a deviation will occur between the absolute value of the retardation as a polarizing plate and the initial setting of the orientation angle it the phase difference film exhibits a fluctuation exceeding the aforementioned range. This may impede the improvement in display quality or may cause deterioration of the display quality.

The phase difference film of the present invention can be used as a polarizing plate protective film. When used as a polarizing plate protective film, there is no particular restriction to the method of manufacturing the polarizing plate. It can be manufactured by common practice. For example, the phase difference film having been obtained is subjected to alkaline treatment, and the polyvinyl alcohol film is immersed in an iodine solution, wherein it is stretching. A polarizing plate protective film is laminated on both sides of the polarizer manufactured in this procedure, using the solution of fully saponifiable polyvinyl alcohol. On at least one side, the phase difference film as a polarizing plate protective film of the present invention directly bonded onto the polarizer

The polarizing plate can be manufactured by adhesion promoting treatment disclosed in JPIA Nos. H6-94915 and H6-118232, instead of the aforementioned alkaline treatment.

(Formation of Functional Layers)

During the production of the optical film of the present invention, prior to/after stretching, coated may be functional layers such as a transparent conductive layer, a hard coat layer, an antireflection layer, a lubricating layer, an adhesion aiding layer, a glare shielding layer, a barrier layer, or an optical compensating layer. Specifically, it is preferable to arrange at least one layer selected from the group consisting of a transparent conductive layer, an antireflection layer, an adhesion aiding layer, a glare shielding layer, and an optical compensating layer. In such a case, if desired, it is possible to conduct various surface treatments such as a corona discharge treatment, a plasma treatment, and a chemical treatment.

(Transparent Conductive Layer)

In the film of the present invention, it is preferable to provide a transparent conductive layer, employing surface active agents or minute conductive particles. The film itself may be made to be conductive or a transparent conductive layer may be provided. In order to provide antistatic properties, it is preferable to provide a transparent conductive layer. It is possible to provide the transparent conductive layer employing methods such as a coating method, an atmospheric pressure plasma treatment, vacuum deposition, sputtering, or an ion plating method. Alternatively, by employing a co-extrusion method, a transparent conductive layer is prepared by incorporating minute conductive particles into the surface layer or only into the interior layer. The transparent conductive layer may be provided on one side of the film or on both sides. Minute conductive particles may be employed together with matting agents resulting in lubrication or may be employed as a matting agent. As a conductive agent, metal oxide particles below having conductivity can be used.

Preferred as examples of metal oxides are ZnO, TiO₂, SnO₂, Al₂O₃, In₂O₃, SiO₂, MgO, BaO, MoO₂, and V₂O₅ or composite oxides thereof. Of these, ZnO, TiO₂, and SnO₂ are particularly preferred. As an example of incorporating a different type of atom, it is effective that Al and In are added to ZnO, Nb and Ta are added to TiO₂, or Sb, Nb and halogen elements are added to SnO₂. The addition amount of these different types of atoms is preferably in the range of 0.01-25 mol %, but is most preferably in the range of 0.1-15 mol %.

Further, the volume resistivity of these conductive metal oxide powders is preferably at most 1×10⁷ Ωcm, but most preferably at most 1×10⁵ Ωcm. It is preferable that powders exhibiting the specified structure at a primary particle diameter of 10 nm-0.2 μm, and a major diameter of higher order structure of 30 nm-6 μm is incorporated in the conductive layer at a volume ratio of 0.01-20%.

In the present invention, the transparent conductive layer may be formed in such a manner that minute conductive particles are dispersed into binders and provided on a substrate, or a substrate is subjected to a subbing treatment onto which minute conductive particles are applied.

Further, it is possible to incorporate the ionen conductive polymers represented by Formulas (I)-(V), described in paragraph 0038-0055 of JP-A No. 9-203810, and quaternary ammonium cationic polymers represented by Formula (1) or (2), described in paragraphs 0056-0145 of the above patent.

Further, to result in a matted surface and to improve layer quality, heat resistant agents, weather resistant agents, inorganic particles, water-soluble resins, and emulsions may be incorporated into the transparent conducive layer composed of metal oxides within the amount range which does not adversely affect the effects of the present invention.

Binders employed in the transparent conductive layer are not particularly limited as long as they exhibit film forming capability. Listed as binders may, for example, be proteins such as gelatin or casein; cellulose compounds such as carboxymethyl cellulose, hydroxyethyl cellulose, acetyl cellulose, diacetyl cellulose, or triacetyl cellulose; saccharides such as dextran, agar, sodium alginates, or starch derivatives; and synthetic polymers such as polyvinyl alcohol, polyvinyl acetate, polyacrylates, polymethacrylates, polystyrene, polyacrylamides, poly-N-vinylpyrrolidone, polyester, polyvinyl chloride, or polyacrylic acid.

Particularly preferred are gelatin (such as alkali process gelatin, acid process gelatin, oxygen decomposition gelatin, phthalated gelatin, or acetylated gelatin), acetyl cellulose, diacetyl cellulose, triacetyl cellulose, polyvinyl acetate, polyvinyl alcohol, butyl polyacrylate, polyacrylamide, and dextran.

(Antireflection Film)

It may be also preferable to make the cellulose ester optical film of the present invention an antireflection film by providing a hard coat layer and an antireflection layer on its surface.

As the hard coat layer, an active ray curable resin layer or a heat curable resin may be preferably employed. The hard coat layer may be coated directly on a support, or on another layer such as an antistatic layer and an undercoat layer.

In the case that the active ray curable resin layer is provided as the hard coat layer, the active ray curable resin layer preferably contains an active ray curable resin capable of being cured by the irradiation with light such as ultraviolet rays.

The hard coat layer preferably has a refractive index of 1.45 to 1.65 from a view point of an optical design. Further, from view points of durability and shock resistance to be provided to an antireflection film, also from view points of a proper flexibility and an economical efficiency at the time of production, the hard coat layer preferably has a thickness of from 1 μm to 20 μm, more preferably from 1 μm to 10 μm.

An active ray curable resin layer refers to a layer mainly comprising a resin which can be cured through a cross-linking reaction caused by irradiating with active rays such as UV rays or electron beams (in the present invention, “active rays” means that all of various electromagnetic waves such as electron beams, neutron beams, X-rays, alpha rays, ultraviolet rays, visible rays and infrared rays are defied as light). As the active ray curable resin, an ultraviolet ray (UV) curable resin and an electron beam curable resin are typically listed, however, a resin curable by the irradiation with light other than ultraviolet rays and electron beams. The UV curable resin includes, for example: a UV-curable acryl urethane type resin, a UV-curable polyester acrylate type resin, a UV-curable epoxy acrylate type resin, a UV-curable polyol acrylate type resin and a UV-curable epoxy type resin.

A UV-curable acryl urethane type resin, a UV-curable polyester acrylate type resin, a UV-curable epoxy acrylate type resin, a UV-curable polyol acrylate type resin and a UV-curable epoxy type resin may be listed.

Moreover, a photoreaction initiator and a photosensitizer may be contained. Concretely, for example: acetophenone, benzophenone, hydroxy benzophenone, Michler's ketone, α-amyloxim ester, thioxanthone, and their derivatives may be employed. Further, when a photoreaction agent is used for synthesizing an epoxy acylate type resin, sensitizers such as n-butyl amine, triethyl amine and tri-n-butyl phosphine can be utilized. The photoreaction initiator and the photosensitizer may be contained in an amount of 2.5% to 6% by weight in the UV curable resin composition except solvent components which volatilize after coating and drying.

Resin monomers include, for example, as a monomer having one unsaturated double bond, common monomers such as methyl acrylate, ethyl acrylate, butyl acrylate, vinyl acetate, benzyl acrylate, cyclohexyl acrylate, or styrene. Further, listed as monomers having at least two unsaturated double bonds may be ethylene glycol diacrylate, propylene glycol diacrylate, divinylbenzene, 1,4-cyclohexane diacrylate, and 1,4-cyclohexyldimethyl acrylate, as well as trimethylolpropane triacrylate and pentaerythritolpropane acrylate, described above.

Moreover, an ultraviolet absorber may be contained in an ultraviolet curable resin composition to such an extent that active ray curing of the ultraviolet curable resin composition is not disturbed. As the ultraviolet absorber, one similar to an ultraviolet absorber which may be usable for the above substrate may be employed.

In order to enhance the heat resistance of a cured layer, an antioxidant selected as a type which does not refrain an active ray curing reaction may be employed. For example, a hindered phenol derivative, a thio propionic acid derivative, a phosphite derivative, etc. may be listed. Concretely, 4,4′-thiobis (6-t-3-methyl phenol), 4,4′-butylidenebis(6-t-butyl-3-methyl phenol), 1,3,5-tris(3,5-di-t-butyl-4-hydroxybenzyl) isocyanurate, 2,4,6-tris(3,5-di-t-butyl-4-hydroxybenzyl) mesitylene and di-octadecyl-4-hydroxy-3,5-di-t-butyl benzyl phosphate etc. may be listed.

The UV curable resins available on the market utilized in the present invention include Adekaoptomer KR, BY Series such as KR-400, KR-410, KR-550, KR-566, KR-567 and BY-320B (manufactured by Asahi Denka Co., Ltd.); Koeihard A-101-KK, A-101-WS, C-302, C-401-N, C-501, M-101, M-102, T-102, D-102, NS-101, FT-102Q8, MAG-1-P20, AG-106 and M-101-C (manufactured by Koei Kagaku Co., Ltd.); Seikabeam PHC221(S), PHC X-9(K-3), PHC2213, DP-10, DP-20, DP-30, P1000, P1100, P1200, P1300, P1400, P1500, P1600, SCR900 (manufactured by Dainichiseika Kogyo Co., Ltd.); KRM7033, KRM7039, KRM7130, KRM7131, UVECRYL29201 and UVECRYL29202 (manufactured by Daicel U. C. B. Co., Ltd.); RC-5015, RC-5016, RC-5020, RC-5031, RC-S105, RC-5102, RC-5120, RC-5122, RC-5152, RC-5171r RC-5180 and RC-5181 (manufactured by Dainippon Ink & Chemicals, Inc.); Olex No. 340 Clear (manufactured by Chyugoku Toryo Co., Ltd.); Sunrad H-601, (manufactured by Sanyo Kaseikogyo Co., Ltd.); SP-1509 and SP-1507 (manufactured by Syowa Kobunshi Co., Ltd.); RCC-15C (manufactured by Grace Japan Co., Ltd.) and Aronix M-6100, M-8030 and M-8060 (manufactured by Toagosei Co., Ltd.).

The coating composition of the active ray layer preferably has a solid component concentration of from 10% to 95% by weight, and a proper concentration may be selected in accordance with a coating method.

A light source to cure layers of the active ray curable resin layer by a photo-curing reaction is not specifically limited, and any light source may be used as far as UV ray is generated. Concretely, a light source to emit light described above item with regard to light. An irradiating condition may change depending on a lamp. However, the preferable irradiation quantity of light is preferably from 20 mJ/cm² to 10000 mJ/cm², and more preferably from 50 to 2000 mJ/cm². In a range from a near ultraviolet ray range to a visible ray region, it may be preferable to use a sensitizer having an absorption maximum for the range.

An organic solvent at a time of coating the active ray curable resin layer can be selected properly from organic solvents, for example: hydrocarbon series (toluene, xylene), alcohol series (methanol, ethanol, isopropanol, butanol and cyclohexanol), ketone series (acetone, methyl ethyl ketone and isobutyl ketone), ester series (methyl acetate, ethyl acetate and methyl lactate), glycol ether series and other organic solvents, or these organic solvents may be also used in combinations as the organic solvent. The above mentioned organic preferably contains propyleneglycol monoalkylether (with an alkyl group having 1 to 4 carbon atoms) or propyleneglycol monoalkylether acetate ester (with an alkyl group having 1 to 4 carbon atoms) with a content of 5% by weight or more, and more preferably from 5 to 80% by weight.

As a coating method of the coating liquid of the active ray curable resin composition, well-known methods such as a gravure coater, a spinner coater, a wire bar coater, a roll coater, a reverse coater, an extrusion coater and an air doctor coater. A coating amount is preferably 0.1 μm to 30 μm as a wet layer thickness, more preferably 0.5 μm to 15 μm. A coating speed is preferably in a range of 10 m/minute to 60 m/minute.

After the active ray curable resin composition is coated and dried, it is irradiated with ultraviolet rays. At this time, the irradiation time is preferably 0.5 seconds to 5 minutes. From view points of curing efficiency of an ultraviolet ray curable resin and working efficiency, it is preferably 3 seconds to 2 minutes.

Thus, it is possible to obtain a cured coating layer. In order to provide glare shielding properties with the panel surface of liquid crystal display devices, to minimize adhesion to other substances, and to enhance abrasion resistance, it is possible to incorporate minute inorganic or organic particles into the curable layer coating composition.

For example, listed as minute inorganic particles may be those composed of silicon oxide, zirconium oxide, titanium oxide, aluminum oxide, tin oxide, zinc oxide, calcium carbonate, barium sulfate, talc, kaolin, and calcium sulfate.

Further listed as minute organic particles may be poly-methacrylic acid methyl acrylate resin powder, acryl styrene based resinous powder, polymethyl methacrylate resinous powder, silicone based resinous powder, polystyrene based resinous powder, polycarbonate resinous powder, benzoguanamine based resinous powder, melamine based resinous powder, polyolefin based resinous powder, polyester based resinous powder, polyamide based resinous powder, polyimide based resinous powder, or fluorinated ethylene based resinous powder. It is possible to incorporate these into ultraviolet radiation curable resinous compositions and then to employ them. The average particle diameter of these minute particle powders is commonly 0.01-10 μm. The used amount is preferably 0.1-20 parts by weight with respect to 100 parts by weight of the ultraviolet radiation curable resin composition. In order to provide glare shielding properties, it is preferable that minute practices of an average particle diameter of 0.1-1 μm are employed in an amount of 1-15 parts by weight with respect to 100 pars by weight of the ultraviolet radiation curable resin composition.

By incorporating such minute particles into ultraviolet radiation curable resins, it is possible to form a glare shielding layer exhibiting the preferred unevenness of center line mean surface roughness Ra of 0.05-0.5 μm. Further, when the above minute particles are not incorporated into ultraviolet radiation curable resin compositions, it is possible to form a hard cost layer exhibiting the desired smooth surface of a center line means roughness Ra of less than 0.05 μm, but preferably 0.002-0.04 μm.

Other than these, as a material to result in a blocking prevention function, it is possible to employ microscopic particles of a volume average particle diameter of 0.005-0.1 mm which are the same components as above in an amount of 0.1-5 parts by weight with respect to 100 parts by weight of the resin composition.

An antireflection layer is provided on the above hard coatinging layer. The providing methods are not particularly limited, and a common coating method, a sputtering method, a deposition method, CVD (chemical vapor depositions method and an atmospheric pressure plasma method may be employed individually or in combination. In the present invention, it is particularly preferable to provide the antireflection layer employing a common coating method.

Listed as methods to form the antireflection layer via coating are a method in which metal oxide powder is dispersed into binder resins dissolved in solvents and the resulting dispersion is coated and subsequently dried, a method in which a polymer having a cross-linking structure is used as binder resin, and a method in which ethylenic unsaturated monomers and photopolymerization initiators are incorporated and a layer is formed via exposure to actinic radiation.

In the present invention, it is possible to provide an antireflection layer on the cellulose ester optical film provided with an ultraviolet radiation curable resinous layer. In order to decrease reflectance, it is preferable to form a low refractive index layer on the uppermost layer of optical film and then to provide between them a metal oxide layer which is a high refractive index layer, and further to provide a medium refractive index layer (being a metal oxide layer of which refractive index has been controlled by varying the metal oxide content, the ratio to the resinous binders, or the kind of metal). The refractive index of the high refractive index layer is preferably 1.55-2.30, but is more preferably 1157-2.20. The refractive index of the medium refractive index layer is controlled to the intermediate value between the refractive index (approximately 1.5) of cellulose ester film as a substrate and the refractive index of the high refractive index layer. The refractive index of the medium refractive index layer is preferably 1.55-1.80. The thickness of each layer is preferably 5 nm-0.5 μm, is more preferably 10 nm-0.3 μm, but is most preferably 30 nm-0.2 μm. The haze of the metal oxide layer is preferably at most 5%, is more preferably at most 3%, but is most preferably at most 1%. The strength of the metal oxide layer is preferably at least 3H in terms of pencil strength of 1 kg load, but is most preferably at least 4H. In cases in which the metal oxide layer is formed employing a coating method, it is preferable that minute inorganic particles and binder polymers are incorporated.

It is preferable that the medium and high refractive index layers in the present invention are formed in such a manner that a liquid coating composition incorporating monomers or oligomers of organic titanium compounds represented by Formula (T) below, or hydrolyzed products thereof are coated and subsequently dried, and the resulting refractive index is 1.55-2.5.

Ti(OR1)₄ Formula (T)

wherein R1 is an aliphatic hydrocarbon group having 1-8 carbon atoms, but is preferably an aliphatic hydrocarbon group having 1-4 carbon atoms. Further, in monomers or oligormers of organic titanium compounds or hydrolyzed products thereof, the alkoxide group undergoes hydrolysis to form a crosslinking structure via reaction such as —Ti—O—Ti, whereby a cured layer is formed.

Listed as preferred examples of monomers and oligomers of organic titanium compounds employed in the present invention are dimers-decamers of Ti(OCH₃)₄, Ti(OC₂₋₁₅)₄, Ti(O-n-C₃H₇)₄, Ti(O-i-C₃H₇)₄, Ti(O-n-C₄H₉)₄, and Ti(O-n-C₃H₇)₄, and diners-decamers of Ti(O-n-C₄H₉)₄. These may be employed individually or in combinations of at least two types. Of these, particularly preferred are dimers decamers of Ti(O-n-C₃H₁₇)₄, Ti(O-i-C₃H₇)₁, Ti(O-n-C₄H₉)₄, and Ti(O-n-C₃H₇)₄.

In the course of preparation of the medium and high refractive index layer liquid coating compositions in the present invention, it is preferable that the above organic titanium compounds are added to the solution into which water and organic solvents, described below, have been successively added. In cases in which water is added later, hydrolysis/polymerization is not uniformly performed, whereby cloudiness is generated or the layer strength is lowered. It is preferable that after adding water and organic solvents, the resulting mixture is vigorously stirred to enhance mixing and dissolution has been completed.

Further, an alternative method is employed. A preferred embodiment is that organic titanium compounds and organic solvents are blended, and the resulting mixed solution is added to the above solution which is prepared by stirring the mixture of water and organic solvents.

Further, the amount of water is preferably in the range of 0.25-3 mol per mol of the organic titanium compounds. When the amount of water is less than 0.25 mol, hydrolysis and polymerization are not sufficiently performed, whereby layer strength is lowered, while when it exceeds 3 mol, hydrolysis and polymerization are excessively performed, and coarse TiO₂ particles are formed to result in cloudiness. Accordingly, it is necessary to control the amount of water within the above range.

Further, the content of water is preferably less than 10% by weight with respect to the total liquid coating composition. When the content of water exceeds 10% by weight with respect to the total liquid coating composition, stability during standing of the liquid coating composition is degraded to result in cloudiness. Therefore, it is not preferable.

Organic solvents employed in the present invention are preferably water-compatible. Preferred as water-compatible solvents are, for example, alcohols (for example, methanol, ethanol, propanol, isopropanol, butanol, isobutanol, secondary butanol, tertiary butanol, pentanol, hexanol, cyclohexanol, and benzyl alcohol; polyhydric alcohols (for example, ethylene glycol, diethylene glycol, triethylene glycol, polyethylene glycol, propylene glycol, dipropylene glycol, polypropylene glycol, butylenes glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethlylene glycol monoethyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylfromamide, and N,N-dimethylacetarnide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); as well as urea, acetonitrile, and acetone. Of these, particularly preferred are alcohols, polyhydric alcohols, and polyhydric alcohol ethers. As noted above, the used amount of these organic solvents may be controlled so that the content of water is less than 10% by weight with respect to the total liquid coating composition by controlling the total used amount of water and the organic solvents.

The content of monomers and oligomers of organic titanium compounds employed in the present invention, as well as hydrolyzed products thereof is preferably 50.0-98.0% by weight with respect to solids incorporated in the liquid coating composition. The solid ratio is more preferably 50-90% by weight, but is still more preferably 55-90% by weight. Other than these, it is preferable to incorporate polymers of organic titanium compounds (which are subjected to hydrolysis followed by crosslinking) in a liquid coating composition, or to incorporate minute titanium oxide particles.

The high refractive index and medium refractive index layers in the present invention may incorporate metal oxide particles as minute particles and further may incorporate binder polymers.

In the above method of preparing liquid coating compositions, when hydrolyzed/polymerized organic titanium compounds and metal oxide particles are combined, both strongly adhere to each other, whereby it is possible to obtain a strong coating layer provided with hardness and uniform layer flexibility.

The refractive index of metal oxide particles employed in the high and medium refractive index layers is preferably 1.80-2.80, but is more preferably 1.90-2.80. The weight average diameter of the primary particle of metal oxide particles is preferably 1-150 nm, is more preferably 1-100 nm, but is most preferably 1-80 nm. The weight average diameter of metal oxide particles in the layer is preferably 1-200 nm, is more preferably 5-150 nm, is still more preferably 10-100 nm, but is most preferably 10-80 nm. An average particle diameter of metal oxide particles are determined employing electron microscope images by observing diameter of 200 particles selected at randum. The specific surface area of metal oxide particles is preferably 10-400 m²/g as a value determined employing the BET method, is more preferably 20-200 m²/g, but is most preferably 30-150 m²/g.

Examples of metal oxide particles are metal oxides incorporating at least one element selected from the group consisting of Ti, Zr, Sn, Sb, Cu, Fe, Mn, Pb, Cd, As, Cr, Hg, Zn, Al, Mg, Si, P, and S. Specifically listed are titanium dioxide, (for example, rutile, rutile/anatase mixed crystals, anatase, and amorphous structures), tin oxide, indium oxide, zinc oxide, and zirconium oxide. Of these, titanium oxide, tin oxide, and indium oxide are particularly preferred. Metal oxide particles are composed of these metals as a main component of oxides and are capable of incorporating other metals. Main component, as described herein, refers to the component of which content (in % by weight) is the maximum in the particle composing components. Listed as examples of other elements are Ti, Zr, Sn, Sb, Cu, Fe, Mn, Pb, Cd, As, Cr, Hg, Zn, Al, Mg, Si, P and S.

It is preferable that metal oxide particles are subjected to a surface treatment. It is possible to perform the surface treatment employing inorganic or organic compounds. Listed as examples of inorganic compounds used for the surface treatment are alumina, silica, zirconium oxide, and iron oxide. Of these, alumina and silica are preferred. Listed as examples of organic compounds used for the surface treatment are polyol, alkanolamine, stearic acid, silane coupling agents, and titanate coupling agents. Of these, silane coupling agents are most preferred.

Specific examples of silane coupling agents include methyltrimethoxysilane, methyltriethoxysilane, methyltrimethoxyethoxysilane, methyltriacetoxysilane, methyltributoxysilane, ethyltrimethoxysilane ethyltriethoxysilane, vinyltrimethoxysilane, vinyltriethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysllane, 3,3,3 trifluoropropyltrimethoxysilane, γ-glycidyloxypropyltrimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxypropyltrimethoxysilane, γ-methacryloyloxypropyltrimethoxysilane, γ-aminopropyltrnmethoxysilane, γ-aminopropyltriethoxysilane, γ-mercaptopropyltriethoxysilane, N-β-(aminoethyl)-γ-aminopropyltrimethoxysilane, and β-cyanoethyltriethoxysilane.

Further, examples of silane coupling agents having an alkyl group of 2-substitution for silicon include dimethyldimethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacetoxysilane, γ-acryloyloxypropylmethyldimethoxysilane, γ-acryloyloxypropylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylraethyldimethoxysilane, γ-aminopropyldiethoxysilane, methylvinyldimethoxysilane, and methylvinyldiethoxysilnae.

Of these, preferred are vinyltrimethoxysilane, vinyltriethoxysilane, vinylacetoxysilane, vinyltrimethoxethoxyysilane, γ-acryloyloxypropylmethoxysilane, and γ-methacryloyloxypropylmethoxysilane which have a double bond in the molecule, as well as γ-acryloyloxypropylmethyldimethoxysilane, γ-acryloyloxypropyldiethoxysilane, γ-methacryloyloxypropylmethyldimethoxysilane, γ-methacryloyloxypropylmethyldiethjoxysilane, methylvinyldimethoxysilane, and methylvinyldiethaoxysilane which have an alkyl group having 2-substitution to silicon. Of these, particularly preferred are γ-acryloyloxypropyltrimethoxysilane, γ-methacryloyloxypropyltrimethoxysilane, γ-acryloyloxypropylmethyldimethoxysilane, γ-b acryloyloxypropylmethyldiethoxysilane, γ-methacryloyloxypropylmethyldimethoxysilane, and γ-methacryloyloxypropylmethyldiethoxysilane.

At least two types of coupling agents may simultaneously be employed. In addition to the above silane coupling agents, other silane coupling agents may be employed. Listed as other silane coupling agents are alkyl esters of ortho-silicic acid (for example, methyl orthosilicate, ethyl orthosilicate, n-propyl orthosilicate, i-propyl orthosilicate, n-butyl orthosilicate, sec-butyl orthosilicate, and t-butyl orthosilicate) and hydrolyzed products thereof.

It is possible to practice a surface treatment employing coupling agents in such a manner that coupling agents are added to a minute particle dispersion and the resulting dispersion is allowed to stand at room temperature—60° C. for several hours—10 days. In order to promote the surface treatment reaction, added to the above dispersion may be inorganic acids (for example, sulfuric acid, hydrochloric acid, nitric acids chromic acid, hypochlorous acid, boric acid, orthosilicic acid, phosphoric acid, and carbonic acid), and organic acids (for example, acetic acid, polyacrylic acid, benzenesulfonic acid, phenol, and polyglutamic acid), or salts thereof (for example, metal salts and ammonium salts).

It is preferable that these coupling agents have been hydrolyzed employing water in a necessary amount. When the silane coupling agent is hydrolyzed, the resulting coupling agent easily react with the above organic titanium compounds and the surface of metal oxide particles, whereby a stronger layer is formed. Further, it is preferable to previously incorporate hydrolyzed silane coupling agents into a liquid coating composition. It is possible to use the water employed for hydrolysis to perform hydrolysis/polymerization of organic titanium compounds.

In the present invention, a treatment may be performed by combining at least two types of surface treatments. It is preferable that the shape of metal oxide particles is rice grain-shaped, spherical, cubic, spindle-shaped, or irregular. At least two types of metal oxide particles may be employed in the high refractive index layer and the medium refractive index layer.

The content of metal oxide particles in the high refractive index and medium refractive index layers is preferably 5-90 W by weight, is more preferably 10-85% by weight, but is still more preferably 20-80% by weight. In cases in which minute particles are incorporated, the ratio of monomers or oligomers of the above organic titanium compounds or hydrolyzed products thereof is commonly 1-50 m by weight with solids incorporated in the liquid coating composition, is preferably 1-40% by weight, but is more preferably 1-30% by weight.

The above metal oxide particles are dispersed into a medium and fed to liquid coasting compositions to form a high refractive index layer and a medium refractive index layer. Preferably employed as dispersion medium of metal oxide particles is a liquid at a boiling point of 60-170° C. Specific examples of dispersion media include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate and butyl formate), aliphatic hydrocarbons (for example, hexane and cyclohexanone), halogenated hydrocarbons (for example, methylene chloride, chloroform, and carbon tetrachloride), aromatic hydrocarbons (for example, benzene, toluene, and xylene), amides (for example, dimethylformamide, diethylacetamide, and n-methylpyrrolidone), ethers (for example, diethyl ether, dioxane, and tetrahydrofuran), and ether alcohols (for example, 1-methoxy-2-propanol). Of these, particularly preferred are toluene, xylene, methyl ethyl ketone, methyl isobutyl ketone, cyclohexane and butanol.

Further, it is possible to disperse metal oxide particles into a medium employing a homogenizer. Listed as examples of homogenizers are a sand grinder mill (for example, a bead mill with pins), a high speed impeller mill, a pebble mill, a roller mill, an attritor, and a colloid mill. Of these, particularly preferred are the sand grinder and the high speed impeller mill. Preliminary dispersion may be performed. Listed as examples which are used for the preliminary dispersion are a ball mill, a three-roller mill, a kneader, and an extruder.

It is preferable to employ polymers having a crosslinking structure (hereinafter referred to as a crosslinking polymer) as a binder polymer in the high refractive index and medium refractive index layers. Listed as examples of the crosslinking polymers are crosslinking products (hereinafter referred to as polyolefin) such as polymers having a saturated hydrocarbon chain such as polyolefin, polyether, polyurea, polyurethane, polyester, polyamine, polyamide, or melamine resins. Of these, crosslinking products of polyolefin, polyether, and polyurethane are preferred, crosslinking products of polyolefin and polyether are more preferred, and crosslinking products of polyolefin are most preferred. Further, it is more preferable that crosslinking polymers have an anionic group. The anionic group exhibits a function to maintain the dispersion state of minute inorganic particles and the crosslinking structure exhibits a function to strengthen layers by providing a polymer with layer forming capability. The above anionic group may directly bond to a polymer chain or may bond to a polymer chain via a linking group. However, it is preferable that the anionic group bonds to the main chain via a linking group as a side chain.

Listed as examples of the anionic group are a carboxylic acid group (carboxyl), a sulfonic acid group (sulfo), and phosphoric acid group (phosphono). Of these, preferred are the sulfonic acid group and the phosphoric acid group. Herein, the anionic group may be in the form of its salts. Cations which form salts with the anionic group are preferably alkali metal ions. Further, protons of the anionic group may be dissociated. The linking group which bond the anionic group with a polymer chain is preferably a bivalent group selected from the group consisting of —CO—, —O—, an alkylene group, and an arylene group, and combinations thereof. Crosslinking polymers which are binder polymers are preferably copolymers having repeating units having an anionic group and repeating units having a crosslinking structure. In this case, the ratio of the repeating units having an anionic group in copolymers is preferably 2-96% by weight, is more preferably 4-94% by weight, but is most preferably 6-92% by weight. The repeating unit may have at least two anionic groups.

In crosslinking polymers having an anionic group, other repeating units (an anionic group is also a repeating unit having no crosslinking structure) may be incorporated. Preferred as other repeating units are repeating units having an amino group or a quaternary ammonium group and repeating units having a benzene ring. The amino group or quaternary ammonium group exhibits a function to maintain a dispersion state of minute inorganic particles. The benzene ring exhibits a function to increase the refractive index of the high refractive index layer. Incidentally, even though the amino group, quaternary ammonium group and benzene ring are incorporated in the repeating units having an anionic group and the repeating units having a crosslinking structure, identical effects are achieved.

In crosslinking polymers incorporating as a constituting unit the above repeating units having an amino group or a quaternary ammonium group, the amino group or quaternary ammonium group may directly bond to a polymer chain or may bond to a polymer chain via a side chain. But the latter is preferred. The amino group or quaternary ammonium group is preferably a secondary amino group, a tertiary amino group or a quaternary ammonium group, but is more preferably a tertiary amino group or a quaternary ammonium group. A group bonded to the nitrogen atom of a secondary amino group, a tertiary amino group or a quaternary ammonium group is preferably an alkyl group, is more preferably an alkyl group having 1-12 carbon atoms, but is still more preferably an alkyl group having 1-6 carbon atoms. The counter ion of the quaternary ammonium group is preferably a halide ion. The linking group which links an amino group or a quaternary ammonium group with a polymer chain is preferably a bivalent group selected from the group consisting of —CO—, —NH—, —O—, an alkylene group and an arylene group, or combinations thereof. In cases in which the crosslinking polymers incorporate repeating units having an amino group or a quaternary ammonium group, the ratio is preferably 0.06-32% by weight, is more preferably 0.08-30% by weight, but is most preferably 0.1-28% t by weight.

It is preferable that high and medium refractive index layer liquid coating compositions composed of monomers to form crosslinking polymers are prepared and crosslinking polymers are formed via polymerization reaction during or after coating of the above liquid coating compositions. Each layer is formed along with the formation of crosslinking polymers. Monomers having an anionic group function as a dispersing agent of minute inorganic particles in the liquid coating compositions. The used amount of monomers having an anionic group is preferably 1-50% by weight with respect to the minute inorganic particles, is more preferably 5-40 e by weight, but is still more preferably 10-30% by weight Further, monomers having an amino group or a quaternary ammonium group function as a dispersing aid in the liquid coating compositions. The used amount of monomers having an amino group or a quaternary ammonium group is preferably 3-33% by weight with respect to the monomers having an anionic group. By employing a method in which crosslinking polymers are formed during or after coating of a liquid coating composition, it is possible to allow these monomers to effectively function prior to coating of the liquid coating compositions

Most preferred as monomers employed in the present invention are those having at least two ethylenic unsaturated groups. Listed as those examples are esters of polyhydric alcohols and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol (meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene, 4-vinyl-benzoic acid-2-acryloylethyl ester, and 1,4-divinylcyclohexane); vinylsulfones (for example, divinylsulfone); acrylamides (for example, methylenebisacrylamide); and methacrylamides. Commercially available monomers having an anionic group and monomers having an amino group or a quaternary ammonium group may be employed. Listed as commercially available monomers having an anionic group which are preferably employed are KAYAMAR PM-21 and PM-2 (both produced by Nihon Kayaku Co., Ltd.); Antox MS-60, MS-2N, and MS-NH₄ (all produced by Nippon Nyukazai Co., Ltd.), ARONIX M-5000, M-6000, and M-8000 SERIES (all produced by Toagosei Chemical Industry Co., Ltd.); BISCOAT #2000 SERIES (produced by Osaka Organic Chemical Industry Ltd.); NEW FRONTIER GX-8289 (produced by Dai-ichi Kogyo Seiyaku Co., Ltd.); NK ESTER CB-1 and A-SA (produced by Shin-Nakamura Chemical Co., Ltd.); and AR-100, MR-100, and MR-200 (produced by Diahachi Chemical Industry Co., Ltd.). Listed as commercially available monomers having an amino group or a quaternary ammonium group which are preferably employed are DMAA (produced by Osaka Organic Chemical Industry Ltd.); DMAEA and DRAPAA (produced by Kojin Co., Ltd.); BLENMER QA (produced by NOF Corp.), and NEW FRONTIER C-1615 (produced by Dia-ichi Kogyo Seiyaku Co., Ltd.).

It is possible to perform polymer polymerization reaction employing a photopolymerization reaction or a thermal polymerization reaction. The photopolymerization reaction is particularly preferred. It is preferable to employ polymerization initiators to perform the polymerization reaction. For example, listed are thermal polymerization initiators and photopolymerization imitators described below which are employed to form binder polymers of the hard coatinging layer.

Employed as the polymerization initiators may be commercially available ones. In addition to the polymerization initiators, employed may be polymerization promoters. The added amount of polymerization initiators and polymerization promoters is preferably in the range of 0.2-10% by weight of the total monomers. Polymerization of monomers (or oligomers) may be promoted by heating a liquid coating composition (being an inorganic particle dispersion incorporating monomers). Further, after the photopolymerization reaction after coating, the resulting coating is heated whereby the formed polymer may undergo additional heat curing reaction.

It is preferable to use relatively high refractive index polymers in the medium and high refractive index layers. Listed as examples of polymers exhibiting a high refractive index are polystyrene, styrene copolymers, polycarbonates, melamine resins, phenol resins, epoxy resins, and urethanes which are obtained by allowing cyclic (alicyclic or aromatic) isocyanates to react with polyols. It is also possible to use polymers having another cyclic (aromatic, heterocyclic, and alicyclic) group and polymers having a halogen atom other than fluorine as a substituent due to their high refractive index.

Low refractive index layers usable in the present invention include a low refractive index layer which is formed by crosslinking of fluorine containing resins (hereinafter referred to as “fluorine containing resins prior to crosslinking”) which undergo crosslinking by heat or ionizing radiation, a low refractive index layer prepared employing a sol-gel method, and a low refractive index layer composed of minute particles and binder polymers in which voids exist among minute particles or in the interior of the minute particle. In the present invention, preferred is the low refractive index layer mainly employing minute particles and binder polymers. The low refractive index layer having voids in the interior of the particle (also called the minute hollow particle) is preferred since it is possible to lower the refractive index. However, a decrease in the refractive index of the low refractive index layer is preferred due to an improvement of antireflection performance, while it becomes difficult to provide desired strength. In view of the above compatibility, the refractive index of the low refractive index layer is preferably at most 1.45, is more preferably 1.30-1.50, is still more preferably 1.35-1.49, but is most preferably 1.35-1.45.

Further, the above preparation methods of the low refractive index layer may be suitably combined.

Preferably listed as fluorine containing resins prior to coating are fluorine containing copolymers which are formed employing fluorine containing vinyl monomers and crosslinking group providing monomers. Listed as specific examples of the above fluorine containing vinyl monomer units are fluoroolefins (for example, fluoroethylene, vinylidene fluoride, tetrafluoroethylene, hexafluoroethylene, hexafluoropropylene, perfluoro-2,2-dimethyl-1,3-dioxol), partially or completely fluorinated alkyl ester derivatives of (meth)acrylic acid (for example, BISCOAT GFM (produced by Osaka Organic Chemical Industry Ltd.) and M-2020 (produced by Daikin Industries, Ltd.), and completely or partially fluorinated vinyl ethers. Listed as monomers to provide a crosslinking group are vinyl monomers previously having a crosslinking functional group in the molecule, such as glycidyl methacrylate, vinyltrimethoxysilane, γ-methacryloyloxypropyltrimethoxysilane, or vinyl glycidyl ether, as well as vinyl monomers having a carboxyl group, a hydroxyl group, an amino group, or a sulfone group (for example, (meth)acrylic acid, methylol (meth)acrylate, hydroxyalkyl (meth)acrylate, allyl acrylate, hydroxyalkyl vinyl ether, and hydroxyalkyl allyl ether). P-A Nos. 10-25388 and 10-147739 describe that a crosslinking structure is introduced into the latter by adding compounds having a group which reacts with the functional group in the polymer and at least one reacting group. Listed as examples of the crosslinking group are a acryloyl, methacryloyl, isocyanate, epoxy, aziridine, oxazoline, aldehyde, carbonyl, hydrazine, carboxyl, methylol or active methylene group. When fluorine containing polymers undergo thermal crosslinking due to the presence of a thermally reacting crosslinking group or the combinations of an ethylenic unsaturated group with thermal radical generating agents or an epoxy group with a heat generating agent, the above polymers are of a heat curable type. On the other hand, in cases in which crosslinking undergoes by exposure to radiation (preferably ultraviolet radiation and electron beams) employing combinations of an ethylenic unsaturated group with photo-radical generating agents or an epoxy group with photolytically acid generating agents, the polymers are of an ionizing radiation curable type.

Further, employed as a fluorine containing resins prior to coating may be fluorine containing copolymers which are prepared by employing the above monomers with fluorine containing vinyl monomers, and monomers other than monomers to provide a crosslinking group in addition to the above monomers. Monomers capable being simultaneously employed are not particularly limited. Those examples include olefins (ethylene, propylene, isoprene, vinyl chloride, and vinylidene chloride); acrylates (methyl acrylate, ethyl acrylate, and 2-ethylhexyl acrylate); methacrylates (methyl methacrylate, ethyl methacrylate, butyl methacrylate, and ethylene glycol dimethacrylate); styrene derivatives (styrene, divinylbenzene, vinyltoluene, and α-methylstyrene); vinyl ethers (methyl vinyl ether); vinyl esters (vinyl acetate, vinyl propionate, and vinyl cinnamate); acrylamides (N-tert-butylacrylamide and N-cyclohexylacrylamide); methacrylamides; and acrylonitrile derivatives. Further, in order to provide desired lubricating properties and antistaining properties, it is also preferable to introduce a polyorganosiloxane skeleton or a perfluoropolyether skeleton into fluorine containing copolymers. The above introduction is performed, for example, by polymerization of the above monomers with polyorganosiloxane and perfluoroether having, at the end, an acryl group, a methacryl group, a vinyl ether group, or a styryl group and reaction of polyorganosiloxane and perfluoropolyether having a functional group.

The used ratio of each monomer to form the fluorine containing copolymers prior to coating is as follows. The ratio of fluorine containing vinyl monomers is preferably 20-70 mol %, but is more preferably 40-70 mol %; the ratio of monomers to provide a crosslinking group is preferably 1-20 mmol %, but is more preferably 5-20 mol %, and the ratio of the other monomers simultaneously employed is preferably 10-70 mol %, but is more preferably 10-50 mol %.

It is possible to obtain the fluorine containing copolymers by polymerizing these monomers employing methods such as a solution polymerization method, a block polymerization method, an emulsion polymerization method or a suspension polymerization method.

The fluorine containing resins prior to coating are commercially available and it is possible to employ commercially available products. Listed as examples of the fluorine containing resins prior to coating are SAITOP (produced by Asahi Glass Co., Ltd.), TEFLON (a registered trade name) AD (produced by Du Pont), vinylidene polyfluoride, RUMIFRON (produced by Asahi Glass Co., Ltd.), and OPSTAR (produced by JSR).

The dynamic friction coefficient and contact angle to water of the low refractive index layer composed of crosslinked fluorine containing resins are in the range of 0.03-0.15 and in the range of 90-120 degrees, respectively.

In view of controlling the refractive index, it is preferable that the low refractive index layer composed of crosslinked fluorine containing resins incorporates minute inorganic particles described below. Further, it is preferable that minute inorganic particles are subjected to a surface treatment. Surface treatment methods include physical surface treatments such as a plasma discharge treatment and a corona discharge treatment, and a chemical surface treatment employing coupling agents. It is preferable to use the coupling agents. Preferably employed as coupling agents are organoalkoxy metal compounds (for example, a titanium coupling argent and a silane coupling agent). In cases in which minute inorganic particles are composed of silica, the treatment employing the silane coupling agent is particularly effective.

Further, preferably employed as components for the low refractive index layer may be various types of sol-gel components. Preferably employed as such sol-gel components may be metal alcolates (being alcolates of silane, titanium, aluminum, or zirconium, and organoalkoxy metal compounds and hydrolysis products thereof. Particularly preferred are alkoxysilane, and hydrolysis products thereof. It is also preferable to use tetraalkoxysilane (tetramethoxysilane and tetraethoxysilane), alkyltrialkoxysilane (methyltrimethoxysilane, and ethyltrimethoxysilane), aryltrialkoxysilane (phenyltrimethoxysilane, dialkyldialkoxysilane, diaryldialkoxysilane. Further, it is also preferable to use organoalkoxysilanes having various type of functional group (vinyltrialkoxysilane, methylvinyldialkoxysilane, γ-glycidyloxypropyltrialkoxysilane, γ-glycidyloxyoropylmethyldialkoxysilane, β-(3,4)epoxycyclohexyl)ethyltrialkoxysilane, γ-merthacryloyloxypropyltrialkoxysilane, γ-aminopropyltrialkoxysilane, γ-mercaptopropyltrialkoxysilane, and γ-chloropropyltrialkoxysilane), perfluoroalkyl group containing silane compounds (for example, (heptadecafluoro1,1,2,2-tetradecyl)triethoxysilane, 3,3,3-trifluoropropyltrimethoxy silane). In view of decreasing the refractive index of the layer and providing water repellency and oil repellency, it is preferable to particularly use fluorine containing silane compounds.

As a low refractive index layer, it is preferable to employ a layer which is prepared in such a manner that minute inorganic or organic particles are employed and micro-voids are formed among minute particles or in the minute particle. The average diameter of the minute particles is preferably 0.5-200 nm, is more preferably 1-100 nm, is more preferably 3-70 nm, but is most preferably 5-40 nm. Further, it is preferable that the particle diameter is as uniform (monodispersion) as possible.

Minute inorganic particles are preferably non-crystalline. The minute inorganic particles are preferably composed of metal oxides, nitrides, sulfides or halides, are more preferably composed of metal oxides or metal halides, but are most preferably composed of metal oxides or metal fluorides. Preferred as metal atoms are Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Ob and Ni. Of these, more preferred are Mg, Ca, B and Si. Inorganic compounds incorporating two types of metal may be employed. Specific examples of preferred inorganic compounds include SuO₂ or MgF₂, and SiO₂ is particularly preferred.

It is possible to form particles having micro-voids in the interior of an inorganic particle, for example, by crosslinking silica molecules. When silica molecules undergo crosslinking, the resulting volume decreases whereby a particle becomes porous. It is possible to directly synthesize micro-void containing (porous) inorganic particles as a dispersion, employing the sol-gel method (described in JP-A No. 53-112732 and Japanese Patent Publication (hereinafter referred to as JP-B) No. 57-9051) and the deposition method (described in Applied Optics, Volume 27, page 3356 (1988)). Alternatively, it is also possible to obtain a dispersion in such a manner that powder prepared by a drying and precipitation method is mechanically pulverized. Commercially available minute porous inorganic particles (for example, SiO₂ sol) may be employed.

In order to form a low refractive index layer, it is preferable that these minute inorganic particles are employed in the state dispersed in a suitable medium. Preferred as media are water, alcohol (for example, methanol, ethanol, and isopropyl alcohol), and ketone (for example, methyl ethyl ketone and methyl isobutyl ketone).

It is also preferable that minute organic particles are non-crystalline and are minute polymer particles which are synthesized by the polymerization reaction (for example, an emulsion polymerization method) of monomers. It is preferable that the polymers of minute organic particles incorporate fluorine atoms. The ratio of fluorine atoms in polymers is preferably 35-80% by weight, but is more preferably 45-75% by weight. Further, it is preferable that micro-voids are formed in the minute organic particle in such a manner that particle forming polymers undergo crosslinking so that a decrease in the volume forms micro-voids. In order that particle forming polymers undergo crosslinking; it is preferable that at least 20 mol % of monomers to synthesize a polymer are multifunctional monomers. The ratio of the multifunctional monomers is more preferably 30-80 mol %, but is most preferably 35-50 mol Em Listed as examples of fluorine containing monomers employed to synthesize the above fluorine containing polymers are fluorolefins (for example, fluoroethylene, vinylidene fluoride, tetrafluoroethylene, hexafluoropropylene, and perfluoro-2,2-dimethyl-1,3-dioxol), as well as fluorinated alkyl esters of acrylic acid or methacrylic acid and fluorinated vinyl ethers. Copolymers of monomers with and without fluorine atoms may be employed. Listed as examples of monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, ethyl methacrylate and butyl methacrylate), styrenes (for example, styrene, vinyltoluene, and α-methylstyrene), vinyl ethers (for example, methyl vinyl ether), vinyl esters (for example, vinyl acetate and vinyl propionate), acrylamides (for example, N-tert-butylacrylamide and N-cyclohexylacrylamide), methacrylamides, and acrylonitriles. Listed as examples of multifunctional monomers are dienes (for example, butadiene and pentadiene), esters of polyhydric alcohol with acrylic acid (for example, ethylene glycol diacrylate, 1,4-cyclohexane diacrylate, and dipentaerythritol hexaacrylate), esters of polyhydric alcohol with methacrylic acid (for example, ethylene glycol dimethacrylate, 1,2,4-cyclohexane tetramethacrylate, and pentaerythritol tetramethacrylate), divinyl compounds (for example, divinylcyclohexane and 1,4-divinylbenzene), divinylsulfone, and bisacrylamides (for example, methylenebisacrylamide) and bismethacrylamides.

It is possible to form micro-voids among particles by piling at least two minute particles. Incidentally, when minute spherical particles (completely monodispersed) of an equal diameter are subjected to closest packing, micro-voids at a 26% void ratio by volume are formed among minute particles. When spherical particles of an equal diameter are subjected to simple cubic packing, micro-voids at 48% void ratio by volume are formed among minute particles. In a practical low refractive index layer, the void ratio significantly shifts from the theoretical value due to the distribution of diameter of the minute particles and the presence of voids in the particle. As the void ratio increases the refractive index of the low refractive index layer decreases. When micro-voids are formed by piling minute particles, it is possible to easily control the size of micro-voids among particles to an appropriate value (being a value minimizing scattering light and resulting in no problems of the strength of the low refractive index layer) by adjusting the diameter of minute particles. Further, by making the diameter of minute particles uniform, it is possible to obtain an optically uniform low refractive index layer of the uniform size of micro-voids among particles. By doing so, though the resulting low refractive index layer is microscopically a micro-void containing porous layer, optically or macroscopically, it is possible to make it a uniform layer. It is preferable that micro-voids among particles are confined in the low refractive index layer employing minute particles and polymers. Confined voids exhibits an advantage such that light scattering on the surface of a low refractive index layer is decreased compared to the voids which are not confined.

By forming micro-voids, the macroscopic refractive index of the low refractive index layer becomes lower than the total refractive index of the components constituting the low refractive index layer. The refractive index of a layer is the sum of the refractive indexes per volume of layer constituting components. The refractive index value of the constituting components such as minute particles or polymers of the low refractive index lay is larger than 1, while the refractive index of air is 1.00. Due to that, by forming micro-voids, it is possible to obtain a low refractive index layer exhibiting significantly lower refractive index.

Further, in the present invention, an embodiment is also preferred in which minute hollow SiO₂ particles are employed.

Minute hollow particles, as described in the present invention, refer to particles which have a particle wall, the interior of which is hollow. An example of such particles includes particles which are formed in such a manner that the above SiO₂ particles having voids in the interior of particles are further subjected to surface coating employing organic silicon compounds (being alkoxysilanes such as tetraethoxysilane) to close the pores. Alternatively, voids in the interior of the wall of the above particles may be filled with solvents or gases. For example, in the case of air, it is possible to significantly lower the refractive index (at 1.44-1.34) of minute hollow particles compared to common silica at a refractive index of 1.46). By adding such minute hollow SiO₂ particles, it is possible to further lower the refractive index of the low refractive index layer.

Making particles having micro-voids in the above minute inorganic particle hollow may be achieved based on the methods described in JP-A Nos. 2001-167637 and 2001-233611. Further, it is possible to use commercially available minute hollow SiO₂ particles. Listed as a specific example of commercially available particles is P-4 produced by Shokubai Kasel Kogyo Co.

It is preferable that the low refractive index layer incorporates polymers in an amount of 5-50% by weight. The above polymers exhibit functions such that minute particles are subjected to adhesion and the structure of the above low refractive index layer is maintained. The used amount of the polymers is controlled so that without filling voids, it is possible to maintain the strength of the low refractive index layer. The amount of the polymers is preferably 10-30% by weight of the total weight of the low refractive index layer. In order to achieve adhesion of minute particles employing polymers, it is preferable that (1) polymers are combined with surface processing agents of minute particles, (2) a polymer shell is formed around a minute particle used as a core, or (3) polymers are employed as a binder among minute particles. The polymers which are combined with the surface processing agents in (1) are preferably the shell polymers of (2) or binder polymers of (3). It is preferable that the polymers of (2) are formed around the minute particles employing a polymerization reaction prior to preparation of the low refractive index layer liquid coating composition. It is preferable that the polymers of (3) are formed employing a polymerization reaction during or after coating of the low refractive index layer while adding their monomers to the above low refractive index layer coating composition. It is preferable that at least two of (1), (2), and (3) or all are combined and employed. Of these, it is particularly preferable to practice the combination of (1) and (3) or the combination of (1), (2), and (3). (1) surface treatment, (2) shell, and (3) binder will now successively be described in that order.

### (1) Surface Treatments

It is preferable that minute particles (especially, minute inorganic particles) are subjected to a surface treatment to improve affinity with polymers. These surface treatments are classified into a physical surface treatment such as a plasma discharge treatment or a corona discharge treatment and a chemical surface treatment employing coupling agents. It is preferable that the chemical surface treatment is only performed or the physical surface treatment and the chemical surface treatment are performed in combination. Preferably employed as coupling agents are organoalkoxymetal compounds (for example, titanium coupling agents and silane coupling agents). In cases in which minute particles are composed of SiO₂, it is possible to particularly effectively affect a surface treatment employing the silane coupling agents. As specific examples of the silane coupling agents, preferably employed are those listed above.

The surface treatment employing the coupling agents is achieved in such a manner that coupling agents are added to a minute particle dispersion and the resulting mixture is allowed to stand at room temperature—60° C. for several hours—10 days. In order to accelerate a surface treatment reaction, added to a dispersion may be inorganic acids (for example, sulfuric acid, hydrochloric acid, nitric acid, chromic acid, hypochloric acid, boric acid, orthosilicic acid, phosphoric acid, and carbonic acid); organic acid (for example, acetic acid, polyacrylic acid, benzenesulfonic acid, phenol and polyglutamine acid), or salts thereof (for example, metal salts and ammonium salts).

### (2) Shell

Shell forming polymers are preferably polymers having a saturated hydrocarbon as a main chain. Polymers incorporating fluorine atoms in the main chain or the side chain are preferred, while polymers incorporating fluorine atoms in the side chain are more preferred. Acrylates or methacrylates are preferred and esters of fluorine-substituted alcohol with polyacrylic acid or methacrylic acid are most preferred. The refractive index of shell polymers decreases as the content of fluorine atoms in the polymer increases. In order to lower the refractive index of a low refractive index layer, the shell polymers incorporate fluorine atoms in an amount of preferably 35-80% by weight, but more preferably 45-75% by weight. It is preferable that fluorine containing polymers are synthesized via the polymerization reaction of fluorine atom containing ethylenic unsaturated monomers. Listed as examples of fluorine atom containing ethylenic unsaturated monomers are fluorolefins (for example, fluoroethylene, vinylidene fluoride, tetrafluoroethylene, hexafluoropropylene, perfluoro-2,-dimethyl-1,3-dixol), fluorinated vinyl ethers and esters of fluorine substituted alcohol with acrylic acid or methacrylic acid.

Polymers to form the shell may be copolymers having repeating units with and without fluorine atoms. It is preferable that the units without fluorine atoms are prepared employing the polymerization reaction of ethylenic unsaturated monomers without fluorine atoms. Listed as examples of ethylenic unsaturated monomers without fluorine atoms are olefins (for example, ethylene, propylene, isoprene, vinyl chloride, and vinylidene chloride), acrylates (for example, methyl acrylate, ethyl acrylate, and 2-ethylhexyl acrylate), methacrylates (for example, methyl methacrylate, ethyl methacrylate, butyl methacrylate, and ethylene glycol dimethacrylate), styrenes and derivatives thereof (for example, styrene, divinylbenzene, vinyltoluene, and α-methylstyrene), vinyl ethers (for example, methyl vinyl ether), vinyl esters (for example, vinyl acetate, vinyl propionate, and vinyl cinnamate), acrylamides (for example, N-tetrabutylacrylamide and N-cyclohexylacrylamide), as well as methacrylamide and acrylonitrile.

In the case of (3) in which binder polymers described below are simultaneously used, a crosslinking functional group may be introduced into shell polymers and the shell polymers and binder polymers are chemically bonded via crosslinking. Shell polymers may be crystalline. When the glass transition temperature (Tg) of the shell polymer is higher than the temperate during the formation of a low refractive index layer, micro-voids in the low refractive index layer are easily maintained. However, when Tg is higher than the temperature during formation of the low refractive index layer, minute particles are not fused and occasionally, the resulting low refractive index layer is not formed as a continuous layer (resulting in a decrease in strength). In such a case, it is desirous that the low refractive index layer is formed as a continuous layer simultaneously employing the binder polymers of (3). A polymer shell is formed around the minute particle, whereby a minute core/shell particle is obtained. A core composed of a minute inorganic particle is incorporated preferably 5-90% by volume in the minute core/shell particle, but more preferably 15-80% by volume. At least two types of minute core/shell particle may be simultaneously employed. Further, inorganic particles without a shell and core/shell particles may be simultaneously employed.

### (3) Binders

Binder polymers are preferably polymers having saturated hydrocarbon or polyether as a main chain, but is more preferably polymers having saturated hydrocarbon as a main chain. The above binder polymers are subjected to crosslinking. It is preferable that the polymers having saturated hydrocarbon as a main chain is prepared employing a polymerization reaction of ethylenic unsaturated monomers. In order to prepare crosslinked binder polymers, it is preferable to employ monomers having at least two ethylenic unsaturated groups. Listed as examples of monomers having at least two ethylenic unsaturated groups are esters of polyhydric alcohol with (meth)acrylic acid (for example, ethylene glycol di(meth)acrylate, 1,4-dicyclohexane diacrylate, pentaerythritol tetra(meth)acrylate, pentaerythritol (meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,2,3-cyclohexane tetramethacrylate, polyurethane polyacrylate, and polyester polyacrylate); vinylbenzene and derivatives thereof (for example, 1,4-divinylbenzene and 4-vinylbenzoic acid-2-acryloylethyl ester, and 1,4-divinylcyclohexane); vinylsulfones (for example, divinylsulfone); acrylamides (for example, methylenebisacrylamide); and methacrylamides. It is preferable that polymers having polyether as a main chain are synthesized employing a ring opening polymerization reaction. A crosslinking structure may be introduced into binder polymers employing a reaction of crosslinking group instead of or in addition to monomers having at least two ethylenic unsaturated groups. Listed as examples of the crosslinking functional groups are an isocyanate group, an epoxy group, an aziridine group, an oxazoline group, an aldehyde group, a carbonyl group, a hydrazine group, a carboxyl group, a methylol group, and an active methylene group. It is possible to use, as a monomer to introduce a crosslinking structure, vinylsulfonic acid, acid anhydrides, cyanoacrylate derivatives, melamine, ether modified methylol, esters and urethane. Functional groups such as a block isocyanate group, which exhibit crosslinking properties as a result of the decomposition reaction, may be employed. The crosslinking groups are not limited to the above compounds and include those which become reactive as a result of decomposition of the above functional group. Employed as polymerization initiators used for the polymerization reaction and crosslinking reaction of binder polymers are heat polymerization initiators and photopolymerization initiators, but the photopolymerization initiators are more preferred. Examples of photopolymerization initiators include acetophenones, benzoins, benzophenones, phosphine oxides, ketals, antharaquinones, thioxanthones, azo compounds, peroxides, 2,3-dialkyldiones, disulfide compounds, fluoroamine compounds, and aromatic sulfoniums. Examples of acetophenones include 2,2-diethoxyacetophenone, p-dimethylacetophenone, 1-hydroxydimethyl phenyl ketone, 1-dihydroxycyclohexyl phenyl ketone, 2-methyl-4-methylthio-2-morpholinopropiophene, and 2-benzyl-2-dimethylamino-1-(4-morpholinophenyl)-butanone. Examples of benzoins include benzoin ethyl ether and benzoin isopropyl ether. Examples of benzophenones include benzophenone, 2,4-dichlorobenzophenone, 4,4-dichlorobenzophenone, and p-chlorobenzophenone. An example of phosphine oxides includes 2,4,6-trimethylbenzoyldiphenylphosphine oxide.

It is preferable that binder polymers are formed in such a manner that monomers are added to a low refractive index layer liquid coating composition and the binder polymers are formed during or after coating of the low refractive index layer utilizing a polymerization reaction (if desired, further crosslinking reaction). A small amount of polymers (for example, polyvinyl alcohol, polyoxyethylene, polymethyl methacrylate, polymethyl acrylate, diacetyl cellulose, triacetyl cellulose, nitrocellulose, polyester, and alkyd resins) may be added to the low refractive index layer liquid coating composition.

Further, it is preferable to add slipping agents to the low refractive index layer or other refractive index layers. By providing desired slipping properties, it is possible to improve abrasion resistance. Preferably employed as slipping agents are silicone oil and wax materials. For example, preferred are the compounds represented by the formula below.

R₁COR₂ Formula

In the above formula, R₁ represents a saturated or unsaturated aliphatic hydrocarbon group hang at least 12 carbon atoms, while R₁ is preferably an alkyl group or an alkenyl group but is more preferably an alkyl group or an alkenyl group having at least 16 carbon atoms. R₂ represents —OM₁ group (M₁ represents an alkaline metal such as Na or K), —OH group, —NH₂ group, or —OR₃ group (R₃ represents a saturated or unsaturated aliphatic hydrocarbon group having at least 12 carbon atoms and is preferably an alkyl group or an alkenyl group). R₂ is preferably —OH group, NH₂ group or —OR₃ group. In practice, preferably employed may be higher fatty acids or derivatives thereof such as behenic acid, stearic acid amide, or pentacosanoic acid or derivatives thereof and natural products such as carnauba wax, beeswax, or montan wax, which incorporate a large amount of such components, Further listed may be polyorganosiloxane disclosed in JP-B No. 53-292, higher fatty acid amides discloses in U.S. Pat. No. 4,275,146, higher fatty acid esters (esters of a fatty acid having 10-24 carbon atoms and alcohol having 10-24 carbon atoms) disclosed in JP-B No. 58-33541, British Patent No. 927,446, or JP-A Nos. 55-126238 and 58-90633, higher fatty acid metal salts disclosed in U.S. Patent No. 3,933,516, polyester compounds composed of dicarboxylic acid having at least 10 carbon atoms and aliphatic or alicyclic diol disclosed in JP-A No. 51-37217, and oligopolyesters composed of dicarboxylic acid and diol disclosed in JP-A No. 7-13292.

For example, the added amount of slipping agents employed in the low refractive index layer is preferably 0.01-10 mg/m₂.

Added to each of the antireflection layers or the liquid coating compositions thereof may be polymerization inhibitors, leveling agents, thickeners, anti-coloring agents, UV absorbents, silane coupling agents, antistatic agents, and adhesion providing agents, other than metal oxide particles, polymers, dispersion media, polymerization initiators, and polymerization accelerators.

It is possible to form each layer of the antireflection films employing coating methods such as a dip coating method, an air-knife coating method, a curtain coating method, a roller coating method, a wire bar coating method, a gravure coating method, or an extrusion coating method (U.S. Pat. No. 2,681,294). At least two layers may be simultaneously coated. Simultaneous coating methods are described in U.S. Pat. Nos. 2,761,791, 2,941,898, 3,508,947, and 3,526,528, as well as Yuji Harazaki, Coating Kogaku (Coating Engineering), page 253, Asakura Shoten (1973).

In the present invention, in the production of an antireflection film, after applying the above liquid coating composition onto a support, drying is performed preferably at 60° C. or higher, but more preferably at 80° C. or higher. Further, drying is performed preferably at a dew point of 20° C. or lower, but is more preferably at a dew point of 15° C. or lower. It is preferable that drying is initiated within 10 seconds after coating onto a support. Combining the above conditions results in the preferred production method to achieve the effects of the present invention.

As noted above, the optical film of the present invention is preferably employed as an antireflection film, a hard coating film, a glare shielding film, a phase different film, an antistatic film, and a luminance enhancing film

### EXAMPLE

The following specifically describes the present invention with reference to Examples, without the present invention being restricted thereto. In the examples, “parts” and “%” represent “parts by weight” and “% by weight”, respectively, unless otherwise specifically specified.

### Example 1

### Preparation of Cellulose Ester Optical Film

One hundred parts by weight of cellulose acetate propionate (acetyl substitution ratio=1.92, propionyl substitution degree=0.74, total substitution degree=2.66, weight average molecular weight 220,000 in terms of polystyrene, dispersion degree=2.4) as the cellulose ester CE-1, 8 parts by weight of AMP-1 of the foregoing polymer (a), 2 parts by weight of the foregoing KA-61 as the plasticizer, 0.25 parts by weight of the foregoing I-16 (Sumilizer GS manufactured by Sumitomo Chemical Co., ltd.) as the carbon radical trapping agent, 0.5 parts by weight of pentaerytihritol tetrakis[3-(3,5-di-tert-butyl-4-hydroxyphenyl)propionate] (Irganox 1010 manufactured by Ciba Specialty Chemicals) as the phenol type compound P-1, 0.25 parts by weight of tetrakis(2,4-di-t-butyl-5-methylphenyl)-4,4′-biphenylene-diphodphonite (GSY-P101 manufactured by Sakai Chemical Industry Co., Ltd.) as the phosphonite compound PN-1, 1.5 parts by weight of 2-(2h-benzotriazole-2-yl)-6-(1-methyl-1-phenylethyl)-4-(1,1,3,3-tetramethylbutyl)phenol (Tinuvin 928 manufactured by Ciba Specialty Chemicals) as a UV absorbent agent UV-1 and 0.3 parts by weight of fine silica particle having an average primary particle diameter of 16 μm (Aerosil R972 manufactured by Nippon Aerosil Co., Ltd.) as a fine particle matting agent M-1 were mixed and dried under reduced pressure for 50 minutes at 60 DC. The resultant cellulose acrylate composition was pelletized by melting and mixing at 235° C. using a bi-axial extruder. On this occasion, an oar type screw was used in place of kneading disc for inhibiting heat generation by the sharing force of kneading. The volatile composition caused during the kneading was exhausted by sucking through a bent hole. The feeder and the hopper supplying the material to the extruder and the course from the extrusion die to cooling tank were placed in nitrogen atmosphere for preventing moisture absorption by the resin.

Film formation was carried out by the apparatus shown in FIG. 1.

The first and second cooling rollers each having a diameter of 40 cm are made from stainless steel and hard chromium plating was provided on the surface thereof. Oil for controlling temperature was circulated in the interior of these rollers for controlling the surface temperature of the rollers. The elastic touching roller had a diameter of 20 cm and the external and internal cylinder thereof were each made from stainless steel and hard chromium plating was provided on the surface of the external cylinder. The thickness of the external cylinder was 2 mm, and temperature controlling oil was circulated in the space between the internal cylinder and the external cylinder for controlling the surface temperature of the elastic touching roller.

The resultant pellets (moisture content: 50 ppm) were extruded into film shape through T-die at a melting temperature of 250° C. using the mono-axial extruder onto the first cooling roller having a surface temperature of 130° C. to obtain a film casted at a drawing ratio of 20. On this occasion, the T-die having a lip clearance of 1.5 mm and an average surface roughness of Ra of 0.01 μm of lip portion was used. The drawing ratio is a value obtained by dividing the lip clearance by the average thickness of the cast and cool-solidified film.

The film was pressed by a line pressure of 10 kg/cm on the first cooling roller by the elastic touching roller having a metal surface with a thickness of 2 mm. The temperature of the film on the touching roller side was 180±1° C. (The temperature of the film on the touching roller side is an averaged value of temperatures of the film at the point to be touched to the touching roller on the first touching roller each measured at 10 points lined in the width direction by a non-contacting thermometer at a distance of 50 cm from the film in a state of that the touching roller is backed so that the roller is not touched to the film.) The glass transition temperature Tg of the film was 136° C. The glass transition temperature was that of the film extruded from the die measured by DCS method at a temperature rising rate of 10° C./minute in nitrogen atmosphere using DSC6200, manufactured by Seiko Corp.

The surface temperature of the elastic touching roller and that of the second cooling roller were each set at 130° C. and 100° C., respectively. The surface temperatures of the elastic touching roller, the first cooling roller and the second cooling roller were each determined by averaging the temperatures of the rollers measured by a non-contact thermometer at ten points lined in the width direction at the position before 900 in the rotating direction from the position where the film was touched to each of the rollers.

Thus obtained film was heated by 160 CC and extended by 1.05 times in the length direction by a extending roller and then introduced in a tenter including a preheating zone, an extending zone, maintaining zone and a cooling zone (neutral zones for making sure the thermal isolation were provided between each of the zones). In the tenter, the film was extended by 1.20 times in the width direction at 160° C. and cooled by 70° C. while relaxing by 2% in the width direction and then released from the clips. The portion of the film where the film was clipped by the clip was cut off, and then a knurling treatment of width of 10 mm and height of 5 μm was provided on both edges of the film. Thus cellulose ester film F-1 slit into a width of 1430 mm having a thickness of 80 μm, Ro of 3 nm and Rt of 44 nm was prepared. The bowing phenomenon caused by the extension was prevented by controlling the preheating temperature and holding temperature.

Optical films F-2 to F-44 were prepared applying the compounds and the conditions described in Tables 1 and 2.

Details of the compounds and the preparation conditions are listed below.

TABLE 1

| | | | | Carbon | | | | | | | |
|---|---|---|---|---|---|---|---|---|---|---|---|
| | | | | radical | | | | Phosphor | | | |
| | | | | capturing | | Phenol type | | type | | | |
| | | Polymer (a) | | agent | | compound | | compound | | Plasticizer | |
| Sample | Cellulose | | Adding | | Adding | | Adding | | Adding | | Adding |
| No. | ester | Kind | amount | Kind | amount | Kind | amount | Kind | amount | Kind | amount |
| F-1 | CE-1 | AMP-1 | 8.00 | I-16 | 0.25 | P-1 | 0.50 | PN-1 | 0.25 | KA-61 | 2.00 |
| F-2 | CE-1 | AMP-2 | 10.00 | — | — | P-1 | 1.00 | — | — | KA-48 | 2.00 |
| F-3 | CE-1 | AMP-3 | 8.00 | — | — | P-1 | 0.50 | PN-2 | 0.25 | KA-61 | 2.00 |
| F-4 | CE-1 | AMP-4 | 8.00 | — | — | P-1 | 1.00 | PN-1 | 0.70 | KA-61 | 2.00 |
| F-5 | CE-1 | AMP-5 | 12.00 | I-16 | 1.10 | P-1 | 0.25 | PN-1 | 0.25 | KA-61 | 2.00 |
| F-6 | CE-2 | AMP-6 | 8.00 | I-16 | 0.25 | P-1 | 0.50 | PN-1 | 0.25 | KA-61 | 2.00 |
| F-7 | CE-2 | AMP-7 | 8.00 | I-16 | 0.25 | P-1 | 0.25 | PN-1 | 1.20 | KA-61 | 2.00 |
| F-8 | CE-2 | AMP-8 | 8.00 | 108 | 0.20 | P-1 | 0.50 | PN-2 | 0.30 | KA-1 | 2.00 |
| F-9 | CE-2 | AMP-9 | 6.00 | 108 | 0.25 | P-4 | 1.80 | — | — | KA-48 | 4.00 |
| F-10 | CE-2 | AMP-10 | 20.00 | 108 | 0.30 | — | — | PN-4 | 0.80 | KA-61 | 2.00 |
| F-11 | CE-3 | AMP-11 | 8.00 | — | — | P-3 | 0.50 | — | — | KA-1 | 2.00 |
| F-12 | CE-3 | AMP-12 | 6.00 | I-16 | 0.50 | P-4 | 0.10 | PN-1 | 0.50 | KA-48 | 4.00 |
| F-13 | CE-3 | AMP-13 | 8.00 | — | — | P-1 | 1.70 | PN-6 | 0.25 | KA-61 | 2.00 |
| F-14 | CE-3 | AMP-14 | 8.00 | I-1 | 0.20 | P-4 | 0.50 | PN-1 | 0.25 | KA-61 | 2.00 |
| F-15 | CE-3 | AMP-15 | 8.00 | I-16 | 0.25 | P-1 | 0.50 | PN-1 | 0.25 | KA-61 | 2.00 |
| F-16 | CE-4 | AMP-16 | 10.00 | — | — | — | — | PN-1 | 0.25 | KA-61 | 2.00 |
| F-17 | CE-4 | AMP-17 | 8.00 | 108 | 0.25 | P-4 | 0.50 | PN-2 | 0.25 | KA-48 | 2.00 |
| F-18 | CE-4 | AMP-18 | 8.00 | I-16 | 0.25 | P-1 | 0.50 | PN-1 | 0.25 | KA-61 | 2.00 |
| F-19 | CE-4 | AMP-19 | 6.00 | — | — | P-1 | 0.50 | PN-1 | 0.90 | KA-61 | 4.00 |
| F-20 | CE-4 | AMP-20 | 8.00 | I-16 | 0.25 | P-1 | 0.25 | PN-1 | 1.20 | KA-61 | 2.00 |
| F-21 | CE-5 | AMP-21 | 12.00 | I-16 | 0.25 | — | — | — | — | KA-61 | 2.00 |
| F-22 | CE-5 | AMP-22 | 8.00 | I-16 | 0.25 | — | — | PN-3 | 0.50 | KA-48 | 2.00 |

| | UV absorbent | | Fine particle | | Melting | Extension | | |
|---|---|---|---|---|---|---|---|---|
| Sample | | Adding | | Adding | temperature | condition | | |
| No. | Kind | amount | Kind | amount | ° C. | MD (times) | TD (times) | Remarks |
| F-1 | UV-1 | 1.50 | M-1 | 0.30 | 250 | 1.05 | 1.20 | Inventive |
| F-2 | UV-2 | 2.00 | M-1 | 0.30 | 250 | 1.00 | 1.20 | Inventive |
| F-3 | UV-1 | 1.50 | M-1 | 0.30 | 250 | 1.05 | 1.20 | Inventive |
| F-4 | UV-3 | 2.50 | M-1 | 0.30 | 250 | 1.30 | 1.50 | Inventive |
| F-5 | UV-1 | 1.50 | M-2 | 0.30 | 250 | 1.00 | 1.20 | Inventive |
| F-6 | UV-1 | 1.50 | M-1 | 0.30 | 240 | 1.10 | 1.20 | Inventive |
| F-7 | UV-1 | 1.50 | M-2 | 0.30 | 240 | 1.10 | 1.20 | Inventive |
| F-8 | UV-2 | 2.00 | M-3 | 0.10 | 240 | 1.00 | 1.10 | Inventive |
| F-9 | UV-3 | 2.50 | M-1 | 0.10 | 240 | 1.20 | 1.60 | Inventive |
| F-10 | UV-1 | 1.50 | M-1 | 0.30 | 240 | 1.10 | 1.20 | Inventive |
| F-11 | UV-1 | 1.50 | M-2 | 0.30 | 240 | 1.05 | 1.20 | Inventive |
| F-12 | UV-3 | 2.50 | M-3 | 0.10 | 240 | 1.10 | 1.10 | Inventive |
| F-13 | UV-1 | 1.50 | M-1 | 0.30 | 240 | 1.25 | 1.45 | Inventive |
| F-14 | UV-1 | 1.50 | M-1 | 0.30 | 240 | 1.00 | 1.05 | Inventive |
| F-15 | UV-1 | 1.50 | M-1 | 0.30 | 240 | 1.00 | 1.05 | Inventive |
| F-16 | UV-1 | 1.50 | M-3 | 0.10 | 240 | 1.05 | 1.20 | Inventive |
| F-17 | UV-3 | 2.50 | M-3 | 0.10 | 240 | 1.05 | 1.25 | Inventive |
| F-18 | UV-1 | 1.50 | M-1 | 0.30 | 240 | 1.05 | 1.20 | Inventive |
| F-19 | UV-1 | 1.50 | M-2 | 0.30 | 240 | 1.30 | 1.50 | Inventive |
| F-20 | UV-1 | 1.50 | M-1 | 0.30 | 240 | 1.00 | 1.20 | Inventive |
| F-21 | UV-2 | 2.00 | M-1 | 0.30 | 220 | 1.05 | 1.15 | Inventive |
| F-22 | UV-3 | 2.50 | M-2 | 0.30 | 220 | 1.10 | 1.20 | Inventive |

The adding amount is parts by weight to 100 parts by weight of cellulose ester

TABLE 2

| | | | | Carbon | | | | | | | |
|---|---|---|---|---|---|---|---|---|---|---|---|
| | | | | radical | | | | Phosphor | | | |
| | | | | capturing | | Phenol type | | type | | | |
| | | Polymer (a) | | agent | | compound | | compound | | Plasticizer | |
| Sample | Cellulose | | Adding | | Adding | | Adding | | Adding | | Adding |
| No. | ester | Kind | amount | Kind | amount | Kind | amount | Kind | amount | Kind | amount |
| F-23 | CE-5 | AMP-23 | 8.00 | 108 | 0.25 | P-3 | 0.50 | — | — | KA-1 | 2.00 |
| F-24 | CE-5 | AMP-24 | 8.00 | 108 | 0.35 | P-1 | 2.20 | PN-1 | 0.25 | KA-61 | 2.00 |
| F-25 | CE-5 | AMP-25 | 8.00 | I-1 | 0.25 | P-1 | 0.50 | PN-2 | 0.25 | KA-61 | 2.00 |
| F-26 | CE-6 | AMP-1 | 8.00 | — | — | — | — | PN-5 | 0.25 | KA-48 | 2.00 |
| F-27 | CE-6 | AMP-2 | 15.00 | I-16 | 0.25 | P-1 | 0.50 | PN-5 | 0.25 | KA-61 | 2.00 |
| F-28 | CE-6 | AMP-3 | 6.00 | 108 | 0.25 | — | — | — | — | KA-61 | 2.00 |
| F-29 | CE-6 | AMP-6 | 8.00 | 108 | 1.10 | P-1 | 0.25 | PN-1 | 1.20 | KA-61 | 2.00 |
| F-30 | CE-6 | AMP-7 | 8.00 | I-1 | 0.25 | P-1 | 0.50 | PN-4 | 0.25 | KA-61 | 2.00 |
| F-31 | CE-7 | AMP-18 | 10.00 | — | — | P-1 | 0.50 | — | — | KA-61 | 2.00 |
| F-32 | CE-7 | AMP-19 | 8.00 | — | — | P-4 | 0.50 | PN-1 | 0.25 | KA-48 | 2.00 |
| F-33 | CE-7 | AMP-20 | 8.00 | I-16 | 0.30 | P-1 | 2.20 | PN-1 | 0.25 | KA-61 | 2.00 |
| F-34 | CE-7 | AMP-21 | 12.00 | 108 | 0.25 | P-1 | 0.50 | PH-1 | 0.25 | KA-61 | 2.00 |
| F-35 | CE-7 | AMP-22 | 8.00 | 108 | 0.25 | P-1 | 0.50 | PH-2 | 0.25 | KA-61 | 2.00 |
| F-36 | CE-1 | AMP-1 | 8.00 | — | — | — | — | — | — | KA-61 | 2.00 |
| F-37 | CE-1 | AMP-6 | 8.00 | — | — | — | — | — | — | KA-61 | 2.00 |
| F-38 | CE-2 | AMP-13 | 8.00 | — | — | — | — | — | — | KA-61 | 2.00 |
| F-39 | CE-3 | AMP-2 | 8.00 | — | — | — | — | — | — | KA-61 | 2.00 |
| F-40 | CE-4 | AMP-7 | 8.00 | — | — | — | — | — | — | KA-48 | 2.00 |
| F-41 | CE-1 | AMP-26 | 8.00 | I-16 | 0.25 | P-1 | 0.50 | PN-1 | 0.25 | KA-61 | 2.00 |
| F-42 | CE-1 | AMP-27 | 10.00 | — | — | P-1 | 1.00 | — | — | KA-48 | 2.00 |
| F-43 | CE-3 | AMP-28 | 8.00 | — | — | P-1 | 1.70 | PN-6 | 0.25 | KA-61 | 2.00 |
| F-44 | CE-1 | — | — | I-16 | 0.25 | P-1 | 0.50 | PN-1 | 0.25 | KA-61 | 2.00 |

| | UV absorbent | | Fine particle | | Melting | Extension | | |
|---|---|---|---|---|---|---|---|---|
| Sample | | Adding | | Adding | temperature | condition | | |
| No. | Kind | amount | Kind | amount | ° C. | MD (times) | TD (times) | Remarks |
| F-23 | UV-1 | 1.50 | M-3 | 0.20 | 220 | 1.40 | 1.50 | Inventive |
| F-24 | UV-2 | 2.00 | M-1 | 0.30 | 220 | 1.10 | 1.20 | Inventive |
| F-25 | UV-1 | 1.50 | M-1 | 0.30 | 220 | 1.00 | 1.05 | Inventive |
| F-26 | UV-1 | 1.50 | M-1 | 0.30 | 230 | 1.10 | 1.15 | Inventive |
| F-27 | UV-1 | 1.50 | M-1 | 0.30 | 230 | 1.05 | 1.20 | Inventive |
| F-28 | UV-1 | 1.50 | M-2 | 0.30 | 230 | 1.25 | 1.45 | Inventive |
| F-29 | UV-1 | 1.50 | M-1 | 0.30 | 230 | 1.05 | 1.20 | Inventive |
| F-30 | UV-1 | 1.50 | M-3 | 0.10 | 230 | 1.10 | 1.15 | Inventive |
| F-31 | UV-1 | 1.50 | M-1 | 0.30 | 230 | 1.10 | 1.20 | Inventive |
| F-32 | UV-1 | 1.50 | M-1 | 0.30 | 230 | 1.40 | 1.60 | Inventive |
| F-33 | UV-3 | 2.50 | M-3 | 0.10 | 230 | 1.10 | 1.15 | Inventive |
| F-34 | UV-1 | 1.50 | M-2 | 0.30 | 230 | 1.00 | 1.10 | Inventive |
| F-35 | UV-1 | 1.50 | M-1 | 0.30 | 230 | 1.05 | 1.15 | Inventive |
| F-36 | UV-1 | 1.50 | M-1 | 0.30 | 250 | 1.05 | 1.20 | Comparative |
| F-37 | UV-1 | 1.50 | M-1 | 0.30 | 250 | 1.05 | 1.20 | Comparative |
| F-38 | UV-1 | 1.50 | M-2 | 0.30 | 240 | 1.10 | 1.20 | Comparative |
| F-39 | UV-1 | 1.50 | M-1 | 0.30 | 240 | 1.00 | 1.05 | Comparative |
| F-40 | UV-3 | 2.50 | M-3 | 0.10 | 240 | 1.10 | 1.10 | Comparative |
| F-41 | UV-1 | 1.50 | M-1 | 0.30 | 250 | 1.05 | 1.20 | Comparative |
| F-42 | UV-2 | 2.00 | M-1 | 0.30 | 250 | 1.00 | 1.20 | Comparative |
| F-43 | UV-1 | 1.50 | M-1 | 0.30 | 240 | 1.05 | 1.20 | Comparative |
| F-44 | UV-1 | 1.50 | M-1 | 0.30 | 250 | 1.05 | 1.20 | Comparative |

The adding amount is parts by weight to 100 parts by weight of cellulose ester

The “adding amount” is parts by weight to 100 parts by weight of cellulose ester.

(Cellulose Ester)

CE-2: Cellulose acetate propionate, acetyl substitution degree=1.41, propionyl substitution degree=1.32, total substitution degree=2.73, weight average molecular weight=220,000 in terms of polystyrene, dispersion degree=3.2

CE-3: Cellulose acetate propionate, acetyl substitution degree=1.38, propionyl substitution degree=1.30, total substitution degree=2.68, weight average molecular weight 210,000 in terms of polystyrene, dispersion degree=2.9

CB-4: Cellulose acetate propionate, acetyl substitution degree=1.31, propionyl substitution degree=1.23, total substitution degree=2.54, weight average molecular weight 200,000 in terms of polystyrene, dispersion degree=3.2 In the above, the “dispersion degree” is a ratio of the weight average molecular weight to the number average molecular weight.

CE-5: Cellulose acetate propionate, acetyl substitution degree=0.08, propionyl substitution degree=2.75r total substitution degree=2.83, weight average molecular weight=260,000 in terms of polystyrene, dispersion degree=3.3

CE-6: Cellulose acetate butylate, acetyl substitution degree=2.10, butylyl substitution degree=0.73, total substitution degree=2.83, weight average molecular weight=230,000 in terms of polystyrene, dispersion degree=3.5

CE-7: Cellulose acetate butylate, acetyl substitution degree=1.05, butylyl substitution-degree=1.78, total substitution degree 2.83, weight average molecular weight=280,000 in terms of polystyrene, dispersion degree=3.6

### Polymer of (a)

### Synthesis Example 1

A copolymer AMP-1 of Exemplified Compound AM-1 and methyl methacrylate was synthesized by the following method.

In 100 ml of toluene, 2.0 g of Exemplified Compound AM-1 available on the market and 8.0 g of methyl methacrylate were added and then 0.1 g of azoisobutylonitrile was added. The resulted mixture was heated by 80° C. and made react for 5 hours under nitrogen atmosphere. After removing 70 ml of toluene by vacuum distillation, the reacted liquid was dropped into large excessive amount of methanol. Precipitated substance was separated by filtration and vacuum dried at 40° C. to obtain 6.5 g of copolymer AMP-1. It was confirmed that the copolymer had a weight average molecular weight of 25,000 and a Mw/Mn of 2.8 by GPC analysis using the standard polystyrene.

It was confirmed by NMR spectrum that the copolymer is a copolymer of Exemplified Compound AM-1 and methyl methacrylate. The ratio of AM-1 to methyl methacrylate in the copolymer was about 20:80.

Polymers AMP-2 to AMP-25 of (a) were synthesized in the same manner as in Synthesis Example 1 except that the monomer was replaced by those described in table 3. The weight average molecular weight and the composition of the synthesized polymers were determined by the same manner as in Synthesis Example 1. Comparative polymers AMP-26 to AMP-28 were synthesized in the same manner as in Synthesis Example 1 except that the monomers described in Table 3 were used.

TABLE 3

| | Kind of monomer | | | Weight average | |
|---|---|---|---|---|---|
| | Composition ratio | | | molecular | |
| Polymer (a) | (weight ratio) | | | weight | Remarks |
| AMP-1 | AM-1(20) | MMA(80) | — | 25000 | Inventive |
| AMP-2 | AM-1(40) | MMA(60) | — | 10000 | Inventive |
| AMP-3 | AM-1(50) | MA(50) | — | 40000 | Inventive |
| AMP-4 | AM-1(50) | ST(50) | — | 15000 | Inventive |
| AMP-5 | AM-1(50) | VAC(50) | — | 30000 | Inventive |
| AMP-6 | AM-2(20) | MMA(80) | — | 20000 | Inventive |
| AMP-7 | AM-2(50) | MMA(40) | ST(10) | 15000 | Inventive |
| AMP-8 | AM-2(50) | MA(50) | — | 35000 | Inventive |
| AMP-9 | AM-2(60) | ST(40) | — | 5000 | Inventive |
| AMP-10 | AM-2(50) | VAC(50) | — | 10000 | Inventive |
| AMP-11 | AM-3(50) | HEMA(50) | — | 80000 | Inventive |
| AMP-12 | AM-4(30) | MMA(70) | — | 40000 | Inventive |
| AMP-13 | AM-5(50) | MMA(30) | HEMA(20) | 55000 | Inventive |
| AMP-14 | AM-5(50) | MA(50) | — | 25000 | Inventive |
| AMP-15 | AM-5(30) | HEMA(70) | — | 25000 | Inventive |
| AMP-16 | AM-5(50) | HEA(50) | — | 15000 | Inventive |
| AMP-17 | AM-5(40) | HEMA(30) | ST(30) | 5000 | Inventive |
| AMP-18 | AM-6(20) | MMA(80) | — | 35000 | Inventive |
| AMP-19 | AM-7(40) | MMA(60) | — | 75000 | Inventive |
| AMP-20 | AM-9(30) | MA(70) | — | 45000 | Inventive |
| AMP-21 | AM-10(60) | HEMA(40) | — | 15000 | Inventive |
| AMP-22 | AM-22(20) | MMA(80) | — | 30000 | Inventive |
| AMP-23 | AM-23(30) | MMA(50) | HEA(20) | 70000 | Inventive |
| AMP-24 | AM-24(40) | HEMA(60) | — | 25000 | Inventive |
| AMP-25 | AM-25(30) | MMA(70) | — | 35000 | Inventive |
| AMP-26 | — | MMA(100) | — | 25000 | Comparative |
| AMP-27 | — | HEMA(100) | — | 25000 | Comparative |
| AMP-28 | — | MMA(70) | HEMA(30) | 35000 | Comparative |

MMA: methyl methacrylate
MA: methyl acrylate
HEMA: 2-hydroxyethyl methacrylate
HEA: 2-hydroxyethyl acrylate
ST: Styrene
VAC: Vinyl acetate

(Phenol Type Compound)

P-2: Ethylene bis(oxyethylene)-bis[3-(5-tert-butyl-4-hydroxyl-m-tolyl)-propionate (Commercial name: Irganox 245, manufactured by Ciba Specialty Chemicals)

P-3: Hexamethylene bis[3-(3,5-di-tert-butyl-4-hydroxyphenyl)propionate] (Commercial name Irganox 259, manufactured by Ciba Specialty Chemicals)

P-4: Octadecyl-3-(3,5-di-tert-butyl-4-hydroxyphenyl)-Propionate (Commercial name Irganox 1076, manufactured by

### Ciba Specialty Chemicals)

(Phosphor Compound)

PH-1: The following compound

PH-2: The following compound

(UV Absorbent)

UV-2: The following compound

UV-3: The following compound

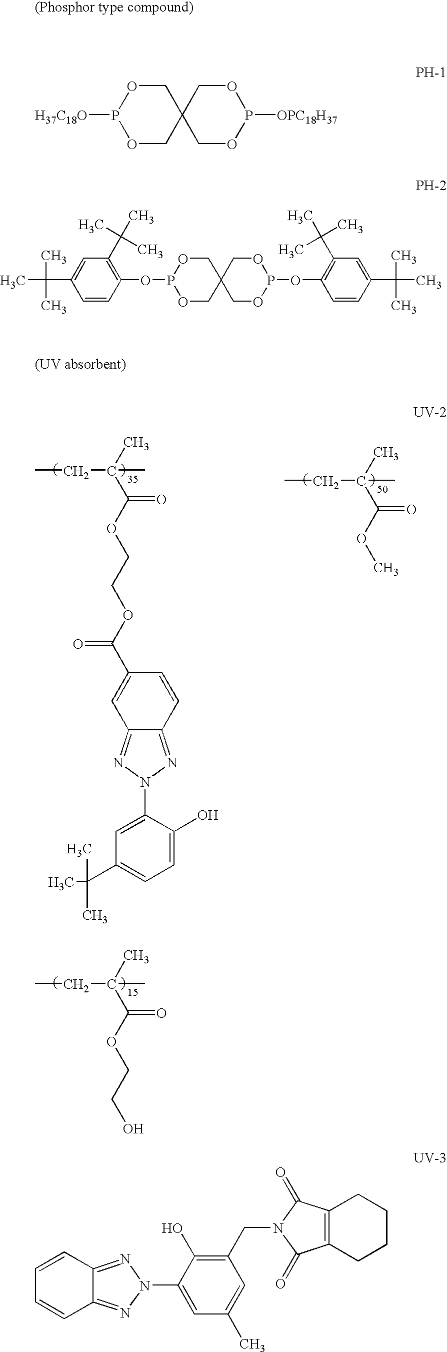

### (Fine Particle)

M-2: Aerosil NAX50 (Nippon Aerosil Co., Ltd.)

N-3: Aerosil KE-P100 (Nippon Shokubai Co., Ltd.)

[Evaluation of Cellulose Ester Optical Film]

The above-prepared samples were subjected to the following evaluations. The results of the evaluations were listed in Tables 4 and 5.

(1) Evaluation of coloring at the both edge portions of the width direction (Comparison of yellow index YI at the edge portion and at the central portion)

In the above cellulose ester optical film producing process, samples of 30 cm square were cut off from the both side portions of the width direction and the central portion of the film just after the melt-extrusion. The spectral absorption of each of the samples was measured by a spectral photometer U-3310, manufactured by Hitachi High Technology Corp., and the trichromatic excitation values X, Y and Z were calculated. The yellow index of the edge portions of the film Ye and that of the central portion Yc were determined according to JIS-K7103, and the ratio Ye/Yc was calculated. The yellow index was lead at the point where the yellow index is highest in the samples cut off from the film. The ratio of the yellow indexes at the edge portions and the central portion was determined at 50 points of each of the films and the averaged value thereof was evaluated according to the following evaluation norms.

7: Ye/Yc was less than 1.2 which was a level of excellent for the practical use.

6: Ye/Yc was not less than 1.2 and less than 1.5 which was a level of suitable for the practical use.

5: Ye/Yc was not less than 1.5 and less than 3.0 which was a level of not causing any problem in the practical use.

4: Ye/Yc was not less than 3.0 and less than 5.0 which was the lowest level of acceptable for the practical use,

3: Ye/Yc was not less than 5.0 and less than 7.0 which was a level of possibly causing a problem in the practical use.

2: Ye/Yc was not less than 7.0 and less than 10.0 which was a level of causing a problem in the practical use.

1: Ye/Yc was not less than 10.0 which was a level of causing a problem in the practical use.

(2) Evaluation of Retardation Distribution

The distribution of retardation was evaluated by the following variation coefficient (CV) as an index.

The refractive indexes in three dimensional directions of the above-obtained cellulose ester optical film were measured at an interval of 1 cm in the width direction. The in-face retardation (Ro), retardation in the thickness direction Rt and the variation coefficient (CV) thereof were determined according to the following expression.

The measurement was carried out by an automatic double refraction meter KOBURA-21ADH, manufactured by Oji Scientific instruments, at 590 nm under conditions of 23° C. and 559 RH. The in-face retardation Ro and the thickness direction retardation Rt were calculated by substituting thus obtained measured data into the following expressions (a) and (b).

In-face retardation Ro=(nx−ny)×d Expression (a)

Thickness direction retardation Rt=((nx+ny)/2−nz)×d Expression (b)

In the above, d is the thickness of the film, nx is the maximum refractive index in-face of the film, which is also called as the refractive index in slow axis, ny is the refractive index in the direction making a right angle to the slow axis and nz is the refractive index in the thickness direction of the film. The standard deviation of each of the retardation values in the thickness direction was calculated by (n−1) method. The variation coefficient of the retardation values in the thickness direction was calculated by the following expression. n was set at 130 to 140.

Variation coefficient of retardation (thickness direction) (CV)=Standard deviation of retardation Rt/Averaged value of retardation Rt

The distribution of retardation was evaluated according to the following norms from the variation coefficient (Cv) of the retardation in the thickness direction.

7: (CV) was less than 1.5% which was a level of excellent for the practical use.

6: (CV) was not less than 1.5% and less than 2.0% which was a level of suitable for the practical use.

5: (CV) was not less than 2.0% and less than 5.0% which was a level of not causing any problem in the practical use.

4: (CV) was not less than 5.0 W and less than 6.0% which was the lowest acceptable level for the practical use.

3: (CV) was not less than 6.0% and less than 8.0% which was a level of possibly causing a problem in the practical use.

2: (CV) was not less than 8.0% and less than 10.0t which was a level of causing a problem in the practical use.

1: Ye/Yc was not less than 10.0% which was a level of causing a problem in the practical use.

(3) Evaluation of Brightening Foreign Matter

The brightening foreign matter was measured by the following procedure: Each of the above prepared films was placed between two polarization plates arranged in a cross Nicole state and observed by a microscope from outside of one of the polarization plate while lighting from outside of the other polarization plate, and the number of the foreign matter seemed as white spot (brightening foreign matter) having a diameter of not less than 0.01 mm per 25 cm² was counted at 100 points. The number of the brightening foreign matter was converted to that when the thickness was 80 μm. The degree of occurrence of the brightening foreign matter was expressed by the average value of such the numbers. For the microscopic observation, a magnitude of 30 times and a transmission light source were used. Smaller number of the brightening foreign matter was preferable.

TABLE 4

| | Evaluation | | | Evaluation | | |
|---|---|---|---|---|---|---|
| | of coloring | | | of | | |
| | ratio of | | | distribution | Number of | |
| | edge portion | | | of | brightening | |
| | to central | Retardation | | retardation | foreign | |
| Sample No. | portion | R0 (nm) | Rt (nm) | (Rt) | matter | Remarks |
| F-1 | 7 | 3 | 44 | 7 | 8 | Inventive |
| F-2 | 5 | 5 | 45 | 7 | 11 | Inventive |
| F-3 | 6 | 4 | 48 | 6 | 25 | Inventive |
| F-4 | 6 | 50 | 114 | 7 | 15 | Inventive |
| F-5 | 7 | 5 | 43 | 6 | 14 | Inventive |
| F-6 | 7 | 4 | 45 | 7 | 9 | Inventive |
| F-7 | 7 | 5 | 42 | 6 | 18 | Inventive |
| F-8 | 7 | 4 | 41 | 6 | 22 | Inventive |
| F-9 | 6 | 47 | 113 | 7 | 12 | Inventive |
| F-10 | 6 | 3 | 50 | 6 | 20 | Inventive |
| F-11 | 5 | 4 | 49 | 5 | 44 | Inventive |
| F-12 | 7 | 3 | 47 | 5 | 36 | Inventive |
| F-13 | 6 | 52 | 115 | 6 | 29 | Inventive |
| F-14 | 7 | 3 | 41 | 6 | 20 | Inventive |
| F-15 | 7 | 5 | 42 | 7 | 8 | Inventive |
| F-16 | 5 | 7 | 45 | 7 | 18 | Inventive |
| F-17 | 7 | 3 | 42 | 6 | 27 | Inventive |
| F-18 | 7 | 5 | 44 | 6 | 38 | Inventive |
| F-19 | 6 | 53 | 121 | 5 | 45 | Inventive |
| F-20 | 7 | 5 | 48 | 5 | 38 | Inventive |
| F-21 | 5 | 4 | 44 | 6 | 35 | Inventive |
| F-22 | 6 | 2 | 43 | 6 | 34 | Inventive |

TABLE 5

| | Evaluation | | | | | |
|---|---|---|---|---|---|---|
| | of coloring | | | Evaluation of | | |
| | ratio of | | | distribution | Number of | |
| | edge portion | | | of | brightening | |
| Sample | to central | Retardation | | retardation | foreign | |
| No. | portion | R0 (nm) | Rt (nm) | (Rt) | matter | Remarks |
| F-23 | 6 | 52 | 122 | 6 | 39 | Inventive |
| F-24 | 7 | 5 | 46 | 5 | 31 | Inventive |
| F-25 | 7 | 4 | 46 | 5 | 30 | Inventive |
| F-26 | 6 | 3 | 42 | 6 | 18 | Inventive |
| F-27 | 7 | 4 | 47 | 6 | 18 | Inventive |
| F-28 | 6 | 51 | 119 | 6 | 13 | Inventive |
| F-29 | 7 | 5 | 44 | 6 | 11 | Inventive |
| F-30 | 7 | 3 | 42 | 6 | 24 | Inventive |
| F-31 | 6 | 4 | 43 | 5 | 37 | Inventive |
| F-32 | 6 | 52 | 119 | 5 | 47 | Inventive |
| F-33 | 7 | 5 | 49 | 5 | 31 | Inventive |
| F-34 | 7 | 4 | 49 | 5 | 39 | Inventive |
| F-35 | 7 | 4 | 43 | 5 | 40 | Inventive |
| F-36 | 1 | 4 | 47 | 2 | 78 | Comparative |
| F-37 | 1 | 5 | 51 | 2 | 81 | Comparative |
| F-38 | 1 | 5 | 48 | 2 | 79 | Comparative |
| F-39 | 1 | 4 | 48 | 1 | 83 | Comparative |
| F-40 | 1 | 6 | 47 | 1 | 73 | Comparative |
| F-41 | 4 | 4 | 52 | 3 | 128 | Comparative |
| F-42 | 2 | 8 | 64 | 1 | 175 | Comparative |
| F-43 | 3 | 7 | 60 | 2 | 115 | Comparative |
| F-44 | 3 | 5 | 58 | 2 | 120 | Comparative |

It is confirmed from Tables 4 and 5 that the samples of the invention are excellent as the optical film in which the diffraction of retardation in the width direction is reduced, the occurrence of brightening matter is inhibited and the coloring at the edge portions of the width direction is lower compared with those in the comparative samples. Namely, it is cleared that the combination use of the polymer (a) with the carbon radical trapping agent, the phenol type compound or the phosphor type compound gives suitable synergistic effects so that the properties of the film is improved. It is further cleared that surpassing effects can be obtained by adding the three kinds of the compound in the specified ratio.

### Example 2

### Anti-Reflection Film and Preparation of Polarization Film

Anti-reflection films having a hard-coat layer were prepared by providing a hard-coat layer and an anti-reflection layer onto one side of optical films F-1 to 3, 5 to 8, 10 to 12, 14 to 18, 20 to 22, 24 to 27, 29 to 31 and 33 to 44. Polarization plates were prepared by using these films.

<Hard-Coat Layer>

The following hard-coat layer composition was coated so as to form a layer with a dry thickness of 3.5 μm and dried at 80° C. for 1 minute. The coated layer was cured by irradiation of energy of 150 mJ/cm² by a high pressure mercury vapor lump (80 W). The refractive index of the hard-coat layer was 1.50.

<Hard-coat layer composition (C-1)>

| | |
|---|---|
| Dipentaerythritol hexacrylate (containing about | 108 parts by weight |
| 20% of dimer or more ingredients) | |
| Irgacure 184 (Ciba Specialty Chemicals) | 2 parts by weight |
| Propylene glycol monomethyl ether | 180 parts by weight |
| Methyl acetate | 120 parts by weight |

<Medium Refractive Layer>

On the hard-coat layer of the hard-coated film, the following medium refractive layer composition was coated by an extrusion coater and dried for 1 minute under conditions of 0.1 m/sec at 80° C. On this occasion, a non-contact floater was used until the coated layer made to the state of set-to-touch (a state that the surface of the coated layer was felt as dried when the surface was touched by a finger). As the non-contact floater, a horizontal flow type air-turnbar, manufactured by Bellmatic Ltd., was used. The static pressure in the floater was 9.8 kPa, and film was transported while uniformly floating by 2 mm in the width direction. After dried, the coated layer was cured by irradiation of 130 mJ/cm² of ultraviolet rays using a high pressure mercury vapor lump (80 W) to prepare the film having the medium refractive layer. The thickness and the refractive index of the medium refractive layer were each 84 nm and 1.66, respectively.

<Medium refractive layer composition>

| | | |
|---|---|---|
| 20% dispersion of ITO fine particle (average particle | 100 | g |
| diameter: 70 nm, isopropyl alcohol solution) | | |
| Dipentaerythritol hexacrylate | 6.4 | g |
| Irgacure184 (Ciba Specialty Chemicals) | 1.6 | g |
| Tetrabutoxytitanium | 4.0 | g |
| 10%-solution of FZ-2207 (Propylene glycol monomethyl ether | 3.0 | g |
| solution, Nippon Unicar Co., ltd.) | | |
| Isopropyl alcohol | 530 | g |
| Methyl ethyl ketone | 90 | g |
| Propylene glycol monomethyl ether | 265 | g |

<High Refractive Layer>

On the medium refractive layer, the following high refractive layer composition was coated by the extrusion coater and dried for 1 minute under a condition of 0.1 m/sec at 80° C. On this occasion, the non-contact floater was used until the coated layer made to the state of set-to-touch (a state that the surface of the coated layer was felt as dried when the surface was touched by a finger). The non-contact floater was used under the same condition as in the preparation of the medium refractive layer. After dried, the coated layer was cured by irradiation of 130 mJ/cm² of ultraviolet rays using a high pressure mercury vapor lump (80 W) to prepare the high refractive film having the high refractive layer.

<High refractive layer composition>

| | | |
|---|---|---|
| Tetra-n-butoxy titanium | 95 | parts by weight |
| Dimethylpolysiloxane KF-96-1000CS (Shin-Etsu | 1 | part by weight |
| Chemical Co., Ltd.) | | |
| γ-methacryloxyorioyltrimethoxysilane KBM503 | 5 | parts by weight |
| (Shin-Etsu Chemical Co., Ltd.) | | |
| Propylene glycol monomethyl ether | 1750 | parts by weight |
| Isopropyl alcohol | 3450 | parts by weight |
| Methyl ethyl ketone | 600 | parts by weight |

The thickness and the refractive index of the high refractive layer of the high refractive film were 50 μm and 1.82, respectively,

<Low Refractive Layer>

Firstly, silica type fine particles (hollow particles) were prepared.

(Preparation of Silica Type Fine Particle S-1)

A mixture of 100 g of silica sol having a SiO₂ concentration of 20 weight % and an average diameter of 5 nm and 1,900 g of purified water was heated by 80° C. The pH value of thus obtained reaction mother liquid was 10.5. To the mother liquid, 9,000 g of an aqueous solution of sodium silicate containing 0-98% by weight of SiO₂ and 9,000 g of an aqueous solution of sodium aluminate containing 1.02% by weight of Al₂O₃ were simultaneously added while maintaining the temperature of the reaction liquid at 80° C. The pH value of the reaction liquid rose to 12.5 just after the addition of the solutions and almost not varied after that. After finishing of the reaction, the reaction liquid was cooled by room temperature and washed using an ultrafilter membrane to prepare SiO₂.Al₂O₃ nuclear particle dispersion having a solid content of 20% by weight (Process (a)).

To 500 g of the nuclear particle dispersion, 1,700 g of purified water was added and the resulted liquid was heated by 98° C. While maintaining the temperature, 3,000 g of silicic acid solution having a SiO₂ content of 3.5% by weight prepared by dealkalizing a sodium silicate aqueous solution by cation-exchange resin to prepare a dispersion of nuclear particles on each of which a first silica covering layer was formed (Process (b)).

Next, the solid content of the dispersion of nuclear particles having the first silica covering layer was made to 13 W by weight by washing using the ultrafilter. To 500 g of the resulted dispersion, 1,125 g of purified water was added and concentrated hydrochloric acid (35.5%) was further dropped to make the pH value to 1.0 for de-aluminum treatment. Then dissolved aluminum was separated by ultrafiltration while adding 10 L of hydrochloric acid having a pH value of 3 and 5 L of purified water to prepare a dispersion of porous SiO₂.Al₂O₃ particles formed by removing a part of the ingredients of the nuclear particles having the first silica covering layer (Process (c)). A mixture of 1,500 g of the above porous particle dispersion, 500 g of purified water, 1,750 g of methanol and 626 g of 28%-ammonia water was heated by 35° C. and then 104 g of ethyl silicate containing 28% by weight of SiO₂ was added to cover the surface of the porous particle having the first silica covering layer by forming a second silica covering layer of hydrolyzed condensation-polymerization product of ethyl silicate. Then the solvent was replaced by ethanol by using the ultrafilter membrane to prepare a dispersion of silica type fine particles having a solid content of 20% by weight.

The thickness of the first silica covering layer, average particle diameter, mole ratio of Moₓ/SiO₂ and refractive index of the silica type particle dispersion are listed in table 6. The average particle diameter was measured by a dynamic light scattering method and the refractive index was measured by the following method using Series A and AA, manufactured by Cargill Lab., as standard refractive liquids.

<Method for Measuring Refractive Index of Particle>

(1) The particle dispersion was put in an evaporator and the dispersing medium was evaporated.

(2) The residue was dried at 120° C. to make powder.

(3) Two or three drops of the standard refractive liquid having known refractive index were put onto a glass plate and the above powder was mixed with the liquid.

(4) The above procedure was repeated using various standard refractive liquids each different in the refractive index thereof and the refractive index of the standard liquid making a transparent mixture with the powder was defined as the refractive index of the colloidal particles.

TABLE 6

| | | | | | | Silica type fine particle | | |
|---|---|---|---|---|---|---|---|---|
| | | | Silica covering layer | | Outer | | Average | |
| | Fine particle | | Thickness | Thickness | shell | | particle | |
| | | Mole ratio | of first | of second | Thickness | Mole ratio | diameter | Refractive |
| No. | Kind | of Moₓ/SiO₂ | layer (nm) | layer (nm) | (nm) | of Moₓ/SiO₂ | (nm) | index |
| P-1 | Al/Si | 0.5 | 3 | 5 | 8 | 0.0017 | 47 | 1.28 |

(Formation of Low Refractive Layer)

To a matrix prepared by mixing 95 mole % of Si(OC₂H₅)₄ and 5 moles of C₃F₇—(OC₃F₆)₂₄—O—(CF₂)₂—C₂H₄—O—CH₂Si(OCH₃)₃, 35% by weight of the above silica type fine particle S-1 having an average particle diameter of 60 nm was added and 1.0 N HCl was added as a catalyst, and the resulted mixture was diluted by a solvent to prepare a low refractive coating composition. The coating composition was coated on the above active ray curable resin layer or the high refractive layer so as to form a layer having a thickness of 100 nm. The coated layer was dried at 120° C. and irradiated by UV rays to form a low refractive layer.

As above-described, anti-reflection films were prepared using the cellulose ester optical films prepared in Example 1.

Thereafter, a poly(vinyl alcohol) film with a thickness of 120 μm was mono-axially extended in a extending ratio of 5 at 110° C. The film was immersed for 60 seconds in an aqueous solution composed of 0.075 g of iodine, 5 g of potassium iodide and 100 g of water, and then further immersed at 80° C. in an aqueous solution composed of 6 g of potassium iodide, 7.5 g of boric acid and 100 g of water. The film after immersion was washed and dried to prepare a polarization membrane.

After that, polarization plates were prepared by pasting the polarization membrane, each of the anti-reflection films and the cellulose ester film for back side according to the following Processes 1 to 5. As the back side polarization plate protection film, Konica Minolta TAC KCSUCR-4, manufactured Konica Minolta Opt, co., Ltd., was used; this was a cellulose ester film available on the market.

Process 1. The cellulose ester film was immersed in a 2 moles/L sodium hydroxide aqueous solution for 90 minutes at 60° C., then washed and dried to obtain the anti-reflection film saponified on the side to be pasted with the polarization element.

Process 2: The above polarization membrane was immersed for 1 to 2 seconds in an adhesive tank containing a poly(vinyl alcohol) having a solid content of 21 by weight.

Process 3: The polarization membrane was piled on the optical film prepared in Process 1 after the adhesive excessively adhering on the polarization membrane in Process 2 was lightly wiped off.

Process 4: The anti-reflection film sample, the polarization membrane and the cellulose ester film piled in Process 3 were pasted by applying a pressure of 20 to 30 N/cm² at a transportation rate of about 2 r/minute.

Process 5: The sample prepared by pasting the polarization membrane, cellulose ester film and anti-reflection film in Process 4 was dried for 2 minutes at 80° C. in a dryer.

[Preparation of Liquid Crystal Display]

Liquid crystal panels were prepared as follows for measuring the visible field angle and the properties of them as the liquid crystal were evaluated.

The polarization plates previously pasted on both sides of liquid crystal cell of 15-type display VL-150SD, manufactured by Fujitsu Ltd., were peeled off and each of the above prepared polarization plate was pasted onto the glass surface of the liquid crystal cell.

On this occasion, the polarization plates was pasted so that the surface of the anti-reflection side was set as the watching face of the liquid crystal cell and the absorption axis of the polarization plate was met with that of the previously pasted polarization plate to prepared a liquid crystal display.

The anti-reflection films using the optical films of the invention was reduced in occurrence of the unevenness of hardness and the line-shaped unevenness, and the polarization plates and the displays using those were shows excellent displaying property superior in the contrast without color unevenness of reflected light. The anti-reflection film using the comparative samples prepared in Example 1 had the hardness unevenness and line-shaped unevenness and the polarization plates and the displays using those showed unevenness of the color of the reflected light.

### Example 3

### Preparation of Antistatic Film and Polarization Plate

On one side of each of the optical films P-1 to 3, 5 to 8, 10 to 12, 14 to 18, 20 to 22, 24 to 27, 29 to 31 and 33 to 44 prepared in Example 1, a hard-coat layer and an anti-static layer were formed to prepare antistatic films each having the hard-card layer. Polarization plates were prepared by using the anti-static films.

(Coating composition)

(Antistatic layer coating composition)

| | | |
|---|---|---|
| Poly(methyl methacrylate) (weight average molecular weight: | 0.5 | parts |
| 550,000, Tg: 90° C.) | | |
| Propylene glycol monomethyl ether | 60 | parts |
| Methyl ethyl ketone | 16 | parts |
| Ethyl lactate | 5 | parts |
| Methanol | 8 | parts |
| Electro-conductive polymer resin CP-1 (particle size: 0.1 to | 0.5 | parts |
| 0.3 μm) | | |

(Hard-coat layer composition)

| | |
|---|---|
| Dipentaerythritol hexacrylate monomer | 60 parts |
| Dipentaerythritol hexacrylate dimer | 20 parts |
| Dipentaerythritol hexacrylate polymer of trimer or | 20 parts |
| more | |
| Dioxybenzophenone photo reaction initiator | 6 parts |
| Silicone type surfactant | 1 part |
| Propylene glycol monomethyl ether | 75 parts |
| Methyl ethyl ketone | 75 parts |

(Anti-curling layer coating composition)

| | | |
|---|---|---|
| Acetone | 35 | parts |
| Ethyl acetate | 45 | parts |
| Isopropyl alcohol | 5 | parts |
| Diacetyl cellulose | 0.5 | parts |
| 2%-acetone dispersion of ultra fine silica particle (Aerosil | 0.1 | parts |
| 200V, Nippon Aerosil Co., Ltd.) | | |

Electro-Conductive Polymer Resin CP-1

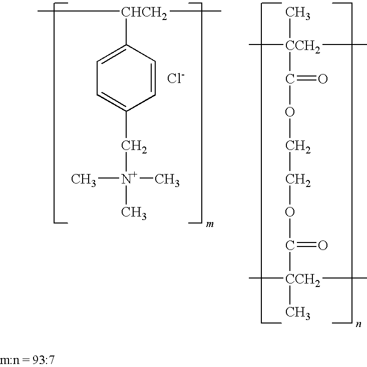

Antistatic films each having the hard coat were prepared as follow.

The anti-curling layer coating composition was coated on a side of each of the cellulose ester optical films prepared in Example 1 by a gravure coating method so as to form a wet layer with thickness of 13 μm and dried at a drying temperature of 80±5° C. The antistatic layer coating composition was coated on another side at a film transportation speed of 30 m/min and a coating width of 1 m under conditions of 28° C. and 82% RH so as to form a layer having a wet thickness of 7 μm and dried in a drying zone set at a temperature of 80±5° C. to form a resin layer having a dry thickness of about 0.2 μm. Thus anti-static films were prepared.

On the antistatic layer, the hard-coat layer coating composition (2) was further coated so as to form a wet layer thickness of 13 μm and dried at a drying temperature of 90° C., and then 150 mJ/m² of UV ray was irradiated to form a clear hard-coat layer having a dry thickness of 5 μm. On clear hard-coat layer having a dry thickness of 5 μm. On thus obtained optical films, blushing was not caused and cracking after drying was not observed also, and the coating suitability was good.

The good coating suitability was confirmed as to the samples of the invention prepared in Example 1. On the anti-static films prepared by using the comparative samples prepared in Example 11, blushing was caused when the coating was carried out under the high temperature and high humidity condition and fine cracks were observed after drying.

Then polarization plates using the antistatic films were prepared the same as in Example 2.

[Preparation of Liquid Crystal Display]

Liquid crystal panels were prepared as follows for measuring the visible field angle and the properties of them as liquid crystal display were evaluated.

The polarization palates previously pasted on both sides of liquid crystal cell of 15-type display VL-150SD, manufactured by Fujitsu Ltd., were peeled off and each of the above prepared was pasted onto the glass surface of the liquid crystal cell.

On this occasion, the polarization plates was pasted so that the surface of the anti-reflection side was set as the watching face of the liquid crystal cell and the absorption axis of the polarization plate was met with that of the previously pasted polarization plate to prepared a liquid crystal display, and the displaying properties of them were evaluated.

The liquid crystal displays each using the antistatic film prepared by the cellulose ester optical film of the invention show higher contrast and superior displaying property compared with the liquid crystal displays using the polarization plated prepared by the comparative samples prepared in Example 1. Thus it was confirmed that the polarization plate using the optical film of the invention was superior as the polarization plate of the image display such as the liquid crystal display.

### Example 4

### Preparation of Polarization Plate and Liquid Crystal Display

Polarization plates and liquid crystal displays were prepared in the same manner as in Example 2 except that Konica Minolta TAC KC8UCR-4, manufactured by Konica Minolta Opt Corp., used as the backside polarization plate protection film was replaced by the polarization films F-4,9,13,19, 23, 28 or 32 and the front side polarization plate protection film was replaced by Konica Minolta TAC KC8UX, manufactured by Konica Minolta Opt Corp. As a result of that, the results Example 2 were reproduced and the polarization plates and the liquid crystal displays showed superior displaying property in the contrast without problem of unevenness of color of reflected light.

### PROBABILITY OF APPLICATION IN INDUSTRY

The cellulose ester optical film which has the superior properties such as reduced distribution of the retardation in the width direction, inhibited occurrence of brightening foreign matter and reduced coloring at the edge portions of both sides of the width direction, the polarization plate and liquid crystal display using the cellulose ester optical film, and the production method of such the optical film by which the load on the production, equipment and environment accompanied with the drying and recovering of the solvent can be reduced can be provided by the invention.

1. A cellulose ester optical film comprising a cellulose ester, a polymer (a) and a compound (b), wherein
the polymer (a) is obtained by copolymerizing an ethylenically unsaturated monomer having a partial structure represented by Formula (1) in a molecule and at least one ethylenically unsaturated monomer,
the compound (b) is at least one compound selected from the group consisting of carbon radical trapping agents, phenol compounds and phosphorous compounds; 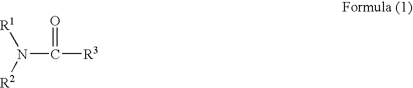
wherein R¹, R² and R³ represents each independently an aliphatic group, an aromatic group or a heterocyclic group, each of which may have a substituent; or any two of R¹, R² and R³ may form a cyclic structure by combining together with the nitrogen atom or the carbon and nitrogen atoms bonded with these groups.

2. The cellulose ester optical film of claim 1, wherein a weight average molecular weight of the polymer (a) is 1,000 or more and 70,000 or less.

3. The cellulose ester optical film of claim 1, wherein the ethylenically unsaturated monomer having a partial structure represented by Formula (1) is N-vinylpyrrolidone, N-acryloylmorpholine, N-vinylpiperidone, N-vinylcaprolactam or a mixture of thereof.

4. The cellulose ester optical film of claim 1, wherein the cellulose ester satisfies a degree of substitution in expressions (1) to (3);
2.4≦A+B≦3.0 Expression (1)
0≦A≦2.4 Expression (2)
0.1≦B<3.0, Expression (3)
wherein A represents a degree of substitution of an acetyl group, and B represents sum of a degree of substitution of an acyl group having 3 to 5 carbon atoms.

5. The cellulose ester optical film of claim 1, wherein the carbon radical trapping agent is a compound represented by Formula (2); 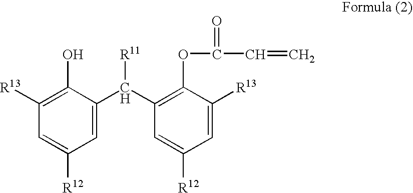
wherein R¹¹ represents a hydrogen atom or an alkyl group having 1 to 10 carbon atoms, and R¹² and R¹³ each represents an alkyl group having 1 to 8 carbon atoms respectively.

6. The cellulose ester optical film of claim 1, wherein the carbon radical trapping agent is a compound represented by Formula (3); 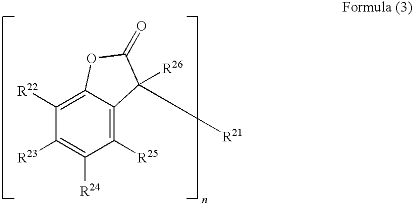
wherein R²² to R²⁶ represents each independently a hydrogen atom, an aliphatic group, an aromatic group or a heterocyclic group, each of which may have a substituent; n represents 1 or 2; when n is 1, R²¹ represents an aliphatic group, an aromatic group or a heterocyclic group, each of which may have a substituent; and when n is 2, R²¹ represents an divalent linking group.

7. The cellulose ester optical film of claim 1, wherein the phosphorous compound is a phosphonite compound represented by Formula (4) or (5);
R³¹P(OR³²)₂, Formula (4)
wherein R³¹ represents a phenyl group or a thienyl group, each of which may have a substituent; R³² represents an alkyl group, a phenyl group or a thienyl group, each of which may have a substituent; and a plurality of R³² may combine and form a ring structure together;
(R³⁴O)₂PR³³—R³³P(OR³⁴)₂ Formula (5)
wherein R³³ represents a phenylene group or a thienylene group, each of which may have a substituent; R³⁴ represents an alkyl group, a phenyl group or a thienyl group, each of which may have a substituent; and a plurality of R³⁴ may combine and form a ring structure together.

8. The cellulose ester optical film of claim 7, wherein R³⁴ in Formula (5) is a substituted phenyl group comprising a substitute having a total number of carbon atoms of 9 to 14 per one phenyl group, provided that a substituted phenyl group may comprise a plurality of substitute per one phenyl group within a range of total number of carbon atoms being 9 to 14.

9. The cellulose ester optical film of claim 8, wherein the phosphonite compound represented by Formula (5) is tetrakis(2,4-di-t-butyl-5-methylphenyl)-4,4,-biphenylene diphosphonite.

10. The cellulose ester optical film of claim 1, wherein an amount of the carbon radical trapping agent is 0.1 to 1.0 parts by weight, an amount of the phenol compound is 0.2 to 2.0 parts by weight and an amount of the phosphorous compound is 0.1 to 1.0 parts by weight, each to 100 parts by weight of the cellulose ester

11. The cellulose ester optical film of claim 1 comprising at least one ester type plasticizer obtained from a polyhydric alcohol and a monovalent carboxylic acid.

12. The cellulose ester optical film of claim 1 comprising at least one of an ultraviolet absorbent.

13. The cellulose ester optical film of claim 1 comprising at least one of fine particles.

14. A polarizing plate comprising the cellulose ester optical film of claim 1.

15. A liquid crystal display apparatus comprising the cellulose ester optical film of claim 1 or the polarizing plate of claim 14.

16. A method for producing a cellulose ester optical film comprising a step of a melt casting, wherein a cellulose ester optical film comprising a cellulose ester, a polymer (a) and a compound (b), wherein
the polymer (a) is obtained by copolymerizing an ethylenically unsaturated monomer having a partial structure represented by Formula (1) in a molecule and at least one ethylenically unsaturated monomer,
the compound (b) is at least one compound selected from the group consisting of carbon radical trapping agents, phenol compounds and phosphorous compounds; 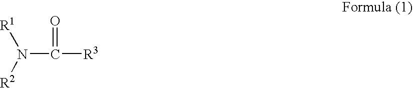
wherein R¹, R² and R³ represents each independently an aliphatic group, an aromatic group or a heterocyclic group, each of which may have a substituent; or any two of R¹, R² and R³ may form a cyclic structure by combining together with the nitrogen atom or the carbon and nitrogen atoms bonded with these groups.

17. The method for producing the cellulose ester optical film of claim 16, wherein a yellow index Yc of a center portion and a yellow index Ye of an edge portion of a film after melt extrusion satisfies expression (4);
1.0≦Ye/Yc≦5.0. Expression (4)

18. The method for producing the cellulose ester optical film of claim 16 comprising a step of a stretching, wherein the cellulose ester film after melt extrusion is stretched at a magnification of 1.0 through 4.0 times in one direction and is stretched at a magnification of 1.01 through 4.0 times in the direction perpendicular to each other.
